(19) United States
(12) Patent Application Publication
(10) Pub. No.: US 2017/0013093 A1
(43) Pub. Date: Jan. 12, 2017

(54) BROADCAST RECEPTION DEVICE AND OPERATING METHOD THEREOF, AND BROADCAST TRANSMISSION DEVICE AND OPERATING METHOD THEREOF

(71) Applicant: LG ELECTRONICS INC., Seoul (KR)

(72) Inventors: Woosuk KWON, Seoul (KR); Jinwon LEE, Seoul (KR); Sejin OH, Seoul (KR); Kyoungsoo MOON, Seoul (KR)

(73) Assignee: LG ELECTRONICS INC., Seoul (KR)

(21) Appl. No.: 15/120,411

(22) PCT Filed: Feb. 17, 2015
(86) PCT No.: PCT/KR2015/001665

§ 371 Date: Aug. 19, 2016

Related U.S. Application Data
(60) Provisional application No. 61/942,596, filed on Feb. 20, 2014.
(60) Provisional application No. 61/947,983, filed on Mar. 4, 2014.
(60) Provisional application No. 61/970,341, filed on Mar. 25, 2014.

(51) Int. Cl. H04L 29/06; H04L 29/08

(52) U.S. Cl. CPC H04L 69/08; H04L 65/4076; H04L 69/323

(57) ABSTRACT

Provided is a broadcast reception device providing emergency alert information for notifying an emergency situation. The device includes: a broadcast reception unit receiving a transmission packet for transmitting the emergency alert information through a transmission path included in a physical layer, which is one a plurality of layers for transmitting a broadcast signal and is for transmitting/receiving a broadcast signal through a physical medium; and a control unit obtaining the emergency alert information by decoding the transmission packet.

### TECHNICAL FIELD

The present disclosure relates to a broadcast reception device and an operating method thereof, and a broadcast transmission device and an operating method thereof.

### BACKGROUND ART

The transmission of emergency alert information in a broadcast system serves to notify an emergency situation to users viewing broadcasts to take an immediate action. Especially, in broadcasting environments in North America, the delivery of emergency notification information is specified by Federal Emergency Management Agency (FEMA) and Federal Communications Commission (FCC). Accordingly, the next broadcast system needs to support the transmission of emergency alert information.

The emergency alert information of existing broadcast systems is mainly configured in a common alerting protocol (CAP) message format and the CAP suggests how to express a message format but a method of transmitting this depends on transport protocol. Accordingly, in order to deliver emergency alert information, the characteristics of a transmission system should be reflected and emergency alert information delivering method using the CAP and a transport protocol are required.

### DISCLOSURE OF INVENTION

### Technical Problem

Embodiments provide a broadcast transmission device and an operating method thereof, and a broadcast reception device and an operating method thereof, which configure a signaling system for transmitting emergency alert information and apply this to a transport protocol.

Embodiments also provide a broadcast transmission device and an operating method thereof, and a broadcast reception device and an operating method thereof, which configure a signaling system for delivering emergency alert information.

Embodiments also provide a broadcast transmission device and an operating method thereof, and a broadcast reception device and an operating method thereof, which configure a section table for delivering emergency alert information.

Embodiments also provide a broadcast transmission device and an operating method thereof, and a broadcast reception device and an operating method thereof, which configure a packet for delivering emergency alert information and receive it.

Embodiments also provide a broadcast transmission device and an operating method thereof, and a broadcast reception device and an operating method thereof, which transmit/receive emergency alert information through a specific physical layer pipe in a physical layer.

Embodiments also provide a broadcast transmission device and an operating method thereof, and a broadcast reception device and an operating method thereof, which set a detection interval on the basis of emergency situation information and transmit/receive it.

### Solution to Problem

In one embodiment, provided is a broadcast reception device providing emergency alert information for notifying an emergency situation. The device includes: a broadcast reception unit receiving a transmission packet for transmitting the emergency alert information through a transmission path included in a physical layer, which is one of a plurality of layers for transmitting a broadcast signal and is for transmitting/receiving a broadcast signal through a physical medium; and a control unit obtaining the emergency alert information by decoding a transmission packet received through the transmission path.

The broadcast reception unit may receive the transmission packet for the emergency alert information transmission through a first transmission path that is a transmission path specified for transmitting only the emergency alert information.

The physical layer may include information for notifying that the first transmission path is included in the physical layer.

The broadcast reception unit may receive the transmission packet for the emergency alert information transmission through a second transmission path that is a transmission path transmitting signaling information on a broadcast service or common data applied to a plurality of broadcast services.

The broadcast reception unit may receive the transmission packet for the emergency alert information transmission on the basis of a third transmission path that is a transmission path for directly transmitting information for broadcast service scan to a physical layer without passing through another layer.

The transmission packet received based on the third transmission path may include path information for the emergency alert information acquisition, wherein the broadcast reception unit may receive the transmission packet for the emergency alert information transmission through a fourth transmission path that his different from the third transmission path on the basis of the path information.

The path information may include information for identifying a transmission path that transmits the transmission packet for the emergency alert information transmission.

The control unit may obtain broadcast service information relating to the emergency alert information by decoding the transmission packet; and the related broadcast service information may be at least one of transmission path information transmitting a real time service relating to the emergency alert information and address information for receiving a non-real time service relating to the emergency alert information.

The control unit may obtain first information for activating a function for detecting whether emergency alert information is transmitted through the physical layer on the basis of the emergency alert information.

The first information may include at least one of activation start time information of a detection function, activation duration time information of a detection function, and deactivation duration time information of a detection function.

The first information may be determined by a location of a broadcast transmission device transmitting the emergency alert information.

The first information may include a deactivation duration time of a detection function proportional to a distance between a location of the broadcast reception device and an emergency occurring area.

The first information may be determined based on second information representing a priority of an emergency alert; and the second information may include information representing an urgency of an emergency alert, information representing a severity of an emergency causing an emergency alert, and information representing a certainty of an emergency causing an emergency alert.

In another embodiment, provided is an operating method of a broadcast reception device providing emergency alert information for notifying an emergency situation. The method includes: receiving a transmission packet for transmitting the emergency alert information through a transmission path included in a physical layer, which is one of a plurality of layers for transmitting a broadcast signal and is for transmitting/receiving a broadcast signal through a physical medium; decoding a transmission packet received through the transmission path; and obtaining the emergency alert information from the decoded transmission packet.

The receiving of the transmission packet may include receiving the physical layer frame for the emergency alert information transmission through a first transmission path that is a transmission path specified for transmitting only the emergency alert information.

In another embodiment, a broadcast transmission device includes: a control unit collecting emergency alert information for notifying an emergency situation from alert authorities and encoding the collected emergency alert information in a format for transmission; and a broadcast transmission unit transmitting the encoded emergency alert information through a transmission path included in a physical layer that is one of a plurality of layers for transmitting a broadcast signal and is for transmitting/receiving a broadcast signal through a physical medium.

In another embodiment, provided an operating method of a broadcast transmission device. The method includes: collecting emergency alert information for notifying an emergency situation from alert authorities; encoding the collected emergency alert information in a format for transmission; and transmitting the encoded emergency alert information through a transmission path included in a physical layer that is one of a plurality of layers for transmitting a broadcast signal and is for transmitting/receiving a broadcast signal through a physical medium.

### BRIEF DESCRIPTION OF DRAWINGS

FIG. 1 illustrates a structure of an apparatus for transmitting broadcast signals for future broadcast services according to an embodiment of the present invention.

FIG. 2 illustrates an input formatting block according to one embodiment of the present invention.

FIG. 3 illustrates an input formatting block according to another embodiment of the present invention.

FIG. 4 illustrates an input formatting block according to another embodiment of the present invention.

FIG. 5 illustrates a BICM block according to an embodiment of the present invention.

FIG. 6 illustrates a BICM block according to another embodiment of the present invention.

FIG. 7 illustrates a frame building block according to one embodiment of the present invention.

FIG. 8 illustrates an OFMD generation block according to an embodiment of the present invention.

FIG. 9 illustrates a structure of an apparatus for receiving broadcast signals for future broadcast services according to an embodiment of the present invention.

FIG. 10 illustrates a frame structure according to an embodiment of the present invention.

FIG. 11 illustrates a signaling hierarchy structure of the frame according to an embodiment of the present invention.

FIG. 12 illustrates preamble signaling data according to an embodiment of the present invention.

FIG. 13 illustrates PLS1 data according to an embodiment of the present invention.

FIG. 14 illustrates PLS2 data according to an embodiment of the present invention.

FIG. 15 illustrates PLS2 data according to another embodiment of the present invention.

FIG. 16 illustrates a logical structure of a frame according to an embodiment of the present invention.

FIG. 17 illustrates PLS mapping according to an embodiment of the present invention.

FIG. 18 illustrates EAC mapping according to an embodiment of the present invention.

FIG. 19 illustrates FIC mapping according to an embodiment of the present invention.

FIG. 20 illustrates a type of DP according to an embodiment of the present invention.

FIG. 21 illustrates DP mapping according to an embodiment of the present invention.

FIG. 22 illustrates an FEC structure according to an embodiment of the present invention.

FIG. 23 illustrates a bit interleaving according to an embodiment of the present invention.

FIG. 24 illustrates a cell-word demultiplexing according to an embodiment of the present invention.

FIG. 25 illustrates a time interleaving according to an embodiment of the present invention.

FIG. 26 illustrates the basic operation of a twisted row-column block interleaver according to an embodiment of the present invention.

FIG. 27 illustrates an operation of a twisted row-column block interleaver according to another embodiment of the present invention.

FIG. 28 illustrates a diagonal-wise reading pattern of a twisted row-column block interleaver according to an embodiment of the present invention.

FIG. 29 illustrates interleaved XFECBLOCKs from each interleaving array according to an embodiment of the present invention.

FIG. 30 is a view illustrating a configuration of a broadcast reception device according to an embodiment of the present invention.

FIG. 31 is a view illustrating a broadcast system providing a broadcast service interoperating with a companion device according to an embodiment of the present invention.

FIG. 32 is a view illustrating the properties of signaled broadcast service according to an embodiment of the present invention.

FIG. 33 is a view illustrating a parameter representing a state of a signaled broadcast service property according to an embodiment of the present invention.

FIG. 34 is a ladder diagram illustrating operations when a broadcast reception device signals a broadcast service property to a companion device according to an embodiment of the present invention.

FIG. 35 is a view illustrating a data format of a broadcast service property that a broadcast reception device signals to a companion device according to an embodiment of the present invention.

FIG. 36 is a view illustrating a parameter representing a state of a broadcast service property that a broadcast reception device signals to a companion device, an action for broadcast service property, and an argument of an action according to another embodiment of the present invention.

FIG. 37 is a ladder diagram illustrating operations when a broadcast reception device signals a broadcast service property to a companion device according to another embodiment of the present invention.

FIG. 38 is a view illustrating a data format of whether a broadcast service property is changed that a broadcast reception device signals to a companion device according to another embodiment of the present invention.

FIG. 39 is a view illustrating parameters representing a state of a broadcast service property that a broadcast reception device signals to a companion device according to another embodiment of the present invention.

FIG. 40 is a view illustrating a data format of whether a broadcast service property is changed that a broadcast reception device signals to a companion device according to another embodiment of the present invention.

FIG. 41 is a view illustrating parameters representing a state of a broadcast service property that a broadcast reception device signals to a companion device according to another embodiment of the present invention.

FIG. 42 is a ladder diagram illustrating operations when a broadcast reception device signals a broadcast service property to a companion device according to another embodiment of the present invention.

FIG. 43 is a view illustrating a parameter representing a state of a broadcast service property that a broadcast reception device signals to a companion device, an action for broadcast service property, and an argument of an action according to another embodiment of the present invention.

FIG. 44 is a ladder diagram illustrating operations when a broadcast reception device signals a broadcast service property to a companion device according to another embodiment of the present invention.

FIG. 45 is a view illustrating operations when an emergency alert is generated and transmitted through a broadcast network according to an embodiment of the present invention.

FIG. 46 is a view when a broadcast reception device extracts and displays emergency information signaled through a broadcast network according to an embodiment of the present invention.

FIG. 47 is a view illustrating an emergency alert message format according to an embodiment of the present invention.

FIG. 48 is a view illustrating a parameter representing a state of an emergency alert that a broadcast reception device signals, an action for emergency alert, and an action argument according to another embodiment of the present invention.

FIG. 49 is a view illustrating information including on an emergency alert signaled by a broadcast reception device according to an embodiment of the present invention.

FIG. 50 is a ladder diagram illustrating operations when a broadcast reception device signals an emergency alert to a companion device according to an embodiment of the present invention.

FIG. 51 is a view illustrating the criteria of a broadcast reception device to determine the priority of an emergency alert according to an embodiment of the present invention.

FIG. 52 is a view illustrating the criteria of a broadcast reception device to determine the priority of an emergency alert according to another embodiment of the present invention.

FIG. 53 is a view illustrating the criteria of a broadcast reception device to determine the priority of an emergency alert according to another embodiment of the present invention.

FIG. 54 is a view illustrating a parameter representing a state of an emergency alert that a broadcast reception device signals, an action for emergency alert, and an action argument according to another embodiment of the present invention.

FIG. 55 is a ladder diagram illustrating operations when a broadcast reception device signals an emergency alert to a companion device according to another embodiment of the present invention.

FIG. 56 is a ladder diagram illustrating operations when a broadcast reception device signals an emergency alert to a companion device according to another embodiment of the present invention.

FIG. 57 is a ladder diagram illustrating operations when a broadcast reception device signals an emergency alert to a companion device according to another embodiment of the present invention.

FIG. 58 is a view illustrating a transport layer of broadcast service according to an embodiment of the present invention.

FIG. 59 is a block diagram illustrating an entire configuration of an emergency alert system according to an embodiment of the present invention.

FIG. 60 is a view illustrating a protocol stock for supporting broadcast service according to an embodiment of the present invention.

FIG. 61 is a view illustrating a syntax for Emergency Alert Table (EAT) information.

FIG. 62 is a view illustrating a syntax for disaster alert message.

FIG. 63 is a view illustrating a syntax for automatic channel tuning information.

FIG. 64 is a view illustrating a syntax for NRT service information.

FIGS. 65 and 66 are views illustrating a section table for transmitting an emergency alert message according to an embodiment of the present invention.

FIG. 67 is a view illustrating the payload of a packet without modifying the format of an emergency alert table according to an embodiment of the present invention.

FIG. 68 is a view illustrating an emergency alert message inserted as individual information instead of a section table format.

FIG. 69 is a view when a broadcast transmission device 300 transmits an EAT through a dedicated PLP according to an embodiment of the present invention.

FIGS. 70 and 71 are views when a broadcast transmission device 300 encapsulates an ET in a packet and transmits the packet according to an embodiment of the present invention.

FIG. 72 is a view illustrating contents for directly transmitting an emergency alert message through a signaling channel.

FIG. 73 is a view illustrating a syntax for an emergency alert message transmitted through a signaling channel according to an embodiment of the present invention.

FIG. 74 is a view illustrating contents for transmitting only a delivery path of emergency alert information through a signaling channel.

FIG. 75 is a view illustrating a syntax for signaling an emergency alert transmitted through a signaling channel according to an embodiment of the present invention.

FIG. 76 is a flowchart illustrating an operating method of a broadcast transmission device according to an embodiment of the present disclosure.

FIG. 77 is a flowchart illustrating an operating method of the broadcast reception device according to an embodiment of the present disclosure.

FIG. 78 is a view illustrating a syntax for a detection time interval table that a broadcast transmission device transmits to a broadcast reception device 100.

FIG. 79 is a view illustrating an operation of a broadcast reception device according to detection period information.

FIG. 80 is a view illustrating a syntax of an EAT with added detection period information.

FIG. 81 is a view when emergency alert information and detection interval information are included in a signaling channel according to an embodiment of the present invention.

FIG. 83 is a view illustrating a CAP message for transmitting emergency situation information according to an embodiment of the present invention.

FIG. 83 is a view illustrating emergency situation information for setting detection interval information by a broadcast transmission device according to an embodiment of the present invention.

FIGS. 84 to 86 are views when a broadcast transmission device sets detection interval information on the basis of emergency situation priority information.

FIG. 87 is a flowchart illustrating an operating method of a broadcast reception device according to an embodiment of the present disclosure.

FIG. 88 is a flowchart illustrating an operating method of the broadcast reception device according to an embodiment of the present disclosure.

### BEST MODE FOR CARRYING OUT THE INVENTION

Hereinafter, embodiments of the present invention will be described in more detail with reference to the accompanying drawings, in order to allow those skilled in the art to easily realize the present invention. The present invention may be realized in different forms, and is not limited to the embodiments described herein. Moreover, detailed descriptions related to well-known functions or configurations will be ruled out in order not to unnecessarily obscure subject matters of the present invention. Like reference numerals refer to like elements throughout.

In additional, when a part “includes” some components, this means that the part does not exclude other components unless stated specifically and further includes other components.

The apparatuses and methods for transmitting according to an embodiment of the present invention may be categorized into a base profile for the terrestrial broadcast service, a handheld profile for the mobile broadcast service and an advanced profile for the UHDTV service. In this case, the base profile can be used as a profile for both the terrestrial broadcast service and the mobile broadcast service. That is, the base profile can be used to define a concept of a profile which includes the mobile profile. This can be changed according to intention of the designer.

The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc.

While MISO or MIMO uses two antennas in the following for convenience of description, the present invention is applicable to systems using two or more antennas.

The present invention may defines three physical layer (PL) profiles (base, handheld and advanced profiles) each optimized to minimize receiver complexity while attaining the performance required for a particular use case. The physical layer (PHY) profiles are subsets of all configurations that a corresponding receiver should implement.

The three PHY profiles share most of the functional blocks but differ slightly in specific blocks and/or parameters. Additional PHY profiles can be defined in the future. For the system evolution, future profiles can also be multiplexed with the existing profiles in a single RF channel through a future extension frame (FEF). The details of each PHY profile are described below.

1. Base Profile

The base profile represents a main use case for fixed receiving devices that are usually connected to a roof-top antenna. The base profile also includes portable devices that could be transported to a place but belong to a relatively stationary reception category. Use of the base profile could be extended to handheld devices or even vehicular by some improved implementations, but those use cases are not expected for the base profile receiver operation.

Target SNR range of reception is from approximately 10 to 20 dB, which includes the 15 dB SNR reception capability of the existing broadcast system (e.g. ATSC A/53). The receiver complexity and power consumption is not as critical as in the battery-operated handheld devices, which will use the handheld profile. Key system parameters for the base profile are listed in below table 1.

TABLE 1

| | |
|---|---|
| LDPC codeword length | 16K, 64K bits |
| Constellation size | 4~10 bpcu (bits per channel use) |
| Time de-interleaving memory size | ≦2¹⁹ data cells |
| Pilot patterns | Pilot pattern for fixed reception |
| FFT size | 16K, 32K points |

2. Handheld Profile

The handheld profile is designed for use in handheld and vehicular devices that operate with battery power. The devices can be moving with pedestrian or vehicle speed. The power consumption as well as the receiver complexity is very important for the implementation of the devices of the handheld profile. The target SNR range of the handheld profile is approximately 0 to 10 dB, but can be configured to reach below 0 dB when intended for deeper indoor reception.

In addition to low SNR capability, resilience to the Doppler Effect caused by receiver mobility is the most important performance attribute of the handheld profile. Key system parameters for the handheld profile are listed in the below table 2.

TABLE 2

| | |
|---|---|
| LDPC codeword length | 16K bits |
| Constellation size | 2~8 bpcu |
| Time de-interleaving memory size | ≦2¹⁸ data cells |
| Pilot patterns | Pilot patterns for mobile and indoor |
| | reception |
| FFT size | 8K, 16K points |

3. Advanced Profile

The advanced profile provides highest channel capacity at the cost of more implementation complexity. This profile requires using MIMO transmission and reception, and UHDTV service is a target use case for which this profile is specifically designed. The increased capacity can also be used to allow an increased number of services in a given bandwidth, e.g., multiple SDTV or HDTV services.

The target SNR range of the advanced profile is approximately 20 to 30 dB. MIMO transmission may initially use existing elliptically-polarized transmission equipment, with extension to full-power cross-polarized transmission in the future. Key system parameters for the advanced profile are listed in below table 3.

TABLE 3

| | |
|---|---|
| LDPC codeword length | 16K, 64K bits |
| Constellation size | 8~12 bpcu |
| Time de-inter leaving memory size | ≦2¹⁹ data cells |
| Pilot patterns | Pilot pattern for fixed reception |
| FFT size | 16K, 32K points |

In this case, the base profile can be used as a profile for both the terrestrial broadcast service and the mobile broadcast service. That is, the base profile can be used to define a concept of a profile which includes the mobile profile. Also, the advanced profile can be divided advanced profile for a base profile with MIMO and advanced profile for a handheld profile with MIMO. Moreover, the three profiles can be changed according to intention of the designer.

The following terms and definitions may apply to the present invention. The following terms and definitions can be changed according to design.

auxiliary stream: sequence of cells carrying data of as yet undefined modulation and coding, which may be used for future extensions or as required by broadcasters or network operators

base data pipe: data pipe that carries service signaling data

baseband frame (or BBFRAME): set of Kbch bits which form the input to one FEC encoding process (BCH and LDPC encoding)

cell: modulation value that is carried by one carrier of the OFDM transmission

coded block: LDPC-encoded block of PLS1 data or one of the LDPC-encoded blocks of PLS2 data

data pipe: logical channel in the physical layer that carries service data or related metadata, which may carry one or multiple service(s) or service component(s).

data pipe unit: a basic unit for allocating data cells to a DP in a frame.

data symbol: OFDM symbol in a frame which is not a preamble symbol (the frame signaling symbol and frame edge symbol is included in the data symbol)

DP_ID: this 8 bit field identifies uniquely a DP within the system identified by the SYSTEM_ID

dummy cell: cell carrying a pseudorandom value used to fill the remaining capacity not used for PLS signaling, DPs or auxiliary streams

emergency alert channel: part of a frame that carries EAS information data

frame: physical layer time slot that starts with a preamble and ends with a frame edge symbol

frame repetition unit: a set of frames belonging to same or different physical layer profile including a FEF, which is repeated eight times in a super-frame

fast information channel: a logical channel in a frame that carries the mapping information between a service and the corresponding base DP

FECBLOCK: set of LDPC-encoded bits of a DP data

FFT size: nominal FFT size used for a particular mode, equal to the active symbol period Ts expressed in cycles of the elementary period T

frame signaling symbol: OFDM symbol with higher pilot density used at the start of a frame in certain combinations of FFT size, guard interval and scattered pilot pattern, which carries a part of the PLS data

frame edge symbol: OFDM symbol with higher pilot density used at the end of a frame in certain combinations of FFT size, guard interval and scattered pilot pattern

frame-group: the set of all the frames having the same PHY profile type in a super-frame.

future extension frame: physical layer time slot within the super-frame that could be used for future extension, which starts with a preamble

Futurecast UTB system: proposed physical layer broadcasting system, of which the input is one or more MPEG2-TS or IP or general stream(s) and of which the output is an RF signal

input stream: A stream of data for an ensemble of services delivered to the end users by the system.

normal data symbol: data symbol excluding the frame signaling symbol and the frame edge symbol

PHY profile: subset of all configurations that a corresponding receiver should implement

PLS: physical layer signaling data consisting of PLS1 and PLS2

PLS1: a first set of PLS data carried in the FSS symbols having a fixed size, coding and modulation, which carries basic information about the system as well as the parameters needed to decode the PLS2

NOTE: PLS1 data remains constant for the duration of a frame-group.

PLS2: a second set of PLS data transmitted in the FSS symbol, which carries more detailed PLS data about the system and the DPs

PLS2 dynamic data: PLS2 data that may dynamically change frame-by-frame

PLS2 static data: PLS2 data that remains static for the duration of a frame-group

preamble signaling data: signaling data carried by the preamble symbol and used to identify the basic mode of the system

preamble symbol: fixed-length pilot symbol that carries basic PLS data and is located in the beginning of a frame

NOTE: The preamble symbol is mainly used for fast initial band scan to detect the system signal, its timing, frequency offset, and FFTsize.

reserved for future use: not defined by the present document but may be defined in future

superframe: set of eight frame repetition units

time interleaving block (TI block): set of cells within which time interleaving is carried out, corresponding to one use of the time interleaver memory

TI group: unit over which dynamic capacity allocation for a particular DP is carried out, made up of an integer, dynamically varying number of XFECBLOCKs.

NOTE: The TI group may be mapped directly to one frame or may be mapped to multiple frames. It may contain one or more TI blocks.

Type 1 DP: DP of a frame where all DPs are mapped into the frame in TDM fashion

Type 2 DP: DP of a frame where all DPs are mapped into the frame in FDM fashion

XFECBLOCK: set of Ncells cells carrying all the bits of one LDPC FECBLOCK

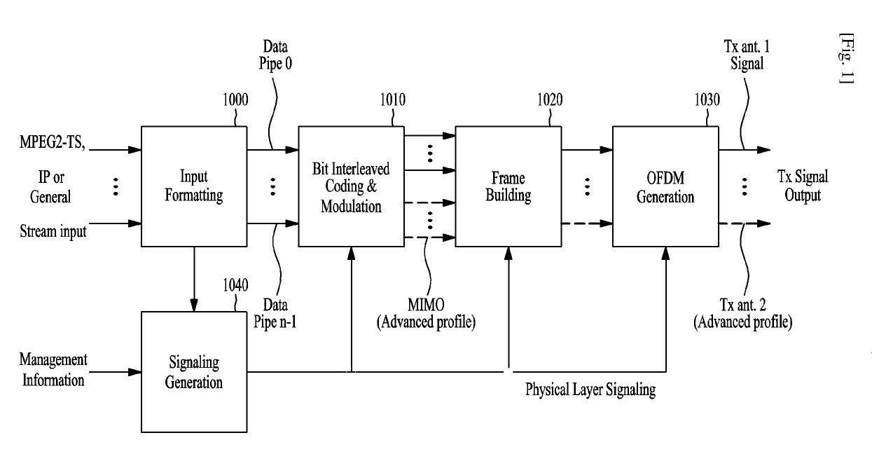

FIG. 1 illustrates a structure of an apparatus for transmitting broadcast signals for future broadcast services according to an embodiment of the present invention.

The apparatus for transmitting broadcast signals for future broadcast services according to an embodiment of the present invention can include an input formatting block 1000, a BICM (Bit interleaved coding & modulation) block 1010, a frame structure block 1020, an OFDM (Orthogonal Frequency Division Multiplexing) generation block 1030 and a signaling generation block 1040. A description will be given of the operation of each module of the apparatus for transmitting broadcast signals.

IP stream/packets and MPEG2-TS are the main input formats, other stream types are handled as General Streams. In addition to these data inputs, Management Information is input to control the scheduling and allocation of the corresponding bandwidth for each input stream. One or multiple TS stream(s), IP stream(s) and/or General Stream(s) inputs are simultaneously allowed.

The input formatting block 1000 can demultiplex each input stream into one or multiple data pipe(s), to each of which an independent coding and modulation is applied. The data pipe (DP) is the basic unit for robustness control, thereby affecting quality-of-service (QoS). One or multiple service(s) or service component(s) can be carried by a single DP. Details of operations of the input formatting block 1000 will be described later.

The data pipe is a logical channel in the physical layer that carries service data or related metadata, which may carry one or multiple service(s) or service component(s).

Also, the data pipe unit: a basic unit for allocating data cells to a DP in a frame.

In the BICM block 1010, parity data is added for error correction and the encoded bit streams are mapped to complex-value constellation symbols. The symbols are interleaved across a specific interleaving depth that is used for the corresponding DP. For the advanced profile, MIMO encoding is performed in the BICM block 1010 and the additional data path is added at the output for MIMO transmission. Details of operations of the BICM block 1010 will be described later.

The Frame Building block 1020 can map the data cells of the input DPs into the OFDM symbols within a frame. After mapping, the frequency interleaving is used for frequency-domain diversity, especially to combat frequency-selective fading channels. Details of operations of the Frame Building block 1020 will be described later.

After inserting a preamble at the beginning of each frame, the OFDM Generation block 1030 can apply conventional OFDM modulation having a cyclic prefix as guard interval. For antenna space diversity, a distributed MISO scheme is applied across the transmitters. In addition, a Peak-to-Average Power Reduction (PAPR) scheme is performed in the time domain. For flexible network planning, this proposal provides a set of various FFT sizes, guard interval lengths and corresponding pilot patterns. Details of operations of the OFDM Generation block 1030 will be described later.

The Signaling Generation block 1040 can create physical layer signaling information used for the operation of each functional block. This signaling information is also transmitted so that the services of interest are properly recovered at the receiver side. Details of operations of the Signaling Generation block 1040 will be described later.

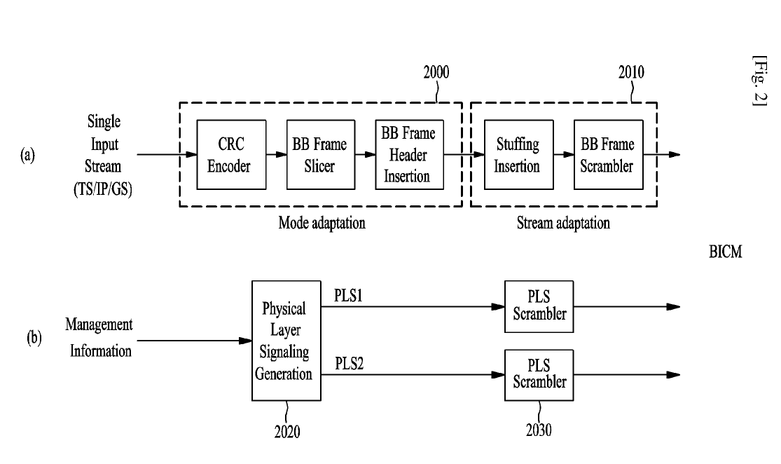

FIGS. 2, 3 and 4 illustrate the input formatting block 1000 according to embodiments of the present invention. A description will be given of each figure.

FIG. 2 illustrates an input formatting block according to one embodiment of the present invention. FIG. 2 shows an input formatting module when the input signal is a single input stream.

The input formatting block illustrated in FIG. 2 corresponds to an embodiment of the input formatting block 1000 described with reference to FIG. 1.

The input to the physical layer may be composed of one or multiple data streams. Each data stream is carried by one DP. The mode adaptation modules slice the incoming data stream into data fields of the baseband frame (BBF). The system supports three types of input data streams: MPEG2-TS, Internet protocol (IP) and Generic stream (GS). MPEG2-TS is characterized by fixed length (188 byte) packets with the first byte being a sync-byte (0x47). An IP stream is composed of variable length IP datagram packets, as signaled within IP packet headers. The system supports both IPv4 and IPv6 for the IP stream. GS may be composed of variable length packets or constant length packets, signaled within encapsulation packet headers.

(a) shows a mode adaptation block 2000 and a stream adaptation 2010 for signal DP and (b) shows a PLS generation block 2020 and a PLS scrambler 2030 for generating and processing PLS data. A description will be given of the operation of each block.

The Input Stream Splitter splits the input TS, IP, GS streams into multiple service or service component (audio, video, etc.) streams. The mode adaptation module 2010 is comprised of a CRC Encoder, BB (baseband) Frame Slicer, and BB Frame Header Insertion block.

The CRC Encoder provides three kinds of CRC encoding for error detection at the user packet (UP) level, i.e., CRC-8, CRC-16, and CRC-32. The computed CRC bytes are appended after the UP. CRC-8 is used for TS stream and CRC-32 for IP stream. If the GS stream doesn't provide the CRC encoding, the proposed CRC encoding should be applied.

BB Frame Slicer maps the input into an internal logical-bit format. The first received bit is defined to be the MSB. The BB Frame Slicer allocates a number of input bits equal to the available data field capacity. To allocate a number of input bits equal to the BBF payload, the UP packet stream is sliced to fit the data field of BBF.

BB Frame Header Insertion block can insert fixed length BBF header of 2 bytes is inserted in front of the BB Frame. The BBF header is composed of STUFFI (1 bit), SYNCD (13 bits), and RFU (2 bits). In addition to the fixed 2-Byte BBF header, BBF can have an extension field (1 or 3 bytes) at the end of the 2-byte BBF header.

The stream adaptation 2010 is comprised of stuffing insertion block and BB scrambler.

The stuffing insertion block can insert stuffing field into a payload of a BB frame. If the input data to the stream adaptation is sufficient to fill a BB-Frame, STUFFI is set to ‘0’ and the BBF has no stuffing field. Otherwise STUFFI is set to ‘1’ and the stuffing field is inserted immediately after the BBF header. The stuffing field comprises two bytes of the stuffing field header and a variable size of stuffing data.

The BB scrambler scrambles complete BBF for energy dispersal. The scrambling sequence is synchronous with the BBF. The scrambling sequence is generated by the feed-back shift register.

The PLS generation block 2020 can generate physical layer signaling (PLS) data.

The PLS provides the receiver with a means to access physical layer DPs. The PLS data consists of PLS1 data and PLS2 data.

The PLS1 data is a first set of PLS data carried in the FSS symbols in the frame having a fixed size, coding and modulation, which carries basic information about the system as well as the parameters needed to decode the PLS2 data. The PLS1 data provides basic transmission parameters including parameters required to enable the reception and decoding of the PLS2 data. Also, the PLS1 data remains constant for the duration of a frame-group.

The PLS2 data is a second set of PLS data transmitted in the FSS symbol, which carries more detailed PLS data about the system and the DPs. The PLS2 contains parameters that provide sufficient information for the receiver to decode the desired DP. The PLS2 signaling further consists of two types of parameters, PLS2 Static data (PLS2-STAT data) and PLS2 dynamic data (PLS2-DYN data). The PLS2 Static data is PLS2 data that remains static for the duration of a frame-group and the PLS2 dynamic data is PLS2 data that may dynamically change frame-by-frame.

Details of the PLS data will be described later.

The PLS scrambler 2030 can scramble the generated PLS data for energy dispersal.

The above-described blocks may be omitted or replaced by blocks having similar or identical functions.

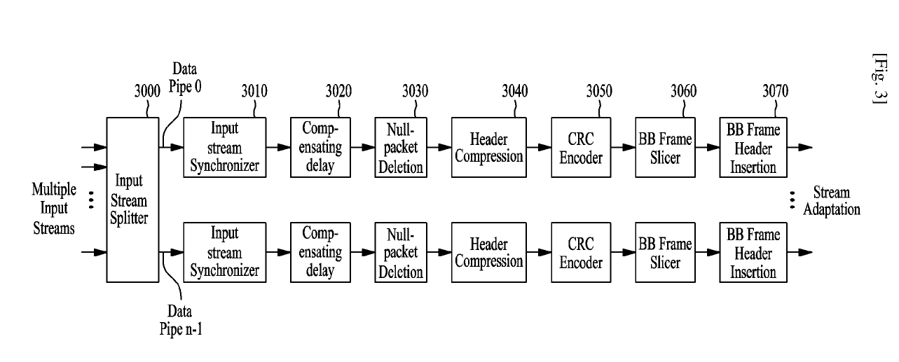

FIG. 3 illustrates an input formatting block according to another embodiment of the present invention.

The input formatting block illustrated in FIG. 3 corresponds to an embodiment of the input formatting block 1000 described with reference to FIG. 1.

FIG. 3 shows a mode adaptation block of the input formatting block when the input signal corresponds to multiple input streams.

The mode adaptation block of the input formatting block for processing the multiple input streams can independently process the multiple input streams.

Referring to FIG. 3, the mode adaptation block for respectively processing the multiple input streams can include an input stream splitter 3000, an input stream synchronizer 3010, a compensating delay block 3020, a null packet deletion block 3030, a head compression block 3040, a CRC encoder 3050, a BB frame slicer 3060 and a BB header insertion block 3070. Description will be given of each block of the mode adaptation block.

Operations of the CRC encoder 3050, BB frame slicer 3060 and BB header insertion block 3070 correspond to those of the CRC encoder, BB frame slicer and BB header insertion block described with reference to FIG. 2 and thus description thereof is omitted.

The input stream splitter 3000 can split the input TS, IP, GS streams into multiple service or service component (audio, video, etc.) streams.

The input stream synchronizer 3010 may be referred as ISSY. The ISSY can provide suitable means to guarantee Constant Bit Rate (CBR) and constant end-to-end transmission delay for any input data format. The ISSY is always used for the case of multiple DPs carrying TS, and optionally used for multiple DPs carrying GS streams.

The compensating delay block 3020 can delay the split TS packet stream following the insertion of ISSY information to allow a TS packet recombining mechanism without requiring additional memory in the receiver.

The null packet deletion block 3030, is used only for the TS input stream case. Some TS input streams or split TS streams may have a large number of null-packets present in order to accommodate VBR (variable bit-rate) services in a CBR TS stream. In this case, in order to avoid unnecessary transmission overhead, null-packets can be identified and not transmitted. In the receiver, removed null-packets can be re-inserted in the exact place where they were originally by reference to a deleted null-packet (DNP) counter that is inserted in the transmission, thus guaranteeing constant bit-rate and avoiding the need for time-stamp (PCR) updating.

The head compression block 3040 can provide packet header compression to increase transmission efficiency for TS or IP input streams. Because the receiver can have a priori information on certain parts of the header, this known information can be deleted in the transmitter.

For Transport Stream, the receiver has a-priori information about the sync-byte configuration (0x47) and the packet length (188 Byte). If the input TS stream carries content that has only one PID, i.e., for only one service component (video, audio, etc.) or service sub-component (SVC base layer, SVC enhancement layer, MVC base view or MVC dependent views), TS packet header compression can be applied (optionally) to the Transport Stream. IP packet header compression is used optionally if the input steam is an IP stream.

The above-described blocks may be omitted or replaced by blocks having similar or identical functions.

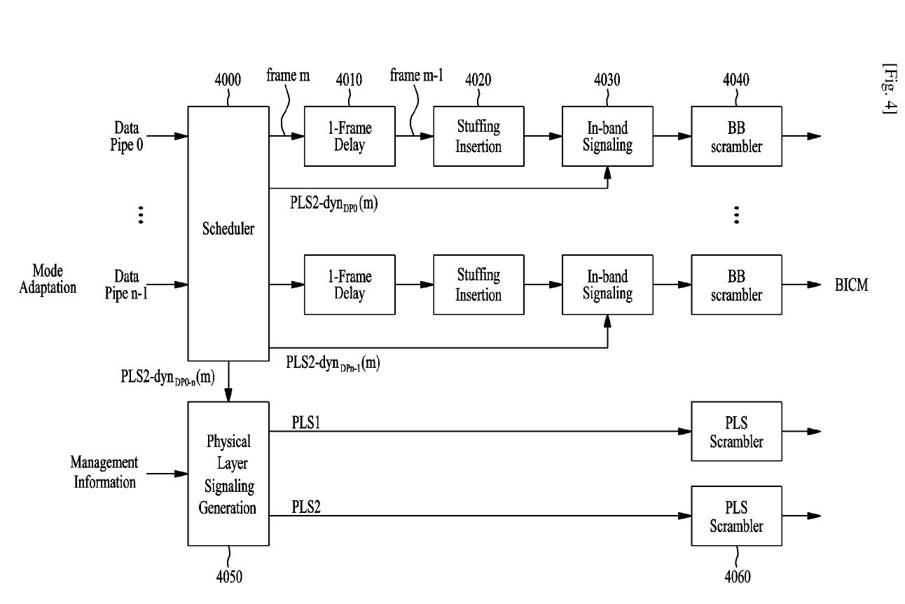

FIG. 4 illustrates an input formatting block according to another embodiment of the present invention.

The input formatting block illustrated in FIG. 4 corresponds to an embodiment of the input formatting block 1000 described with reference to FIG. 1.

FIG. 4 illustrates a stream adaptation block of the input formatting module when the input signal corresponds to multiple input streams.

Referring to FIG. 4, the mode adaptation block for respectively processing the multiple input streams can include a scheduler 4000, an 1-Frame delay block 4010, a stuffing insertion block 4020, an in-band signaling 4030, a BB Frame scrambler 4040, a PLS generation block 4050 and a PLS scrambler 4060. Description will be given of each block of the stream adaptation block.

Operations of the stuffing insertion block 4020, the BB Frame scrambler 4040, the PLS generation block 4050 and the PLS scrambler 4060 correspond to those of the stuffing insertion block, BB scrambler, PLS generation block and the PLS scrambler described with reference to FIG. 2 and thus description thereof is omitted.

The scheduler 4000 can determine the overall cell allocation across the entire frame from the amount of FECBLOCKs of each DP. Including the allocation for PLS, EAC and FIC, the scheduler generate the values of PLS2-DYN data, which is transmitted as in-band signaling or PLS cell in FSS of the frame. Details of FECBLOCK, EAC and FIC will be described later.

The 1-Frame delay block 4010 can delay the input data by one transmission frame such that scheduling information about the next frame can be transmitted through the current frame for in-band signaling information to be inserted into the DPs.

The in-band signaling 4030 can insert un-delayed part of the PLS2 data into a DP of a frame.

The above-described blocks may be omitted or replaced by blocks having similar or identical functions.

FIG. 5 illustrates a BICM block according to an embodiment of the present invention.

The BICM block illustrated in FIG. 5 corresponds to an embodiment of the BICM block 1010 described with reference to FIG. 1.

As described above, the apparatus for transmitting broadcast signals for future broadcast services according to an embodiment of the present invention can provide a terrestrial broadcast service, mobile broadcast service, UHDTV service, etc.

Since QoS (quality of service) depends on characteristics of a service provided by the apparatus for transmitting broadcast signals for future broadcast services according to an embodiment of the present invention, data corresponding to respective services needs to be processed through different schemes. Accordingly, the a BICM block according to an embodiment of the present invention can independently process DPs input thereto by independently applying SISO, MISO and MIMO schemes to the data pipes respectively corresponding to data paths. Consequently, the apparatus for transmitting broadcast signals for future broadcast services according to an embodiment of the present invention can control QoS for each service or service component transmitted through each DP.

(a) shows the BICM block shared by the base profile and the handheld profile and (b) shows the BICM block of the advanced profile.

The BICM block shared by the base profile and the handheld profile and the BICM block of the advanced profile can include plural processing blocks for processing each DP.

A description will be given of each processing block of the BICM block for the base profile and the handheld profile and the BICM block for the advanced profile.

A processing block 5000 of the BICM block for the base profile and the handheld profile can include a Data FEC encoder 5010, a bit interleaver 5020, a constellation mapper 5030, an SSD (Signal Space Diversity) encoding block 5040 and a time interleaver 5050.

The Data FEC encoder 5010 can perform the FEC encoding on the input BBF to generate FECBLOCK procedure using outer coding (BCH), and inner coding (LDPC). The outer coding (BCH) is optional coding method. Details of operations of the Data FEC encoder 5010 will be described later.

The bit interleaver 5020 can interleave outputs of the Data FEC encoder 5010 to achieve optimized performance with combination of the LDPC codes and modulation scheme while providing an efficiently implementable structure. Details of operations of the bit interleaver 5020 will be described later.

The constellation mapper 5030 can modulate each cell word from the bit interleaver 5020 in the base and the handheld profiles, or cell word from the Cell-word demultiplexer 5010-1 in the advanced profile using either QPSK, QAM-16, non-uniform QAM (NUQ-64, NUQ-256, NUQ-1024) or non-uniform constellation (NUC-16, NUC-64, NUC-256, NUC-1024) to give a power-normalized constellation point, e₁. This constellation mapping is applied only for DPs. Observe that QAM-16 and NUQs are square shaped, while NUCs have arbitrary shape. When each constellation is rotated by any multiple of 90 degrees, the rotated constellation exactly overlaps with its original one. This “rotation-sense” symmetric property makes the capacities and the average powers of the real and imaginary components equal to each other. Both NUQs and NUCs are defined specifically for each code rate and the particular one used is signaled by the parameter DP_MOD filed in PLS2 data.

The SSD encoding block 5040 can precode cells in two (2D), three (3D), and four (4D) dimensions to increase the reception robustness under difficult fading conditions.

The time interleaver 5050 can operates at the DP level. The parameters of time interleaving (TI) may be set differently for each DP. Details of operations of the time interleaver 5050 will be described later.

A processing block 5000-1 of the BICM block for the advanced profile can include the Data FEC encoder, bit interleaver, constellation mapper, and time interleaver. However, the processing block 5000-1 is distinguished from the processing block 5000 further includes a cell-word demultiplexer 5010-1 and a MIMO encoding block 5020-1.

Also, the operations of the Data FEC encoder, bit interleaver, constellation mapper, and time interleaver in the processing block 5000-1 correspond to those of the Data FEC encoder 5010, bit interleaver 5020, constellation mapper 5030, and time interleaver 5050 described and thus description thereof is omitted.

The cell-word demultiplexer 5010-1 is used for the DP of the advanced profile to divide the single cell-word stream into dual cell-word streams for MIMO processing. Details of operations of the cell-word demultiplexer 5010-1 will be described later.

The MIMO encoding block 5020-1 can processing the output of the cell-word demultiplexer 5010-1 using MIMO encoding scheme. The MIMO encoding scheme was optimized for broadcasting signal transmission. The MIMO technology is a promising way to get a capacity increase but it depends on channel characteristics. Especially for broadcasting, the strong LOS component of the channel or a difference in the received signal power between two antennas caused by different signal propagation characteristics makes it difficult to get capacity gain from MIMO. The proposed MIMO encoding scheme overcomes this problem using a rotation-based pre-coding and phase randomization of one of the MIMO output signals.

MIMO encoding is intended for a 2×2 MIMO system requiring at least two antennas at both the transmitter and the receiver. Two MIMO encoding modes are defined in this proposal; full-rate spatial multiplexing (FR-SM) and full-rate full-diversity spatial multiplexing (FRFD-SM). The FR-SM encoding provides capacity increase with relatively small complexity increase at the receiver side while the FRFD-SM encoding provides capacity increase and additional diversity gain with a great complexity increase at the receiver side. The proposed MIMO encoding scheme has no restriction on the antenna polarity configuration.

MIMO processing is required for the advanced profile frame, which means all DPs in the advanced profile frame are processed by the MIMO encoder. MIMO processing is applied at DP level. Pairs of the Constellation Mapper outputs NUQ (e_{1,i} and e_{2,i}) are fed to the input of the MIMO Encoder. Paired MIMO Encoder output (g1,i and g2,i) is transmitted by the same carrier k and OFDM symbol 1 of their respective TX antennas.

The above-described blocks may be omitted or replaced by blocks having similar or identical functions.

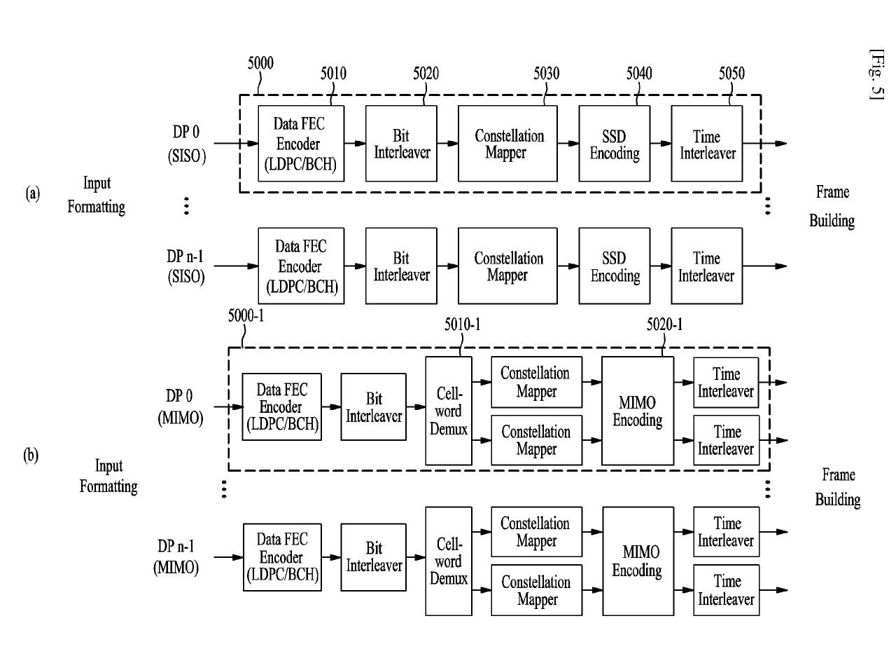

FIG. 6 illustrates a BICM block according to another embodiment of the present invention.

The BICM block illustrated in FIG. 6 corresponds to an embodiment of the BICM block 1010 described with reference to FIG. 1.

FIG. 6 illustrates a BICM block for protection of physical layer signaling (PLS), emergency alert channel (EAC) and fast information channel (FIC). EAC is a part of a frame that carries EAS information data and FIC is a logical channel in a frame that carries the mapping information between a service and the corresponding base DP. Details of the EAC and FIC will be described later.

Referring to FIG. 6, the BICM block for protection of PLS, EAC and FIC can include a PLS FEC encoder 6000, a bit interleaver 6010 and a constellation mapper 6020.

Also, the PLS FEC encoder 6000 can include a scrambler, BCH encoding/zero insertion block, LDPC encoding block and LDPC parity puncturing block. Description will be given of each block of the BICM block.

The PLS FEC encoder 6000 can encode the scrambled PLS 1/2 data, EAC and FIC section.

The scrambler can scramble PLS1 data and PLS2 data before BCH encoding and shortened and punctured LDPC encoding.

The BCH encoding/zero insertion block can perform outer encoding on the scrambled PLS 1/2 data using the shortened BCH code for PLS protection and insert zero bits after the BCH encoding. For PLS1 data only, the output bits of the zero insertion may be permitted before LDPC encoding.

The LDPC encoding block can encode the output of the BCH encoding/zero insertion block using LDPC code. To generate a complete coded block, C_{ldpc}, parity bits, P_{ldpc} are encoded systematically from each zero-inserted PLS information block, I_{ldpc} and appended after it.

MathFigure 1

C_{ldpc}=[I_{ldpc}P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [Math.1]

The LDPC code parameters for PLS1 and PLS2 are as following table 4.

TABLE 4

| Signaling | | | | K_{ldpc} | | | code | |
|---|---|---|---|---|---|---|---|---|
| Type | K_{sig} | K_{bch} | N_{bch}_{_{—}}_{parity} | (=N_{bch}) | N_{ldpc} | N_{ldpc}_{_{—}}_{parity} | rate | Q_{ldpc} |
| PLS1 | 342 | 1020 | 60 | 1080 | 4320 | 3240 | 1/4 | 36 |
| PLS2 | <1021 | | | | | | | |
| | >1020 | 2100 | | 2160 | 7200 | 5040 | 3/10 | 56 |

The LDPC parity puncturing block can perform puncturing on the PLS1 data and PLS 2 data.

When shortening is applied to the PLS1 data protection, some LDPC parity bits are punctured after LDPC encoding. Also, for the PLS2 data protection, the LDPC parity bits of PLS2 are punctured after LDPC encoding. These punctured bits are not transmitted.

The bit interleaver 6010 can interleave the each shortened and punctured PLS1 data and PLS2 data.

The constellation mapper 6020 can map the bit interleaved PLS1 data and PLS2 data onto constellations.

The above-described blocks may be omitted or replaced by blocks having similar or identical functions.

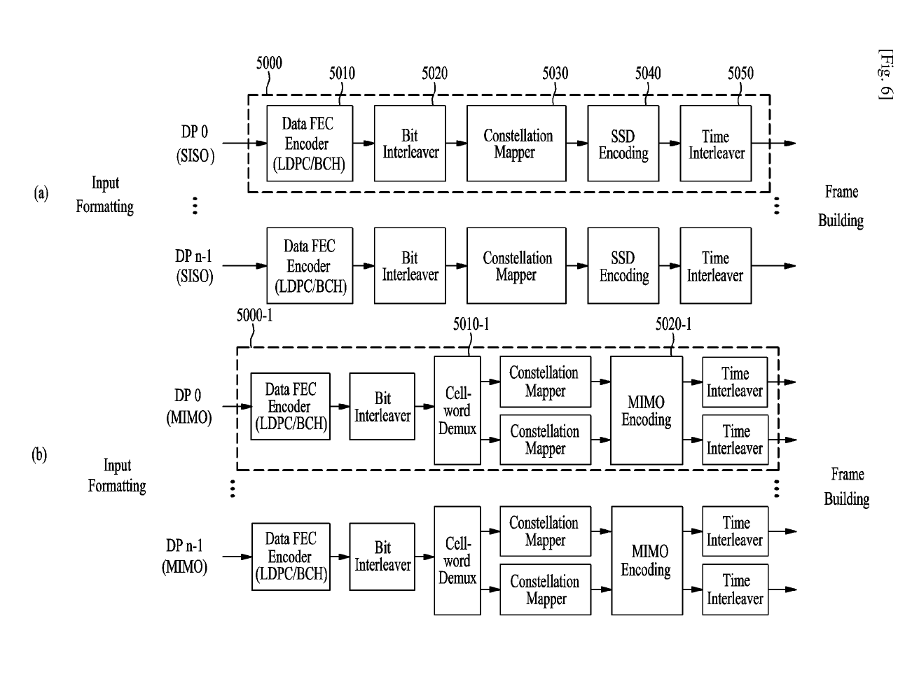

FIG. 7 illustrates a frame building block according to one embodiment of the present invention.

The frame building block illustrated in FIG. 7 corresponds to an embodiment of the frame building block 1020 described with reference to FIG. 1.

Referring to FIG. 7, the frame building block can include a delay compensation block 7000, a cell mapper 7010 and a frequency interleaver 7020. Description will be given of each block of the frame building block.

The delay compensation block 7000 can adjust the timing between the data pipes and the corresponding PLS data to ensure that they are co-timed at the transmitter end. The PLS data is delayed by the same amount as data pipes are by addressing the delays of data pipes caused by the Input Formatting block and BICM block. The delay of the BICM block is mainly due to the time interleaver. In-band signaling data carries information of the next TI group so that they are carried one frame ahead of the DPs to be signaled. The Delay Compensating block delays in-band signaling data accordingly.

The cell mapper 7010 can map PLS, EAC, FIC, DPs, auxiliary streams and dummy cells into the active carriers of the OFDM symbols in the frame. The basic function of the cell mapper 7010 is to map data cells produced by the TIs for each of the DPs, PLS cells, and EAC/FIC cells, if any, into arrays of active OFDM cells corresponding to each of the OFDM symbols within a frame. Service signaling data (such as PSI (program specific information)/SI) can be separately gathered and sent by a data pipe. The Cell Mapper operates according to the dynamic information produced by the scheduler and the configuration of the frame structure. Details of the frame will be described later.

The frequency interleaver 7020 can randomly interleave data cells received from the cell mapper 7010 to provide frequency diversity. Also, the frequency interleaver 7020 can operate on very OFDM symbol pair comprised of two sequential OFDM symbols using a different interleaving-seed order to get maximum interleaving gain in a single frame. Details of operations of the frequency interleaver 7020 will be described later.

The above-described blocks may be omitted or replaced by blocks having similar or identical functions.

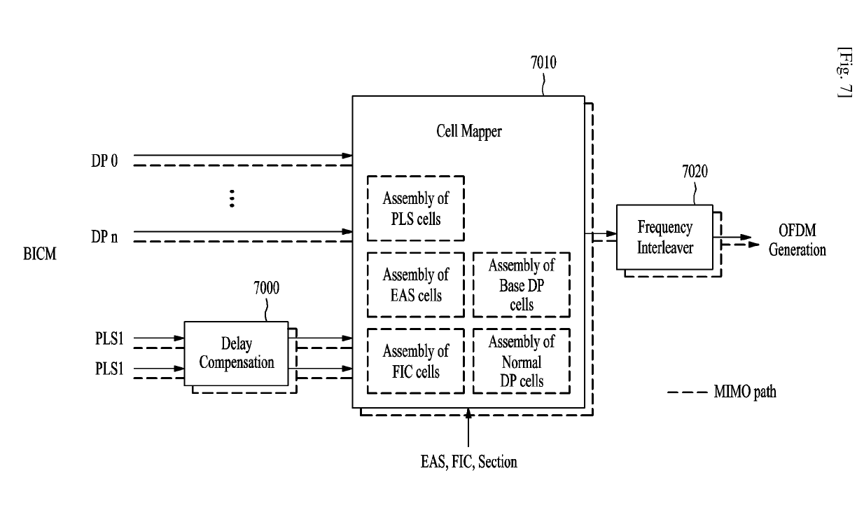

FIG. 8 illustrates an OFMD generation block according to an embodiment of the present invention.

The OFMD generation block illustrated in FIG. 8 corresponds to an embodiment of the OFMD generation block 1030 described with reference to FIG. 1.

The OFDM generation block modulates the OFDM carriers by the cells produced by the Frame Building block, inserts the pilots, and produces the time domain signal for transmission. Also, this block subsequently inserts guard intervals, and applies PAPR (Peak-to-Average Power Radio) reduction processing to produce the final RF signal.

Referring to FIG. 8, the frame building block can include a pilot and reserved tone insertion block 8000, a 2D-eSFN encoding block 8010, an IFFT (Inverse Fast Fourier Transform) block 8020, a PAPR reduction block 8030, a guard interval insertion block 8040, a preamble insertion block 8050, other system insertion block 8060 and a DAC block 8070. Description will be given of each block of the frame building block.

The pilot and reserved tone insertion block 8000 can insert pilots and the reserved tone.

Various cells within the OFDM symbol are modulated with reference information, known as pilots, which have transmitted values known a priori in the receiver. The information of pilot cells is made up of scattered pilots, continual pilots, edge pilots, FSS (frame signaling symbol) pilots and FES (frame edge symbol) pilots. Each pilot is transmitted at a particular boosted power level according to pilot type and pilot pattern. The value of the pilot information is derived from a reference sequence, which is a series of values, one for each transmitted carrier on any given symbol. The pilots can be used for frame synchronization, frequency synchronization, time synchronization, channel estimation, and transmission mode identification, and also can be used to follow the phase noise.

Reference information, taken from the reference sequence, is transmitted in scattered pilot cells in every symbol except the preamble, FSS and FES of the frame. Continual pilots are inserted in every symbol of the frame. The number and location of continual pilots depends on both the FFT size and the scattered pilot pattern. The edge carriers are edge pilots in every symbol except for the preamble symbol. They are inserted in order to allow frequency interpolation up to the edge of the spectrum. FSS pilots are inserted in FSS(s) and FES pilots are inserted in FES. They are inserted in order to allow time interpolation up to the edge of the frame.

The system according to an embodiment of the present invention supports the SFN network, where distributed MISO scheme is optionally used to support very robust transmission mode. The 2D-eSFN is a distributed MISO scheme that uses multiple TX antennas, each of which is located in the different transmitter site in the SFN network.

The 2D-eSFN encoding block 8010 can process a 2D-eSFN processing to distorts the phase of the signals transmitted from multiple transmitters, in order to create both time and frequency diversity in the SFN configuration. Hence, burst errors due to low flat fading or deep-fading for a long time can be mitigated.

The IFFT block 8020 can modulate the output from the 2D-eSFN encoding block 8010 using OFDM modulation scheme. Any cell in the data symbols which has not been designated as a pilot (or as a reserved tone) carries one of the data cells from the frequency interleaver. The cells are mapped to OFDM carriers.

The PAPR reduction block 8030 can perform a PAPR reduction on input signal using various PAPR reduction algorithm in the time domain.

The guard interval insertion block 8040 can insert guard intervals and the preamble insertion block 8050 can insert preamble in front of the signal. Details of a structure of the preamble will be described later. The other system insertion block 8060 can multiplex signals of a plurality of broadcast transmission/reception systems in the time domain such that data of two or more different broadcast transmission/reception systems providing broadcast services can be simultaneously transmitted in the same RF signal bandwidth. In this case, the two or more different broadcast transmission/reception systems refer to systems providing different broadcast services. The different broadcast services may refer to a terrestrial broadcast service, mobile broadcast service, etc. Data related to respective broadcast services can be transmitted through different frames.

The DAC block 8070 can convert an input digital signal into an analog signal and output the analog signal. The signal output from the DAC block 7800 can be transmitted through multiple output antennas according to the physical layer profiles. A Tx antenna according to an embodiment of the present invention can have vertical or horizontal polarity.

The above-described blocks may be omitted or replaced by blocks having similar or identical functions according to design.

FIG. 9 illustrates a structure of an apparatus for receiving broadcast signals for future broadcast services according to an embodiment of the present invention.

The apparatus for receiving broadcast signals for future broadcast services according to an embodiment of the present invention can correspond to the apparatus for transmitting broadcast signals for future broadcast services, described with reference to FIG. 1.

The apparatus for receiving broadcast signals for future broadcast services according to an embodiment of the present invention can include a synchronization & demodulation module 9000, a frame parsing module 9010, a demapping & decoding module 9020, an output processor 9030 and a signaling decoding module 9040. A description will be given of operation of each module of the apparatus for receiving broadcast signals.

The synchronization & demodulation module 9000 can receive input signals through m Rx antennas, perform signal detection and synchronization with respect to a system corresponding to the apparatus for receiving broadcast signals and carry out demodulation corresponding to a reverse procedure of the procedure performed by the apparatus for transmitting broadcast signals.

The frame parsing module 9100 can parse input signal frames and extract data through which a service selected by a user is transmitted. If the apparatus for transmitting broadcast signals performs interleaving, the frame parsing module 9100 can carry out deinterleaving corresponding to a reverse procedure of interleaving. In this case, the positions of a signal and data that need to be extracted can be obtained by decoding data output from the signaling decoding module 9400 to restore scheduling information generated by the apparatus for transmitting broadcast signals.

The demapping & decoding module 9200 can convert the input signals into bit domain data and then deinterleave the same as necessary. The demapping & decoding module 9200 can perform demapping for mapping applied for transmission efficiency and correct an error generated on a transmission channel through decoding. In this case, the demapping & decoding module 9200 can obtain transmission parameters necessary for demapping and decoding by decoding the data output from the signaling decoding module 9400.

The output processor 9300 can perform reverse procedures of various compression/signal processing procedures which are applied by the apparatus for transmitting broadcast signals to improve transmission efficiency. In this case, the output processor 9300 can acquire necessary control information from data output from the signaling decoding module 9400. The output of the output processor 8300 corresponds to a signal input to the apparatus for transmitting broadcast signals and may be MPEG-TSs, IP streams (v4 or v6) and generic streams.

The signaling decoding module 9400 can obtain PLS information from the signal demodulated by the synchronization & demodulation module 9000. As described above, the frame parsing module 9100, demapping & decoding module 9200 and output processor 9300 can execute functions thereof using the data output from the signaling decoding module 9400.

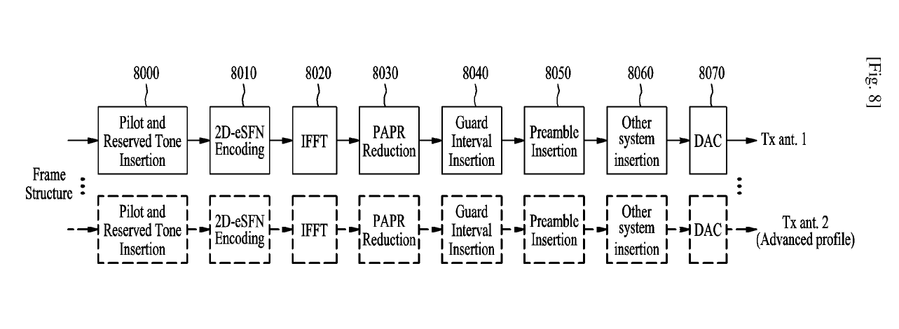

FIG. 10 illustrates a frame structure according to an embodiment of the present invention.

FIG. 10 shows an example configuration of the frame types and FRUs in a super-frame. (a) shows a super frame according to an embodiment of the present invention, (b) shows FRU (Frame Repetition Unit) according to an embodiment of the present invention, (c) shows frames of variable PHY profiles in the FRU and (d) shows a structure of a frame.

A super-frame may be composed of eight FRUs. The FRU is a basic multiplexing unit for TDM of the frames, and is repeated eight times in a super-frame.

Each frame in the FRU belongs to one of the PHY profiles, (base, handheld, advanced) or FEF. The maximum allowed number of the frames in the FRU is four and a given PHY profile can appear any number of times from zero times to four times in the FRU (e.g., base, base, handheld, advanced). PHY profile definitions can be extended using reserved values of the PHY_PROFILE in the preamble, if required.

The FEF part is inserted at the end of the FRU, if included. When the FEF is included in the FRU, the minimum number of FEFs is 8 in a super-frame. It is not recommended that FEF parts be adjacent to each other.

One frame is further divided into a number of OFDM symbols and a preamble. As shown in (d), the frame comprises a preamble, one or more frame signaling symbols (FSS), normal data symbols and a frame edge symbol (FES).

The preamble is a special symbol that enables fast Futurecast UTB system signal detection and provides a set of basic transmission parameters for efficient transmission and reception of the signal. The detailed description of the preamble will be will be described later.

The main purpose of the FSS(s) is to carry the PLS data. For fast synchronization and channel estimation, and hence fast decoding of PLS data, the FSS has more dense pilot pattern than the normal data symbol. The FES has exactly the same pilots as the FSS, which enables frequency-only interpolation within the FES and temporal interpolation, without extrapolation, for symbols immediately preceding the FES.

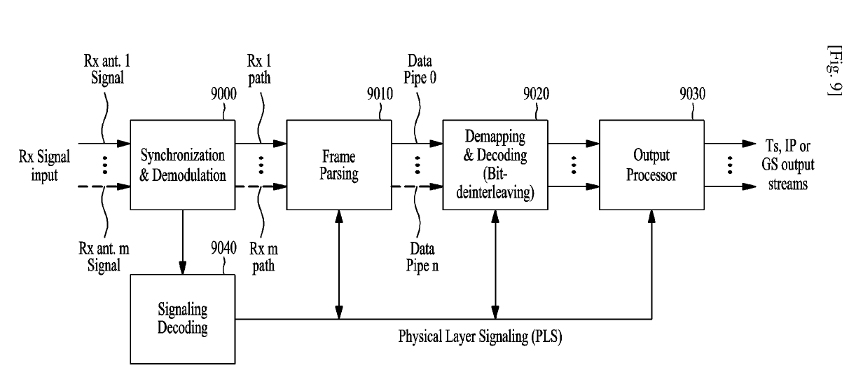

FIG. 11 illustrates a signaling hierarchy structure of the frame according to an embodiment of the present invention.

FIG. 11 illustrates the signaling hierarchy structure, which is split into three main parts: the preamble signaling data 11000, the PLS1 data 11010 and the PLS2 data 11020. The purpose of the preamble, which is carried by the preamble symbol in every frame, is to indicate the transmission type and basic transmission parameters of that frame. The PLS1 enables the receiver to access and decode the PLS2 data, which contains the parameters to access the DP of interest. The PLS2 is carried in every frame and split into two main parts: PLS2-STAT data and PLS2-DYN data. The static and dynamic portion of PLS2 data is followed by padding, if necessary.

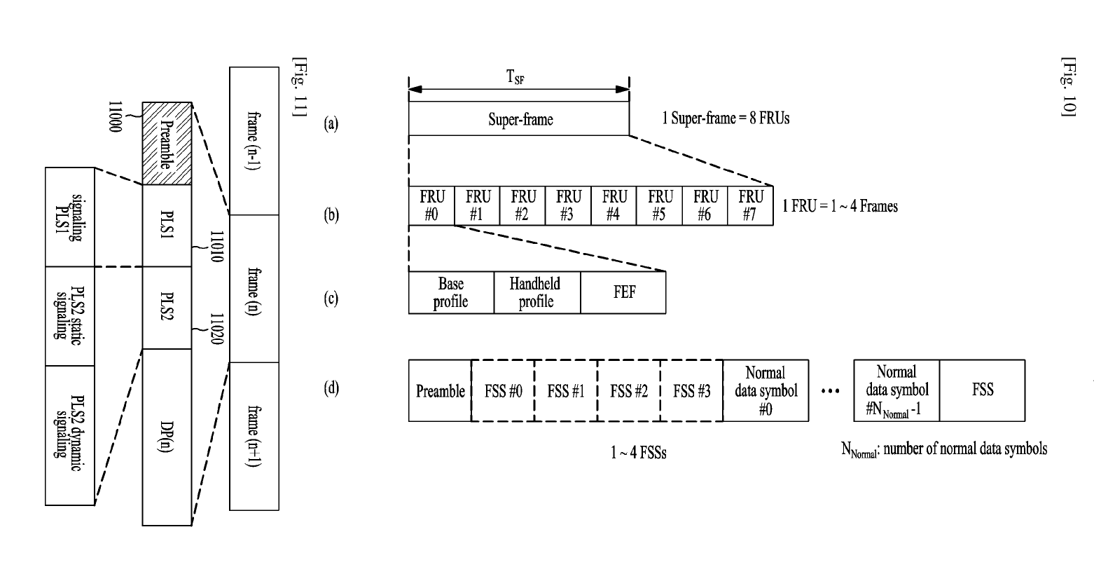

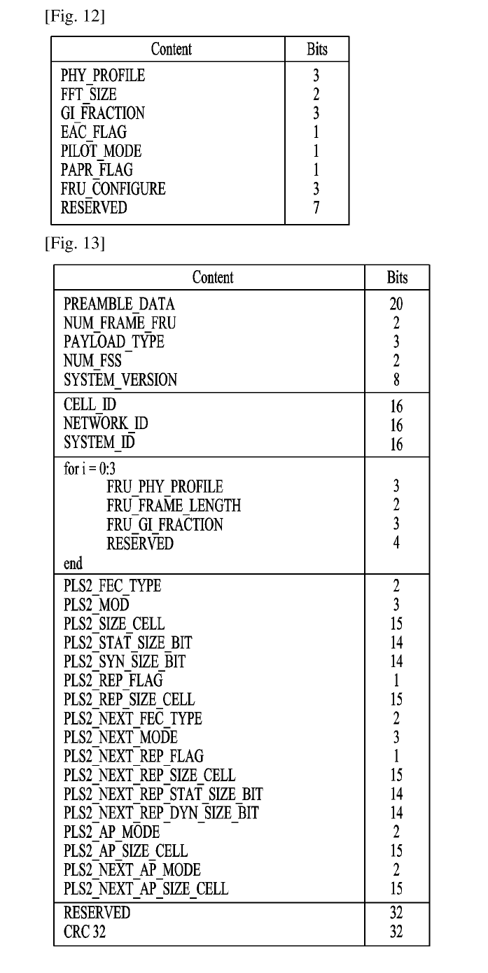

FIG. 12 illustrates preamble signaling data according to an embodiment of the present invention.

Preamble signaling data carries 21 bits of information that are needed to enable the receiver to access PLS data and trace DPs within the frame structure. Details of the preamble signaling data are as follows:

PHY_PROFILE: This 3-bit field indicates the PHY profile type of the current frame. The mapping of different PHY profile types is given in below table 5.

TABLE 5

| Value | PHY Profile |
|---|---|
| 000 | Base profile |
| 001 | Handheld profile |
| 010 | Advanced profiled |
| 011~110 | Reserved |
| 111 | FEF |

FFT_SIZE: This 2 bit field indicates the FFT size of the current frame within a frame-group, as described in below table 6.

TABLE 6

| Value | FFT size |
|---|---|
| 00 | 8K FFT |
| 01 | 16K FFT |
| 10 | 32K FFT |
| 11 | Reserved |

GI_FRACTION: This 3 bit field indicates the guard interval fraction value in the current super-frame, as described in below table 7.

TABLE 7

| Value | GI_FRACTION |
|---|---|
| 000 | ⅕ |
| 001 | 1/10 |
| 010 | 1/20 |
| 011 | 1/40 |
| 100 | 1/80 |
| 101 | 1/160 |
| 110~111 | Reserved |

EAC_FLAG: This 1 bit field indicates whether the EAC is provided in the current frame. If this field is set to ‘1’, emergency alert service (EAS) is provided in the current frame. If this field set to ‘0’, EAS is not carried in the current frame. This field can be switched dynamically within a super-frame.

PILOT_MODE: This 1-bit field indicates whether the pilot mode is mobile mode or fixed mode for the current frame in the current frame-group. If this field is set to ‘0’, mobile pilot mode is used. If the field is set to ‘1’, the fixed pilot mode is used.

PAPR_FLAG: This 1-bit field indicates whether PAPR reduction is used for the current frame in the current frame-group. If this field is set to value ‘1’, tone reservation is used for PAPR reduction. If this field is set to ‘0’, PAPR reduction is not used.

FRU_CONFIGURE: This 3-bit field indicates the PHY profile type configurations of the frame repetition units (FRU) that are present in the current super-frame. All profile types conveyed in the current super-frame are identified in this field in all preambles in the current super-frame. The 3-bit field has a different definition for each profile, as show in below table 8.

TABLE 8

| | | Current | Current | |
|---|---|---|---|---|
| | Current | PHY_PROFILE = | PHY_PROFILE = | Current |
| | PHY_PROFILE = | ‘001’ | ‘010’ | PHY_PROFILE = |
| | ‘000’ (base) | (handheld) | (advanced) | ‘111’ (FEF) |
| FRU_CONFIGURE = | Only base | Only handheld | Only advanced | Only FEF |
| 000 | profile present | profile present | profile present | present |
| FRU_CONFIGURE = | Handheld | Base profile | Base profile | Base profile |
| 1XX | profile present | present | present | present |
| FRU_CONFIGURE = | Advanced | Advanced | Handheld | Handheld |
| X1X | profile present | profile present | profile present | profile present |
| FRU_CONFIGURE = | FEF present | FEF present | FEF present | Advanced |
| XX1 | | | | profile present |

RESERVED: This 7-bit field is reserved for future use.

FIG. 13 illustrates PLS1 data according to an embodiment of the present invention.

PLS1 data provides basic transmission parameters including parameters required to enable the reception and decoding of the PLS2. As above mentioned, the PLS1 data remain unchanged for the entire duration of one frame-group. The detailed definition of the signaling fields of the PLS1 data are as follows:

PREAMBLE_DATA: This 20-bit field is a copy of the preamble signaling data excluding the EAC_FLAG.

NUM_FRAME_FRU: This 2-bit field indicates the number of the frames per FRU.

PAYLOAD_TYPE: This 3-bit field indicates the format of the payload data carried in the frame-group. PAYLOAD_TYPE is signaled as shown in table 9.

TABLE 9

| value | Payload type |
|---|---|
| 1XX | TS stream is transmitted |
| X1X | IP stream is transmitted |
| XX1 | GS stream is transmitted |

NUM_FSS: This 2-bit field indicates the number of FSS symbols in the current frame.

SYSTEM_VERSION: This 8-bit field indicates the version of the transmitted signal format. The SYSTEM_VERSION is divided into two 4-bit fields, which are a major version and a minor version.

Major version: The MSB four bits of SYSTEM_VERSION field indicate major version information. A change in the major version field indicates a non-backward-compatible change. The default value is ‘0000’. For the version described in this standard, the value is set to ‘0000’.

Minor version: The LSB four bits of SYSTEM_VERSION field indicate minor version information. A change in the minor version field is backward-compatible.

CELL_ID: This is a 16-bit field which uniquely identifies a geographic cell in an ATSC network. An ATSC cell coverage area may consist of one or more frequencies, depending on the number of frequencies used per Futurecast UTB system. If the value of the CELL_ID is not known or unspecified, this field is set to ‘0’.

NETWORK_ID: This is a 16-bit field which uniquely identifies the current ATSC network.

SYSTEM_ID: This 16-bit field uniquely identifies the Futurecast UTB system within the ATSC network. The Futurecast UTB system is the terrestrial broadcast system whose input is one or more input streams (TS, IP, GS) and whose output is an RF signal. The Futurecast UTB system carries one or more PHY profiles and FEF, if any. The same Futurecast UTB system may carry different input streams and use different RF frequencies in different geographical areas, allowing local service insertion. The frame structure and scheduling is controlled in one place and is identical for all transmissions within a Futurecast UTB system. One or more Futurecast UTB systems may have the same SYSTEM_ID meaning that they all have the same physical layer structure and configuration.

The following loop consists of FRU_PHY_PROFILE, FRU_FRAME_LENGTH, FRU_GI_FRACTION, and RESERVED which are used to indicate the FRU configuration and the length of each frame type. The loop size is fixed so that four PHY profiles (including a FEF) are signaled within the FRU. If NUM_FRAME_FRU is less than 4, the unused fields are filled with zeros.

FRU_PHY_PROFILE: This 3-bit field indicates the PHY profile type of the (i+1)^{th} (i is the loop index) frame of the associated FRU. This field uses the same signaling format as shown in the table 8.

FRU_FRAME_LENGTH: This 2-bit field indicates the length of the (i+1)^{th} frame of the associated FRU. Using FRU_FRAME_LENGTH together with FRU_GI_FRACTION, the exact value of the frame duration can be obtained.

FRU_GI_FRACTION: This 3-bit field indicates the guard interval fraction value of the (i+1)^{th} frame of the associated FRU. FRU_GI_FRACTION is signaled according to the table 7.

RESERVED: This 4-bit field is reserved for future use.

The following fields provide parameters for decoding the PLS2 data.

PLS2_FEC_TYPE: This 2-bit field indicates the FEC type used by the PLS2 protection. The FEC type is signaled according to table 10. The details of the LDPC codes will be described later.

TABLE 10

| Content | PLS2 FEC type |
|---|---|
| 00 | 4K-1/4 and 7K-3/10 LDPC codes |
| 01~11 | Reserved |

PLS2_MOD: This 3-bit field indicates the modulation type used by the PLS2. The modulation type is signaled according to table 11.

TABLE 11

| Value | PLS2_MODE |
|---|---|
| 000 | BPSK |
| 001 | QPSK |
| 010 | QAM-16 |
| 011 | NUQ-64 |
| 100~111 | Reserved |

PLS2_SIZE_CELL: This 15-bit field indicates Cₜₒₜₐₗ_{_}ₚₐᵣₜᵢₐₗ_{_}_{block}, the size (specified as the number of QAM cells) of the collection of full coded blocks for PLS2 that is carried in the current frame-group. This value is constant during the entire duration of the current frame-group.

PLS2_STAT_SIZE_BIT: This 14-bit field indicates the size, in bits, of the PLS2-STAT for the current frame-group. This value is constant during the entire duration of the current frame-group.

PLS2_DYN_SIZE_BIT: This 14-bit field indicates the size, in bits, of the PLS2-DYN for the current frame-group. This value is constant during the entire duration of the current frame-group.

PLS2_REP_FLAG: This 1-bit flag indicates whether the PLS2 repetition mode is used in the current frame-group. When this field is set to value ‘1’, the PLS2 repetition mode is activated. When this field is set to value ‘0’, the PLS2 repetition mode is deactivated.

PLS2_REP_SIZE_CELL: This 15-bit field indicates Cₜₒₜₐₗ_{_}ₚₐᵣₜᵢₐₗ_{_}_{block}, the size (specified as the number of QAM cells) of the collection of partial coded blocks for PLS2 carried in every frame of the current frame-group, when PLS2 repetition is used. If repetition is not used, the value of this field is equal to 0. This value is constant during the entire duration of the current frame-group.

PLS2_NEXT_FEC_TYPE: This 2-bit field indicates the FEC type used for PLS2 that is carried in every frame of the next frame-group. The FEC type is signaled according to the table 10.

PLS2_NEXT_MOD: This 3-bit field indicates the modulation type used for PLS2 that is carried in every frame of the next frame-group. The modulation type is signaled according to the table 11.

PLS2_NEXT_REP_FLAG: This 1-bit flag indicates whether the PLS2 repetition mode is used in the next frame-group. When this field is set to value ‘1’, the PLS2 repetition mode is activated. When this field is set to value ‘0’, the PLS2 repetition mode is deactivated.

PLS2_NEXT_REP_SIZE_CELL: This 15-bit field indicates Cₜₒₜₐₗ_{_}_{full}_{_}_{block}, The size (specified as the number of QAM cells) of the collection of full coded blocks for PLS2 that is carried in every frame of the next frame-group, when PLS2 repetition is used. If repetition is not used in the next frame-group, the value of this field is equal to 0. This value is constant during the entire duration of the current frame-group.

PLS2_NEXT_REP_STAT_SIZE_BIT: This 14-bit field indicates the size, in bits, of the PLS2-STAT for the next frame-group. This value is constant in the current frame-group.

PLS2_NEXT_REP_DYN_SIZE_BIT: This 14-bit field indicates the size, in bits, of the PLS2-DYN for the next frame-group. This value is constant in the current frame-group.

PLS2_AP_MODE: This 2-bit field indicates whether additional parity is provided for PLS2 in the current frame-group. This value is constant during the entire duration of the current frame-group. The below table 12 gives the values of this field. When this field is set to ‘00’, additional parity is not used for the PLS2 in the current frame-group.

TABLE 12

| Value | PLS2-AP mode |
|---|---|
| 00 | AP is not provided |
| 01 | AP1 mode |
| 10~11 | Reserved |

PLS2_AP_SIZE_CELL: This 15-bit field indicates the size (specified as the number of QAM cells) of the additional parity bits of the PLS2. This value is constant during the entire duration of the current frame-group.

PLS2_NEXT_AP_MODE: This 2-bit field indicates whether additional parity is provided for PLS2 signaling in every frame of next frame-group. This value is constant during the entire duration of the current frame-group. The table 12 defines the values of this field

PLS2_NEXT_AP_SIZE_CELL: This 15-bit field indicates the size (specified as the number of QAM cells) of the additional parity bits of the PLS2 in every frame of the next frame-group. This value is constant during the entire duration of the current frame-group.

RESERVED: This 32-bit field is reserved for future use.

CRC_32: A 32-bit error detection code, which is applied to the entire PLS1 signaling.

FIG. 14 illustrates PLS2 data according to an embodiment of the present invention.

FIG. 14 illustrates PLS2-STAT data of the PLS2 data. The PLS2-STAT data are the same within a frame-group, while the PLS2-DYN data provide information that is specific for the current frame.

The details of fields of the PLS2-STAT data are as follows:

FIC_FLAG: This 1-bit field indicates whether the FIC is used in the current frame-group. If this field is set to ‘1’, the FIC is provided in the current frame. If this field set to ‘0’, the FIC is not carried in the current frame. This value is constant during the entire duration of the current frame-group.

AUX_FLAG: This 1-bit field indicates whether the auxiliary stream(s) is used in the current frame-group. If this field is set to ‘1’, the auxiliary stream is provided in the current frame. If this field set to ‘0’, the auxiliary stream is not carried in the current frame. This value is constant during the entire duration of current frame-group.

NUM_DP: This 6-bit field indicates the number of DPs carried within the current frame. The value of this field ranges from 1 to 64, and the number of DPs is NUM_DP+1.

DP_ID: This 6-bit field identifies uniquely a DP within a PHY profile.

DP_TYPE: This 3-bit field indicates the type of the DP. This is signaled according to the below table 13.

TABLE 13

| Value | DP Type |
|---|---|
| 000 | DP Type 1 |
| 001 | DP Type 2 |
| 010~111 | reserved |

DP_GROUP_ID: This 8-bit field identifies the DP group with which the current DP is associated. This can be used by a receiver to access the DPs of the service components associated with a particular service, which will have the same DP_GROUP_ID.

BASE_DP_ID: This 6-bit field indicates the DP carrying service signaling data (such as PSI/SI) used in the Management layer. The DP indicated by BASE_DP_ID may be either a normal DP carrying the service signaling data along with the service data or a dedicated DP carrying only the service signaling data

DP_FEC_TYPE: This 2-bit field indicates the FEC type used by the associated DP. The FEC type is signaled according to the below table 14.

TABLE 14

| Value | FEC_TYPE |
|---|---|
| 00 | 16K LDPC |
| 01 | 64K LDPC |
| 10~11 | Reserved |

DP_COD: This 4-bit field indicates the code rate used by the associated DP. The code rate is signaled according to the below table 15.

TABLE 15

| Value | Code rate |
|---|---|
| 0000 | 5/15 |
| 0001 | 6/15 |
| 0010 | 7/15 |
| 0011 | 8/15 |
| 0100 | 9/15 |
| 0101 | 10/15 |
| 0110 | 11/15 |
| 0111 | 12/15 |
| 1000 | 13/15 |
| 1001~1111 | Reserved |

DP_MOD: This 4-bit field indicates the modulation used by the associated DP. The modulation is signaled according to the below table 16.

TABLE 16

| Value | Modulation |
|---|---|
| 0000 | QPSK |
| 0001 | QAM-16 |
| 0010 | NUQ-64 |
| 0011 | NUQ-256 |
| 0100 | NUQ-1024 |
| 0101 | NUC-16 |
| 0110 | NUC-64 |
| 0111 | NUC-256 |
| 1000 | NUC-1024 |
| 1001~1111 | reserved |

DP_SSD_FLAG: This 1-bit field indicates whether the SSD mode is used in the associated DP. If this field is set to value ‘1’, SSD is used. If this field is set to value ‘0’, SSD is not used.

The following field appears only if PHY_PROFILE is equal to ‘010’, which indicates the advanced profile:

DP_MIMO: This 3-bit field indicates which type of MIMO encoding process is applied to the associated DP. The type of MIMO encoding process is signaled according to the table 17.

TABLE 17

| Value | MIMO encoding |
|---|---|
| 0000 | FR-SM |
| 0001 | FRFD-SM |
| 010~111 | reserved |

DP_TI_TYPE: This 1-bit field indicates the type of time-interleaving. A value of ‘0’ indicates that one TI group corresponds to one frame and contains one or more TI-blocks. A value of ‘1’ indicates that one TI group is carried in more than one frame and contains only one TI-block.

DP_TI_LENGTH: The use of this 2-bit field (the allowed values are only 1, 2, 4, 8) is determined by the values set within the DP_TI_TYPE field as follows:

If the DP_TI_TYPE is set to the value ‘1’, this field indicates P_{I}, the number of the frames to which each TI group is mapped, and there is one TI-block per TI group (N_{TI}=1). The allowed P_{I} values with 2-bit field are defined in the below table 18.

If the DP_TI_TYPE is set to the value ‘0’, this field indicates the number of TI-blocks N_{TI} per TI group, and there is one TI group per frame (P_{I}=1). The allowed P_{I} values with 2-bit field are defined in the below table 18.

TABLE 18

| 2-bit field | P_{I} | N_{TI} |
|---|---|---|
| 00 | 1 | 1 |
| 01 | 2 | 2 |
| 10 | 4 | 3 |
| 11 | 8 | 4 |

DP_FRAME_INTERVAL: This 2-bit field indicates the frame interval (I_{JUMP}) within the frame-group for the associated DP and the allowed values are 1, 2, 4, 8 (the corresponding 2-bit field is ‘00’, ‘01’, ‘10’, or ‘11’, respectively). For DPs that do not appear every frame of the frame-group, the value of this field is equal to the interval between successive frames. For example, if a DP appears on the frames 1, 5, 9, 13, etc., this field is set to ‘4’. For DPs that appear in every frame, this field is set to ‘1’.

DP_TI_BYPASS: This 1-bit field determines the availability of time interleaver. If time interleaving is not used for a DP, it is set to ‘1’. Whereas if time interleaving is used it is set to ‘0’.

DP_FIRST_FRAME_IDX: This 5-bit field indicates the index of the first frame of the super-frame in which the current DP occurs. The value of DP_FIRST_FRAME_IDX ranges from 0 to 31

DP_NUM_BLOCK_MAX: This 10-bit field indicates the maximum value of DP_NUM_BLOCKS for this DP. The value of this field has the same range as DP_NUM_BLOCKS.

DP_PAYLOAD_TYPE: This 2-bit field indicates the type of the payload data carried by the given DP. DP_PAYLOAD_TYPE is signaled according to the below table 19.

TABLE 19

| Value | Payload Type |
|---|---|
| 00 | TS. |
| 01 | IP |
| 10 | GS |
| 11 | reserved |

DP_INBAND_MODE: This 2-bit field indicates whether the current DP carries in-band signaling information. The in-band signaling type is signaled according to the below table 20.

TABLE 20

| Value | In-band mode |
|---|---|
| 00 | In-band signaling is not carried. |
| 01 | INBAND-PLS is carried only |
| 10 | INBAND-ISSY is carried only |
| 11 | INBAND-PLS and INBAND-ISSY are carried |

DP_PROTOCOL_TYPE: This 2-bit field indicates the protocol type of the payload carried by the given DP. It is signaled according to the below table 21 when input payload types are selected.

TABLE 21

| | If DP_PAY- | If DP_PAY- | If DP_PAY- |
|---|---|---|---|
| | LOAD_TYPE | LOAD_TYPE | LOAD_TYPE |
| Value | Is TS | Is IP | Is GS |
| 00 | MPEG2-TS | IPv4 | (Note) |
| 01 | Reserved | IPv6 | Reserved |
| 10 | Reserved | Reserved | Reserved |
| 11 | Reserved | Reserved | Reserved |

DP_CRC_MODE: This 2-bit field indicates whether CRC encoding is used in the Input Formatting block. The CRC mode is signaled according to the below table 22.

TABLE 22

| Value | CRC mode |
|---|---|
| 00 | Not used |
| 01 | CRC-8 |
| 10 | CRC-16 |
| 11 | CRC-32 |

DNP_MODE: This 2-bit field indicates the null-packet deletion mode used by the associated DP when DP_PAYLOAD_TYPE is set to TS (‘00’). DNP_MODE is signaled according to the below table 23. If DP_PAYLOAD_TYPE is not TS (‘00’), DNP_MODE is set to the value ‘00’.

TABLE 23

| Value | Null-packet deletion mode |
|---|---|
| 00 | Not used |
| 01 | DNP-NORMAL |
| 10 | DNP-OFFSET |
| 11 | reserved |

ISSY_MODE: This 2-bit field indicates the ISSY mode used by the associated DP when DP_PAYLOAD_TYPE is set to TS (‘00’). The ISSY_MODE is signaled according to the below table 24 If DP_PAYLOAD_TYPE is not TS (‘00’), ISSY_MODE is set to the value ‘00’.

TABLE 24

| Value | ISSY mode |
|---|---|
| 00 | Not used |
| 01 | ISSY-UP |
| 10 | ISSY-BBF |
| 11 | reserved |

HC_MODE_TS: This 2-bit field indicates the TS header compression mode used by the associated DP when DP_PAYLOAD_TYPE is set to TS (‘00’). The HC_MODE_TS is signaled according to the below table 25.

TABLE 25

| Value | Header compression mode |
|---|---|
| 00 | HC_MODE_TS 1 |
| 01 | HC_MODE_TS 2 |
| 10 | HC_MODE_TS 3 |
| 11 | HC_MODE_TS 4 |

HC_MODE_IP: This 2-bit field indicates the IP header compression mode when DP_PAYLOAD_TYPE is set to IP (‘01’). The HC_MODE_IP is signaled according to the below table 26.

TABLE 26

| Value | Header compression mode |
|---|---|
| 00 | No compression |
| 01 | HC_MODE_IP 1 |
| 10~11 | reserved |

PID: This 13-bit field indicates the PID number for TS header compression when DP_PAYLOAD_TYPE is set to TS (‘00’) and HC_MODE_TS is set to ‘01’ or ‘10’.

RESERVED: This 8-bit field is reserved for future use.

The following field appears only if FIC_FLAG is equal to ‘1’:

FIC_VERSION: This 8-bit field indicates the version number of the FIC.

FIC_LENGTH_BYTE: This 13-bit field indicates the length, in bytes, of the FIC.

RESERVED: This 8-bit field is reserved for future use.

The following field appears only if AUX_FLAG is equal to ‘1’:

NUM_AUX: This 4-bit field indicates the number of auxiliary streams. Zero means no auxiliary streams are used.

AUX_CONFIG_RFU: This 8-bit field is reserved for future use.

AUX_STREAM_TYPE: This 4-bit is reserved for future use for indicating the type of the current auxiliary stream.

AUX_PRIVATE_CONFIG: This 28-bit field is reserved for future use for signaling auxiliary streams.

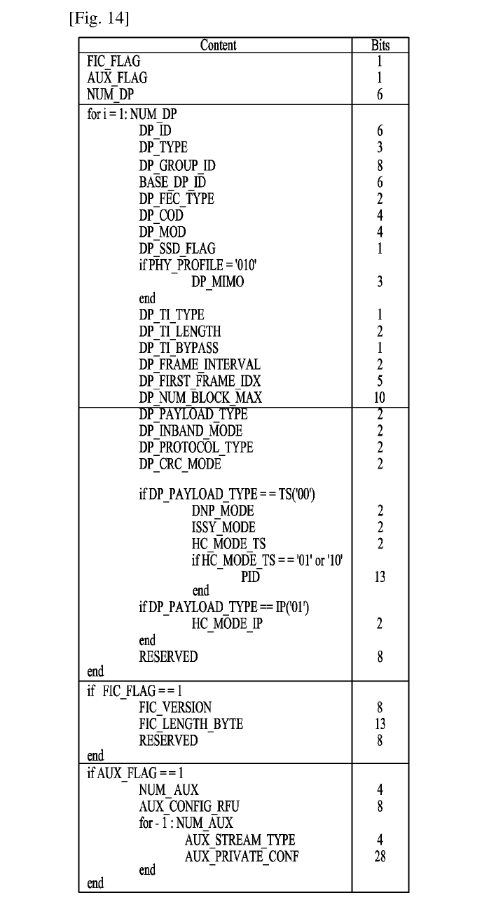

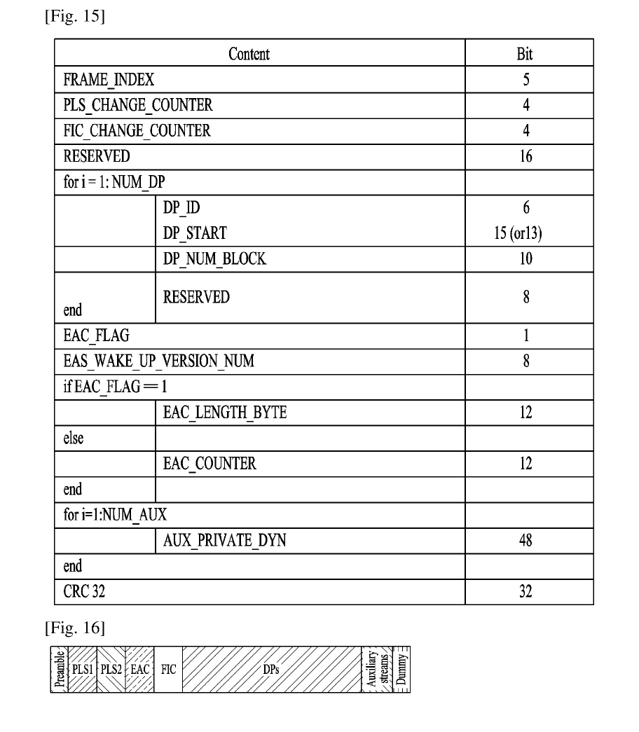

FIG. 15 illustrates PLS2 data according to another embodiment of the present invention.

FIG. 15 illustrates PLS2-DYN data of the PLS2 data. The values of the PLS2-DYN data may change during the duration of one frame-group, while the size of fields remains constant.

The details of fields of the PLS2-DYN data are as follows:

FRAME_INDEX: This 5-bit field indicates the frame index of the current frame within the super-frame. The index of the first frame of the super-frame is set to ‘0’.

PLS_CHANGE_COUNTER: This 4-bit field indicates the number of super-frames ahead where the configuration will change. The next super-frame with changes in the configuration is indicated by the value signaled within this field. If this field is set to the value ‘0000’, it means that no scheduled change is foreseen: e.g., value ‘1’ indicates that there is a change in the next super-frame.

FIC_CHANGE_COUNTER: This 4-bit field indicates the number of super-frames ahead where the configuration (i.e., the contents of the FIC) will change. The next super-frame with changes in the configuration is indicated by the value signaled within this field. If this field is set to the value ‘0000’, it means that no scheduled change is foreseen: e.g. value ‘0001’ indicates that there is a change in the next super-frame.

RESERVED: This 16-bit field is reserved for future use.

The following fields appear in the loop over NUM_DP, which describe the parameters associated with the DP carried in the current frame.

DP_ID: This 6-bit field indicates uniquely the DP within a PHY profile.

DP_START: This 15-bit (or 13-bit) field indicates the start position of the first of the DPs using the DPU addressing scheme. The DP_START field has differing length according to the PHY profile and FFT size as shown in the below table 27.

TABLE 27

DP_START field size

| PHY profile | 64K | 16K |
|---|---|---|
| Base | 13 bit | 15 bit |
| Handheld | — | 13 bit |
| Advanced | 13 bit | 15 bit |

DP_NUM_BLOCK: This 10-bit field indicates the number of FEC blocks in the current TI group for the current DP. The value of DP_NUM_BLOCK ranges from 0 to 1023

RESERVED: This 8-bit field is reserved for future use.

The following fields indicate the FIC parameters associated with the EAC.

EAC_FLAG: This 1-bit field indicates the existence of the EAC in the current frame. This bit is the same value as the EAC_FLAG in the preamble.

EAS_WAKE_UP_VERSION_NUM: This 8-bit field indicates the version number of a wake-up indication.

If the EAC_FLAG field is equal to ‘1’, the following 12 bits are allocated for EAC_LENGTH_BYTE field. If the EAC_FLAG field is equal to ‘0’, the following 12 bits are allocated for EAC_COUNTER.

EAC_LENGTH_BYTE: This 12-bit field indicates the length, in byte, of the EAC.

EAC_COUNTER: This 12-bit field indicates the number of the frames before the frame where the EAC arrives.

The following field appears only if the AUX_FLAG field is equal to ‘1’:

AUX_PRIVATE_DYN: This 48-bit field is reserved for future use for signaling auxiliary streams. The meaning of this field depends on the value of AUX_STREAM_TYPE in the configurable PLS2-STAT.

CRC_32: A 32-bit error detection code, which is applied to the entire PLS2.

FIG. 16 illustrates a logical structure of a frame according to an embodiment of the present invention.

As above mentioned, the PLS, EAC, FIC, DPs, auxiliary streams and dummy cells are mapped into the active carriers of the OFDM symbols in the frame. The PLS1 and PLS2 are first mapped into one or more FSS(s). After that, EAC cells, if any, are mapped immediately following the PLS field, followed next by FIC cells, if any. The DPs are mapped next after the PLS or EAC, FIC, if any. Type 1 DPs follows first, and Type 2 DPs next. The details of a type of the DP will be described later. In some case, DPs may carry some special data for EAS or service signaling data. The auxiliary stream or streams, if any, follow the DPs, which in turn are followed by dummy cells. Mapping them all together in the above mentioned order, i.e. PLS, EAC, FIC, DPs, auxiliary streams and dummy data cells exactly fill the cell capacity in the frame.

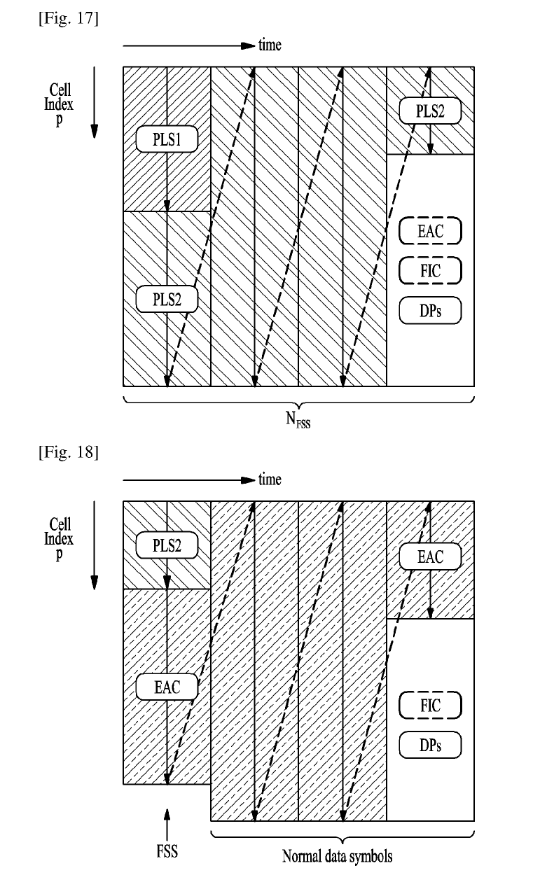

FIG. 17 illustrates PLS mapping according to an embodiment of the present invention.

PLS cells are mapped to the active carriers of FSS(s). Depending on the number of cells occupied by PLS, one or more symbols are designated as FSS(s), and the number of FSS(s) N_{FSS} is signaled by NUM_FSS in PLS1. The FSS is a special symbol for carrying PLS cells. Since robustness and latency are critical issues in the PLS, the FSS(s) has higher density of pilots allowing fast synchronization and frequency-only interpolation within the FSS.

PLS cells are mapped to active carriers of the N_{FSS} FSS(s) in a top-down manner as shown in an example in FIG. 17. The PLS1 cells are mapped first from the first cell of the first FSS in an increasing order of the cell index. The PLS2 cells follow immediately after the last cell of the PLS1 and mapping continues downward until the last cell index of the first FSS. If the total number of required PLS cells exceeds the number of active carriers of one FSS, mapping proceeds to the next FSS and continues in exactly the same manner as the first FSS.

After PLS mapping is completed, DPs are carried next. If EAC, FIC or both are present in the current frame, they are placed between PLS and “normal” DPs.

FIG. 18 illustrates EAC mapping according to an embodiment of the present invention.

EAC is a dedicated channel for carrying EAS messages and links to the DPs for EAS. EAS support is provided but EAC itself may or may not be present in every frame. EAC, if any, is mapped immediately after the PLS2 cells. EAC is not preceded by any of the FIC, DPs, auxiliary streams or dummy cells other than the PLS cells. The procedure of mapping the EAC cells is exactly the same as that of the PLS.

The EAC cells are mapped from the next cell of the PLS2 in increasing order of the cell index as shown in the example in FIG. 18. Depending on the EAS message size, EAC cells may occupy a few symbols, as shown in FIG. 18.

EAC cells follow immediately after the last cell of the PLS2, and mapping continues downward until the last cell index of the last FSS. If the total number of required EAC cells exceeds the number of remaining active carriers of the last FSS mapping proceeds to the next symbol and continues in exactly the same manner as FSS(s). The next symbol for mapping in this case is the normal data symbol, which has more active carriers than a FSS.

After EAC mapping is completed, the FIC is carried next, if any exists. If FIC is not transmitted (as signaled in the PLS2 field), DPs follow immediately after the last cell of the EAC.

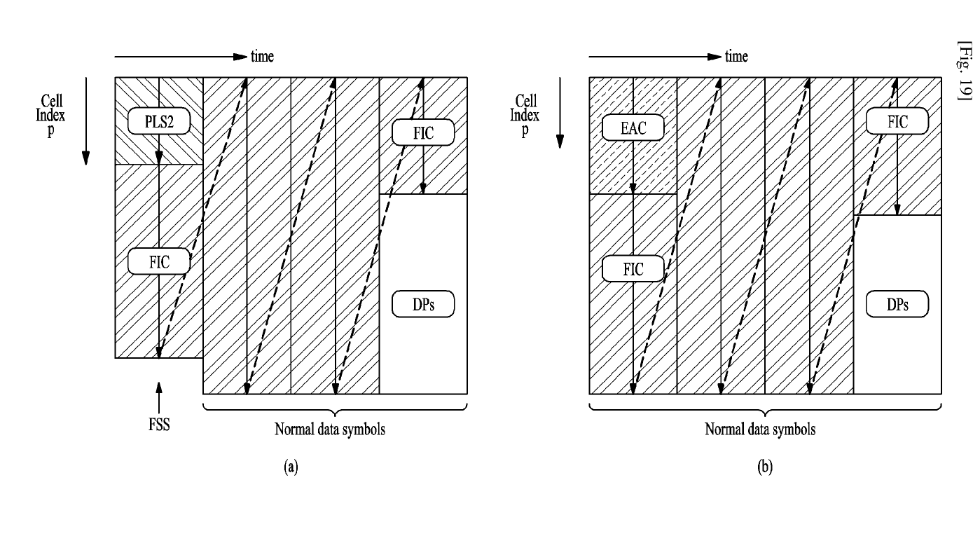

FIG. 19 illustrates FIC mapping according to an embodiment of the present invention.

(a) shows an example mapping of FIC cell without EAC and (b) shows an example mapping of FIC cell with EAC.

FIC is a dedicated channel for carrying cross-layer information to enable fast service acquisition and channel scanning. This information primarily includes channel binding information between DPs and the services of each broadcaster. For fast scan, a receiver can decode FIC and obtain information such as broadcaster ID, number of services, and BASE_DP_ID. For fast service acquisition, in addition to FIC, base DP can be decoded using BASE_DP_ID. Other than the content it carries, a base DP is encoded and mapped to a frame in exactly the same way as a normal DP. Therefore, no additional description is required for a base DP. The FIC data is generated and consumed in the Management Layer. The content of FIC data is as described in the Management Layer specification.

The FIC data is optional and the use of FIC is signaled by the FIC_FLAG parameter in the static part of the PLS2. If FIC is used, FIC_FLAG is set to ‘1’ and the signaling field for FIC is defined in the static part of PLS2. Signaled in this field are FIC_VERSION, and FIC_LENGTH_BYTE. FIC uses the same modulation, coding and time interleaving parameters as PLS2. FIC shares the same signaling parameters such as PLS2 MOD and PLS2 FEC. FIC data, if any, is mapped immediately after PLS2 or EAC if any. FIC is not preceded by any normal DPs, auxiliary streams or dummy cells. The method of mapping FIC cells is exactly the same as that of EAC which is again the same as PLS.

Without EAC after PLS, FIC cells are mapped from the next cell of the PLS2 in an increasing order of the cell index as shown in an example in (a). Depending on the FIC data size, FIC cells may be mapped over a few symbols, as shown in (b).

FIC cells follow immediately after the last cell of the PLS2, and mapping continues downward until the last cell index of the last FSS. If the total number of required FIC cells exceeds the number of remaining active carriers of the last FSS, mapping proceeds to the next symbol and continues in exactly the same manner as FSS(s). The next symbol for mapping in this case is the normal data symbol which has more active carriers than a FSS.

If EAS messages are transmitted in the current frame, EAC precedes FIC, and FIC cells are mapped from the next cell of the EAC in an increasing order of the cell index as shown in (b).

After FIC mapping is completed, one or more DPs are mapped, followed by auxiliary streams, if any, and dummy cells.

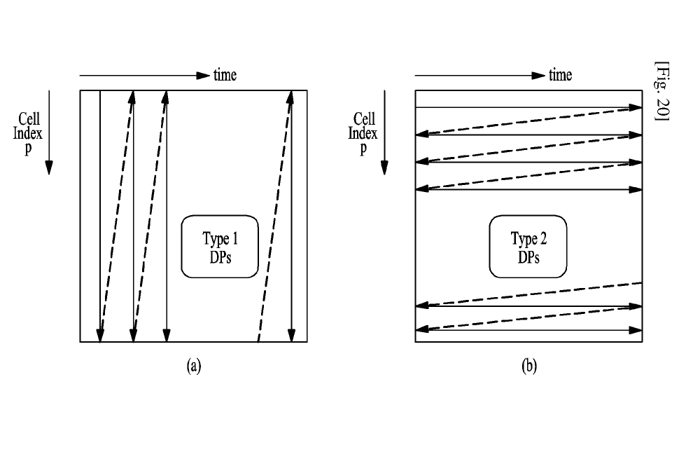

FIG. 20 illustrates a type of DP according to an embodiment of the present invention.

(a) shows type 1 DP and (b) shows type 2 DP.

After the preceding channels, i.e., PLS, EAC and FIC, are mapped, cells of the DPs are mapped. A DP is categorized into one of two types according to mapping method:

Type 1 DP: DP is mapped by TDM

Type 2 DP: DP is mapped by FDM

The type of DP is indicated by DP_TYPE field in the static part of PLS2. FIG. 20 illustrates the mapping orders of Type 1 DPs and Type 2 DPs. Type 1 DPs are first mapped in the increasing order of cell index, and then after reaching the last cell index, the symbol index is increased by one. Within the next symbol, the DP continues to be mapped in the increasing order of cell index starting from p=0. With a number of DPs mapped together in one frame, each of the Type 1 DPs are grouped in time, similar to TDM multiplexing of DPs.

Type 2 DPs are first mapped in the increasing order of symbol index, and then after reaching the last OFDM symbol of the frame, the cell index increases by one and the symbol index rolls back to the first available symbol and then increases from that symbol index. After mapping a number of DPs together in one frame, each of the Type 2 DPs are grouped in frequency together, similar to FDM multiplexing of DPs.

Type 1 DPs and Type 2 DPs can coexist in a frame if needed with one restriction; Type 1 DPs always precede Type 2 DPs. The total number of OFDM cells carrying Type 1 and Type 2 DPs cannot exceed the total number of OFDM cells available for transmission of DPs:

MathFigure 2

D_{DP1}+D_{DP2}≦D_{DP} [Math.2]

where DDP1 is the number of OFDM cells occupied by Type 1 DPs, DDP2 is the number of cells occupied by Type 2 DPs. Since PLS, EAC, FIC are all mapped in the same way as Type 1 DP, they all follow “Type 1 mapping rule”. Hence, overall, Type 1 mapping always precedes Type 2 mapping.

FIG. 21 illustrates DP mapping according to an embodiment of the present invention.

(a) shows an addressing of OFDM cells for mapping type 1 DPs and (b) shows an addressing of OFDM cells for mapping for type 2 DPs.

Addressing of OFDM cells for mapping Type 1 DPs (0, . . . , DDP11) is defined for the active data cells of Type 1 DPs. The addressing scheme defines the order in which the cells from the TIs for each of the Type 1 DPs are allocated to the active data cells. It is also used to signal the locations of the DPs in the dynamic part of the PLS2.

Without EAC and FIC, address 0 refers to the cell immediately following the last cell carrying PLS in the last FSS. If EAC is transmitted and FIC is not in the corresponding frame, address 0 refers to the cell immediately following the last cell carrying EAC. If FIC is transmitted in the corresponding frame, address 0 refers to the cell immediately following the last cell carrying FIC. Address 0 for Type 1 DPs can be calculated considering two different cases as shown in (a). In the example in (a), PLS, EAC and FIC are assumed to be all transmitted. Extension to the cases where either or both of EAC and FIC are omitted is straightforward. If there are remaining cells in the FSS after mapping all the cells up to FIC as shown on the left side of (a).

Addressing of OFDM cells for mapping Type 2 DPs (0, . . . , DDP21) is defined for the active data cells of Type 2 DPs. The addressing scheme defines the order in which the cells from the TIs for each of the Type 2 DPs are allocated to the active data cells. It is also used to signal the locations of the DPs in the dynamic part of the PLS2.

Three slightly different cases are possible as shown in (b). For the first case shown on the left side of (b), cells in the last FSS are available for Type 2 DP mapping. For the second case shown in the middle, FIC occupies cells of a normal symbol, but the number of FIC cells on that symbol is not larger than C_{FSS}. The third case, shown on the right side in (b), is the same as the second case except that the number of FIC cells mapped on that symbol exceeds C_{FSS}.

The extension to the case where Type 1 DP(s) precede Type 2 DP(s) is straightforward since PLS, EAC and FIC follow the same “Type 1 mapping rule” as the Type 1 DP(s).

A data pipe unit (DPU) is a basic unit for allocating data cells to a DP in a frame.

A DPU is defined as a signaling unit for locating DPs in a frame. A Cell Mapper 7010 may map the cells produced by the TIs for each of the DPs. A Time interleaver 5050 outputs a series of TI-blocks and each TI-block comprises a variable number of XFECBLOCKs which is in turn composed of a set of cells. The number of cells in an XFECBLOCK, N_{cells}, is dependent on the FECBLOCK size, N_{ldpc}, and the number of transmitted bits per constellation symbol. A DPU is defined as the greatest common divisor of all possible values of the number of cells in a XFECBLOCK, N_{cells}, supported in a given PHY profile. The length of a DPU in cells is defined as L_{DPU}. Since each PHY profile supports different combinations of FECBLOCK size and a different number of bits per constellation symbol, L_{DPU} is defined on a PHY profile basis.

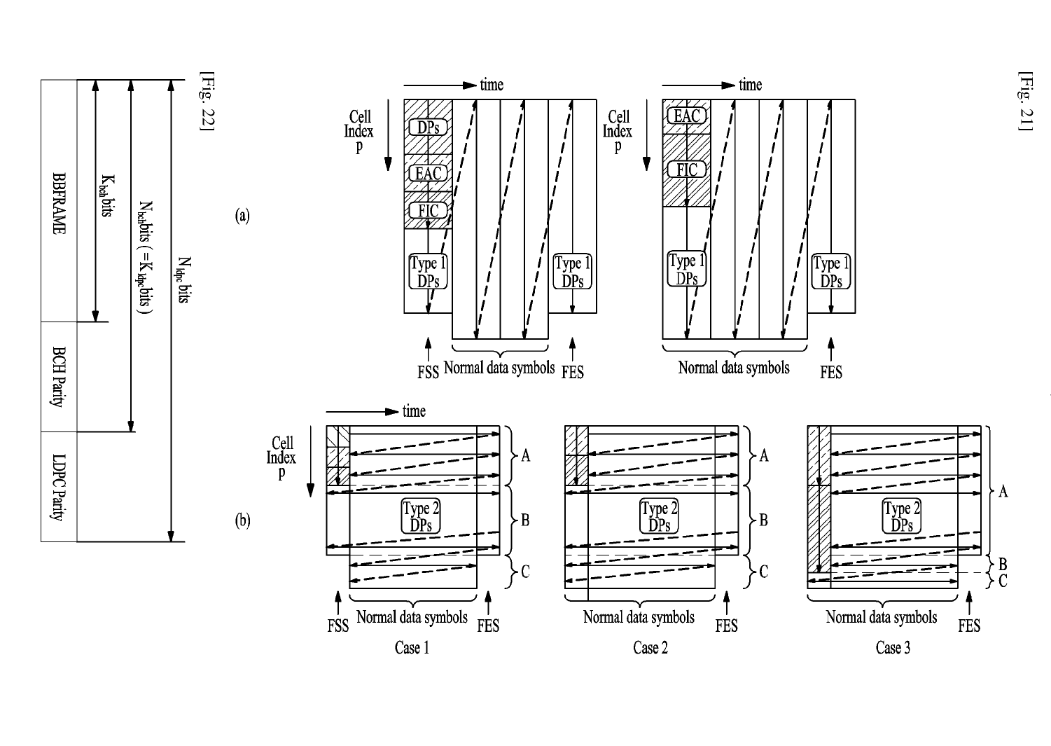

FIG. 22 illustrates an FEC structure according to an embodiment of the present invention.

FIG. 22 illustrates an FEC structure according to an embodiment of the present invention before bit interleaving. As above mentioned, Data FEC encoder may perform the FEC encoding on the input BBF to generate FECBLOCK procedure using outer coding (BCH), and inner coding (LDPC). The illustrated FEC structure corresponds to the FECBLOCK. Also, the FECBLOCK and the FEC structure have same value corresponding to a length of LDPC codeword.

The BCH encoding is applied to each BBF (K_{bch} bits), and then LDPC encoding is applied to BCH-encoded BBF (K_{ldpc} bits=N_{bch} bits) as illustrated in FIG. 22.

The value of N_{ldpc} is either 64800 bits (long FECBLOCK) or 16200 bits (short FECBLOCK).

The below table 28 and table 29 show FEC encoding parameters for a long FECBLOCK and a short FECBLOCK, respectively.

TABLE 28

| | | | | BCH error | |
|---|---|---|---|---|---|
| LDPC | | | | correction | N_{bch} − |
| Rate | N_{ldpc} | K_{ldpc} | K_{bch} | capability | K_{bch} |
| 5/15 | 64800 | 21600 | 21408 | 12 | 192 |
| 6/15 | | 25920 | 25728 | | |
| 7/15 | | 30240 | 30048 | | |
| 8/15 | | 34560 | 34368 | | |
| 9/15 | | 38880 | 38688 | | |
| 10/15 | | 43200 | 43008 | | |
| 11/15 | | 47520 | 47328 | | |
| 12/15 | | 51840 | 51648 | | |
| 13/15 | | 56160 | 55968 | | |

TABLE 29

| | | | | BCH error | |
|---|---|---|---|---|---|
| LDPC | | | | correction | N_{bch} − |
| Rate | N_{ldpc} | K_{ldpc} | K_{bch} | capability | K_{bch} |
| 5/15 | 16200 | 5400 | 5232 | 12 | 168 |
| 6/15 | | 6480 | 6312 | | |
| 7/15 | | 7560 | 7392 | | |
| 8/15 | | 8640 | 8472 | | |
| 9/15 | | 9720 | 9552 | | |
| 10/15 | | 10800 | 10632 | | |
| 11/15 | | 11880 | 11712 | | |
| 12/15 | | 12960 | 12792 | | |
| 13/15 | | 14040 | 13872 | | |

The details of operations of the BCH encoding and LDPC encoding are as follows:

A 12-error correcting BCH code is used for outer encoding of the BBF. The BCH generator polynomial for short FECBLOCK and long FECBLOCK are obtained by multiplying together all polynomials.

LDPC code is used to encode the output of the outer BCH encoding. To generate a completed B_{ldpc} (FECBLOCK), P_{ldpc} (parity bits) is encoded systematically from each I_{ldpc} (BCH-encoded BBF), and appended to I_{ldpc}. The completed B_{ldpc} (FECBLOCK) are expressed as follow Math figure.

MathFigure 3

B_{ldpc}=[I_{ldpc}P_{ldpc}]=[i₀,i₁, . . . ,i_{K}_{_{ldpc}}₋₁,p₀,p₁, . . . ,p_{N}_{_{ldpc}}_{-K}_{_{ldpc}}₋₁] [Math.3]

The parameters for long FECBLOCK and short FECBLOCK are given in the above table 28 and 29, respectively.

The detailed procedure to calculate N_{ldpc}−K_{ldpc} parity bits for long FECBLOCK, is as follows:

1) Initialize the parity bits,

MathFigure 4

p₀=p₁=p₂= . . . =p_{N}_{_{ldpc}}_{-K}_{_{ldpc}}₋₁=0 [Math.4]

2) Accumulate the first information bit—i₀, at parity bit addresses specified in the first row of an addresses of parity check matrix. The details of addresses of parity check matrix will be described later. For example, for rate 13/15:

MathFigure 5

p₉₈₃=p₉₈₃⊕i₀ p₂₈₁₅=p₂₈₁₅⊕i₀

p₄₈₃₇=p₄₈₃₇⊕i₀ p₄₉₈₉=p₄₉₈₉⊕i₀

p₆₁₃₈=p₆₁₃₈⊕i₀ p₆₄₅₈=p₆₄₅₈⊕i₀

p₆₉₂₁=p₆₉₂₁⊕i₀ p₆₉₇₄=p₆₉₇₄⊕i₀

p₇₅₇₂=p₇₅₇₂⊕i₀ p₈₂₆₀=p₈₂₆₀⊕i₀

p₈₄₉₆=p₈₄₉₆⊕i₀ [Math.5]

3) For the next 359 information bits, iₛ, s=1, 2, . . . , 359 accumulate iₛ at parity bit addresses using following Math figure.

MathFigure 6

{x+(s mod 360)×Q_{ldpc}} mod(N_{ldpc}−K_{ldpc}) [Math.6]

where x denotes the address of the parity bit accumulator corresponding to the first bit i₀, and Q_{ldpc} is a code rate dependent constant specified in the addresses of parity check matrix. Continuing with the example, Q_{ldpc}=24 for rate 13/15, so for information bit i₁, the following operations are performed:

MathFigure 7

p₁₀₀₇=p₁₀₀₇⊕i₁ p₂₈₃₉=p₂₈₃₉⊕i₁

p₄₈₆₁=p₄₈₆₁⊕i₁ p₅₀₁₃=p₅₀₁₃⊕i₁

p₆₁₆₂=p₆₁₆₂⊕i₁ p₆₄₈₂=p₆₄₈₂⊕i₁

p₆₉₄₅=p₆₉₄₅⊕i₁ p₆₉₉₈=p₆₉₉₈⊕i₁

p₇₅₉₆=p₇₅₉₆⊕i₁ p₈₂₈₄=p₈₂₈₄⊕i₁

p₈₅₂₀=p₈₅₂₀⊕i₁ [Math.7]

4) For the 361st information bit i₃₆₀, the addresses of the parity bit accumulators are given in the second row of the addresses of parity check matrix. In a similar manner the addresses of the parity bit accumulators for the following 359 information bits iₛ, s=361, 362, . . . , 719 are obtained using the Math figure. 6, where x denotes the address of the parity bit accumulator corresponding to the information bit i₃₆₀, i.e., the entries in the second row of the addresses of parity check matrix.

In a similar manner, for every group of 360 new information bits, a new row from addresses of parity check matrixes used to find the addresses of the parity bit accumulators.

After all of the information bits are exhausted, the final parity bits are obtained as follows:

6) Sequentially perform the following operations starting with i=1

MathFigure 8

pᵢ=pᵢ⊕pᵢ₋₁,i=1,2, . . . ,N_{ldpc}−K_{ldpc}−1 [Math.8]

where final content of pᵢ, i=0, 1, . . . N_{ldpc}−K_{ldpc}−1 is equal to the parity bit pᵢ.

TABLE 30

| Code Rate | Q_{ldpc} |
|---|---|
| 5/15 | 120 |
| 6/15 | 108 |
| 7/15 | 96 |
| 8/15 | 84 |
| 9/15 | 72 |
| 10/15 | 60 |
| 11/15 | 48 |
| 12/15 | 36 |
| 13/15 | 24 |

This LDPC encoding procedure for a short FECBLOCK is in accordance with t LDPC encoding procedure for the long FECBLOCK, except replacing the table 30 with table 31, and replacing the addresses of parity check matrix for the long FECBLOCK with the addresses of parity check matrix for the short FECBLOCK.

TABLE 31

| Code Rate | Q_{ldpc} |
|---|---|
| 5/15 | 30 |
| 6/15 | 27 |
| 7/15 | 24 |
| 8/15 | 21 |
| 9/15 | 18 |
| 10/15 | 15 |
| 11/15 | 12 |
| 12/15 | 9 |
| 13/15 | 6 |

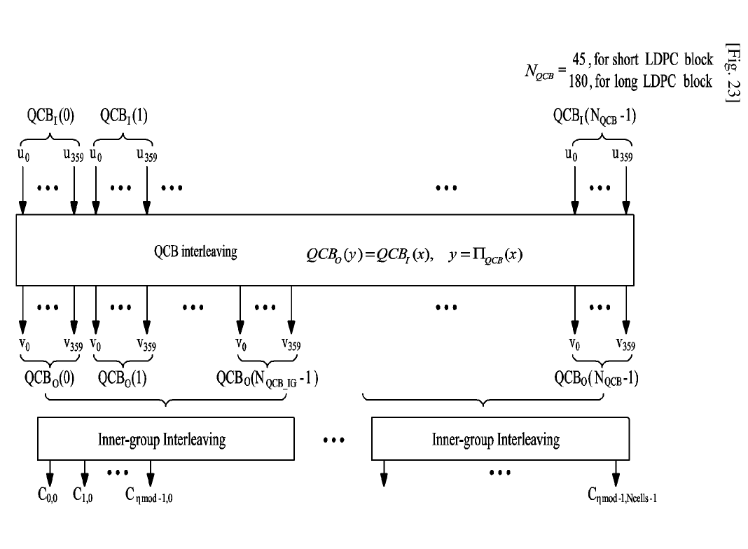

FIG. 23 illustrates a bit interleaving according to an embodiment of the present invention.

The outputs of the LDPC encoder are bit-interleaved, which consists of parity interleaving followed by Quasi-Cyclic Block (QCB) interleaving and inner-group interleaving.

(a) shows Quasi-Cyclic Block (QCB) interleaving and (b) shows inner-group interleaving.

The FECBLOCK may be parity interleaved. At the output of the parity interleaving, the LDPC codeword consists of 180 adjacent QC blocks in a long FECBLOCK and 45 adjacent QC blocks in a short FECBLOCK. Each QC block in either a long or short FECBLOCK consists of 360 bits. The parity interleaved LDPC codeword is interleaved by QCB interleaving. The unit of QCB interleaving is a QC block. The QC blocks at the output of parity interleaving are permutated by QCB interleaving as illustrated in FIG. 23, where N_{cells}=64800/η_{mod} or 16200/η_{mod} according to the FECBLOCK length. The QCB interleaving pattern is unique to each combination of modulation type and LDPC code rate.

After QCB interleaving, inner-group interleaving is performed according to modulation type and order (η_{mod}) which is defined in the below table 32. The number of QC blocks for one inner-group, N_{QCB}_{_}_{IG}, is also defined.

TABLE 32

| Modulation type | η_{mod} | N_{QCB}_{_{—}}_{IG} |
|---|---|---|
| QAM-16 | 4 | 2 |
| NUC-16 | 4 | 4 |
| NUQ-64 | 6 | 3 |
| NUC-64 | 6 | 6 |
| NUQ-256 | 8 | 4 |
| NUC-256 | 8 | 8 |
| NUQ-1024 | 10 | 5 |
| NUC-1024 | 10 | 10 |

The inner-group interleaving process is performed with N_{QCB}_{_}_{IG} QC blocks of the QCB interleaving output Inner-group interleaving has a process of writing and reading the bits of the inner-group using 360 columns and N_{QCB}_{_}_{IG} rows. In the write operation, the bits from the QCB interleaving output are written row-wise. The read operation is performed column-wise to read out m bits from each row, where m is equal to 1 for NUC and 2 for NUQ.

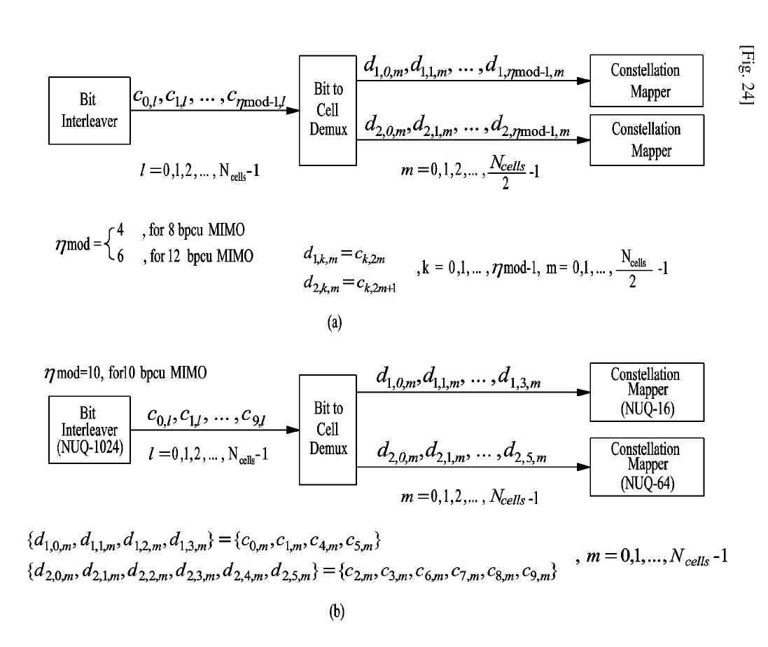

FIG. 24 illustrates a cell-word demultiplexing according to an embodiment of the present invention.

(a) shows a cell-word demultiplexing for 8 and 12 bpcu MIMO and (b) shows a cell-word demultiplexing for 10 bpcu MIMO.

Each cell word (c_{0,l}, c_{1,l}, . . . , c_{nmod-1,l}) of the bit interleaving output is demultiplexed into (d_{1,0,m}, d_{1,1,m} . . . , d_{1,nmod-1,m}) and (d_{2,0,m}, d_{2,1,m} . . . , d_{2,nmod-1,m}) as shown in (a), which describes the cell-word demultiplexing process for one XFECBLOCK.

For the 10 bpcu MIMO case using different types of NUQ for MIMO encoding, the Bit Interleaver for NUQ-1024 is re-used. Each cell word (c_{0,l}, c_{1,l}, . . . , c_{9,l}) of the Bit Interleaver output is demultiplexed into (d_{1,0,m}, d_{1,1,m} . . . , d_{1,3,m}) and (d_{2,0,m}, d_{2,1,m} . . . , d_{2,5,m}), as shown in (b).

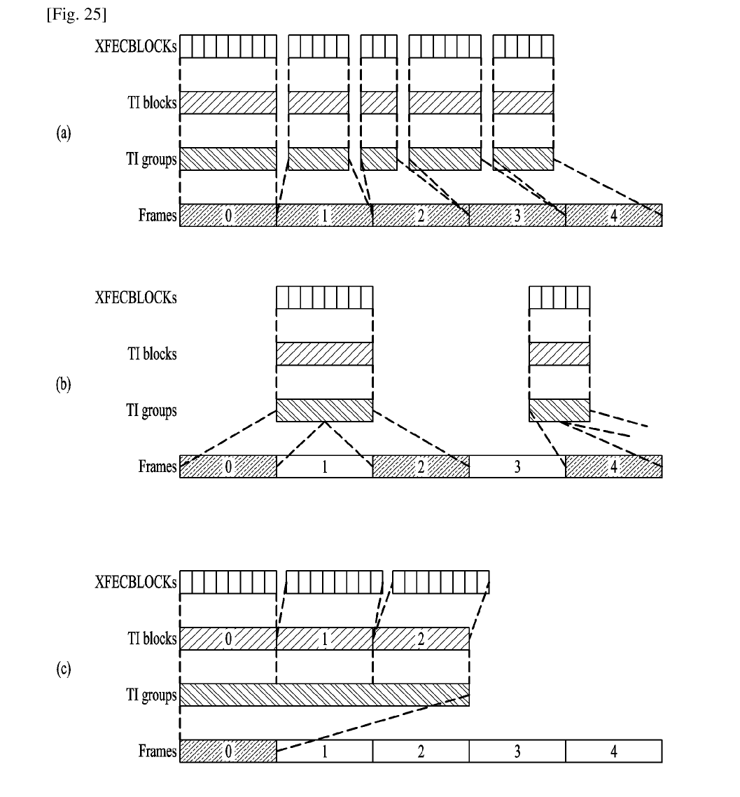

FIG. 25 illustrates a time interleaving according to an embodiment of the present invention.

(a) to (c) show examples of TI mode.

The time interleaver operates at the DP level. The parameters of time interleaving (TI) may be set differently for each DP.

The following parameters, which appear in part of the PLS2-STAT data, configure the TI:

DP_TI_TYPE (allowed values: 0 or 1): Represents the TI mode; ‘0’ indicates the mode with multiple TI blocks (more than one TI block) per TI group. In this case, one TI group is directly mapped to one frame (no inter-frame interleaving). ‘1’ indicates the mode with only one TI block per TI group. In this case, the TI block may be spread over more than one frame (inter-frame interleaving).

DP_TI_LENGTH: If DP_TI_TYPE=‘0’, this parameter is the number of TI blocks N_{TI} per TI group. For DP_TI_TYPE=‘1’, this parameter is the number of frames P_{I} spread from one TI group.

DP_NUM_BLOCK_MAX (allowed values: 0 to 1023): Represents the maximum number of XFECBLOCKs per TI group.

DP_FRAME_INTERVAL (allowed values: 1, 2, 4, 8): Represents the number of the frames I_{JUMP} between two successive frames carrying the same DP of a given PHY profile.

DP_TI_BYPASS (allowed values: 0 or 1): If time interleaving is not used for a DP, this parameter is set to ‘1’. It is set to ‘0’ if time interleaving is used.

Additionally, the parameter DP_NUM_BLOCK from the PLS2-DYN data is used to represent the number of XFECBLOCKs carried by one TI group of the DP.

When time interleaving is not used for a DP, the following TI group, time interleaving operation, and TI mode are not considered. However, the Delay Compensation block for the dynamic configuration information from the scheduler will still be required. In each DP, the XFECBLOCKs received from the SSD/MIMO encoding are grouped into TI groups. That is, each TI group is a set of an integer number of XFECBLOCKs and will contain a dynamically variable number of XFECBLOCKs. The number of XFECBLOCKs in the TI group of index n is denoted by N_{xBLOCK}_{_}_{Group}(n) and is signaled as DP_NUM_BLOCK in the PLS2-DYN data. Note that N_{xBLOCK}_{_}_{Group}(n) may vary from the minimum value of 0 to the maximum value N_{xBLOCK}_{_}_{Group}_{_}_{MAX} (corresponding to DP_NUM_BLOCK_MAX) of which the largest value is 1023.

Each TI group is either mapped directly onto one frame or spread over P_{I} frames. Each TI group is also divided into more than one TI blocks (N_{TI}), where each TI block corresponds to one usage of time interleaver memory. The TI blocks within the TI group may contain slightly different numbers of XFECBLOCKs. If the TI group is divided into multiple TI blocks, it is directly mapped to only one frame. There are three options for time interleaving (except the extra option of skipping the time interleaving) as shown in the below table 33.

TABLE 33

| Modes | Descriptions |
|---|---|
| Option-1 | Each TI group contains one TI block and is mapped |
| | directly to one frame as shown in (a). This option |
| | is signaled in the PLS2-STAT by DP_TI_TYPE = |
| | ‘0’ and DP_TI_LENGTH = ‘1’ (NTI = 1). |
| Option-2 | Each TI group contains one TI block and is mapped |
| | to more than one frame. (b) shows an example, where |
| | one TI group is mapped to two frames, i.e., |
| | DP_TI_LENGTH = ‘2’ (PI = 2) and |
| | DP_FRAME_INTERVAL (IJUMP = 2). |
| | This provides greater time diversity for low |
| | data-rate services. This option is signaled in |
| | the PLS2-STAT by DP_TI_TYPE = ‘1’. |
| Option-3 | Each TI group is divided into multiple TI blocks |
| | and is mapped directly to one frame as shown in (c). |
| | Each TI block may use full TI memory, so as to |
| | provide the maximum bit-rate for a DP. This option |
| | is signaled in the PLS2-STAT signaling by |
| | DP_TI_TYPE = ‘0’ and DP_TI_LENGTH = NTI, |
| | while PI = 1. |

In each DP, the TI memory stores the input XFECBLOCKs (output XFECBLOCKs from the SSD/MIMO encoding block). Assume that input XFECBLOCKs are defined as

d_{n,s,0,0},d_{s,s,0,1}, . . . ,d_{n,s,0,N cells-1},d_{n,s,1,N cells-1}, . . . d_{n,s,N xBLOCK}_{_}_{TI(n,s)-1,0}, . . . ,d_{n,s,N xBLOCK}_{_}_{TI(n,x)-1,Ncells-1}),

where d_{n,s,r,q} is the qth cell of the rth XFECBLOCK in the sth TI block of the nth TI group and represents the outputs of SSD and MIMO encodings as follows.

$${d}_{n , s , r , q} = \{ \begin{matrix}{f}_{n , s , r , q} , theoutputofSSD … encoding \\ {g}_{n , s , r , q} , theoutputofMIMOencoding\end{matrix}$$

In addition, assume that output XFECBLOCKs from the time interleaver are defined as

h_{n,s,0},h_{n,s,1}, . . . ,h_{n,s,i}, . . . ,h_{n,s,N xBLOCK}_{_}_{TI(n,s)×N cells-1}),

where h_{n,s,i} is the ith output cell (for i=0, . . . , N_{xBLOCK}_{_}_{TI}(n,s)×N_{cells}−1) in the sth TI block of the nth TI group.

Typically, the time interleaver will also act as a buffer for DP data prior to the process of frame building. This is achieved by means of two memory banks for each DP. The first TI-block is written to the first bank. The second TI-block is written to the second bank while the first bank is being read from and so on.

The TI is a twisted row-column block interleaver. For the sth TI block of the nth TI group, the number of rows Nᵣ of a TI memory is equal to the number of cells N_{cells}, i.e., Nᵣ=N_{cells} while the number of columns N_{c} is equal to the number N_{xBLOCK}_{_}_{TI}(n,s).

FIG. 26 illustrates the basic operation of a twisted row-column block interleaver according to an embodiment of the present invention.

shows a writing operation in the time interleaver and (b) shows a reading operation in the time interleaver The first XFECBLOCK is written column-wise into the first column of the TI memory, and the second XFECBLOCK is written into the next column, and so on as shown in (a). Then, in the interleaving array, cells are read out diagonal-wise. During diagonal-wise reading from the first row (rightwards along the row beginning with the left-most column) to the last row, Nᵣ cells are read out as shown in (b). In detail, assuming z_{n,s,i} (i=0, . . . , NᵣN_{c}) as the TI memory cell position to be read sequentially, the reading process in such an interleaving array is performed by calculating the row index R_{n,s,i}, the column index C_{n,s,i}, and the associated twisting parameter T_{n,s,i} as follows expression.

$$\begin{matrix}MathFigure 9 & \\ GENERATE ( {R}_{n , s , i} , {C}_{n , s , i} ) = \\ \{ \\ {R}_{n , s , i} = mod ( i , {N}_{r} ) , \\ {T}_{n , s , i} = mod ( {S}_{shift} \times {S}_{n , s , i} , {S}_{c} ) \\ {C}_{n , s , i} = mod ( {T}_{n , s , i} + ⌊ \frac{i}{{N}_{r}} ⌋ , {N}_{c} ) \\ \} & [ Math . 9 ]\end{matrix}$$

where

S_{shift}

is a common shift value for the diagonal-wise reading process regardless of

N_{xBLOCK}_{_}_{TI}(n,s),

and it is determined by

N_{xBLOCK}_{_}_{TI}_{_}_{MAX}

given in the PLS2-STAT as follows expression.

$$\begin{matrix} MathFigure 10 & \\ for \{ \begin{matrix}\begin{matrix}{N}_{xBLOCK\_TI \_MAX}^{′} = \\ {N}_{xBLOCK\_TI \_MAX} + 1\end{matrix} , & if {N}_{xBLOCK\_TI \_MAX} mod 2 = 0 \\ \begin{matrix}{N}_{xBLOCK\_TI \_MAX}^{′} = \\ {N}_{xBLOCK\_TI \_MAX}\end{matrix} , & if {N}_{xBLOCK\_TI \_MAX} mod 2 = 1\end{matrix} , \\ {S}_{shift} = \frac{{N}_{xBLOCK\_TI \_MAX}^{′} - 1}{2} & [ Math . 10 ]\end{matrix}$$

As a result, the cell positions to be read are calculated by a coordinate as

z_{n,s,i}=NᵣC_{n,s,i}+R_{n,s,i}.

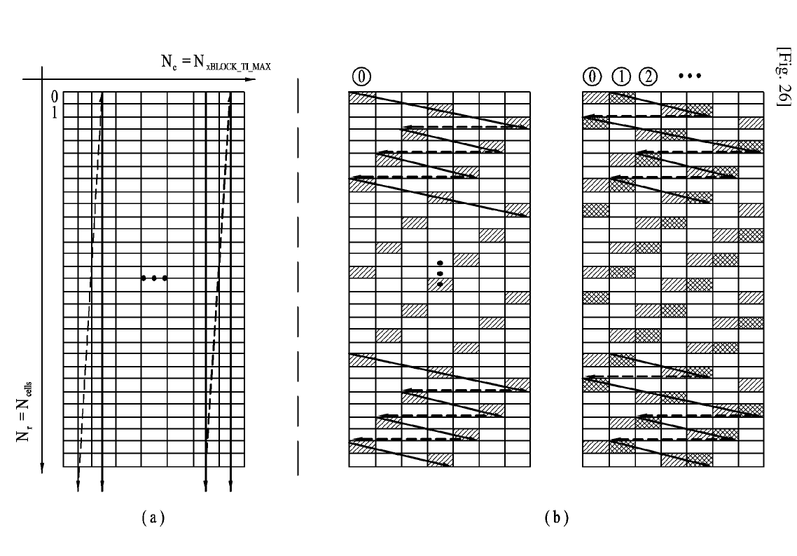

FIG. 27 illustrates an operation of a twisted row-column block interleaver according to another embodiment of the present invention.

More specifically, FIG. 27 illustrates the interleaving array in the TI memory for each TI group, including virtual XFECBLOCKs when

N_{xBLOCK}_{_{—TI}}(0,0)=3,

N_{xBLOCK}_{_}_{TI}(1,0)=6,

N_{xBLOCK}_{_}_{TI}(2,0)=5.

The variable number

N_{xBLOCK}_{_}_{TI}(n,s)=Nᵣ

will be less than or equal to

N′_{xBLOCK}_{_}_{TI}_{_}_{MAX}.

Thus, in order to achieve a single-memory deinterleaving at the receiver side, regardless of

N_{xBLOCK}_{_}_{TI}(n,s),

the interleaving array for use in a twisted row-column block interleaver is set to the size of

Nᵣ×N_{c}=N_{cells}×N′_{xBLOCK}_{_}_{TI}_{_}_{MAX}

by inserting the virtual XFECBLOCKs into the TI memory and the reading process is accomplished as follow expression.

Math FIG. 11
[Math.11]

```
p=0;
for i=0; i<N_{cells} N′_{xBLOCK}_{_{—}}_{TI}_{_{—}}_{MAX} ; i=i+1
{GENERATE (R_{n,s,i} , C_{n,s,i} ) ;
Vᵢ =Nᵣ C_{n,s,j} +R_{n,s,i}
    if Vᵢ<N_{cells} N_{xBLOCK}_{_{—}}_{TI}(n, s)
    {
    Z_{n,s,p} = Vᵢ ;p=p+1;
    }
}
```

The number of TI groups is set to 3. The option of time interleaver is signaled in the PLS2-STAT data by DP_TI_TYPE=‘0’, DP_FRAME_INTERVAL=‘1’, and DP_TI_LENGTH=‘1’, i.e., N_{TI}=1, I_{JUMP}=1, and P_{I}=1. The number of XFECBLOCKs, each of which has N_{cells}=30 cells, per TI group is signaled in the PLS2-DYN data by N_{xBLOCK}_{_}_{TI}(0,0)=3, N_{xBLOCK}_{_}_{TI}(1,0)=6, and N_{xBLOCK}_{_}_{TI}(2,0)=5, respectively. The maximum number of XFECBLOCK is signaled in the PLS2-STAT data by N_{xBLOCK}_{_}_{Group}_{_}_{MAX}, which leads to

└N_{xBLOCK}_{_}_{Group}_{_}_{MAX}/N_{TI}┘=N_{xBLOCK}_{_}_{TI}_{_}_{MAX}=6.

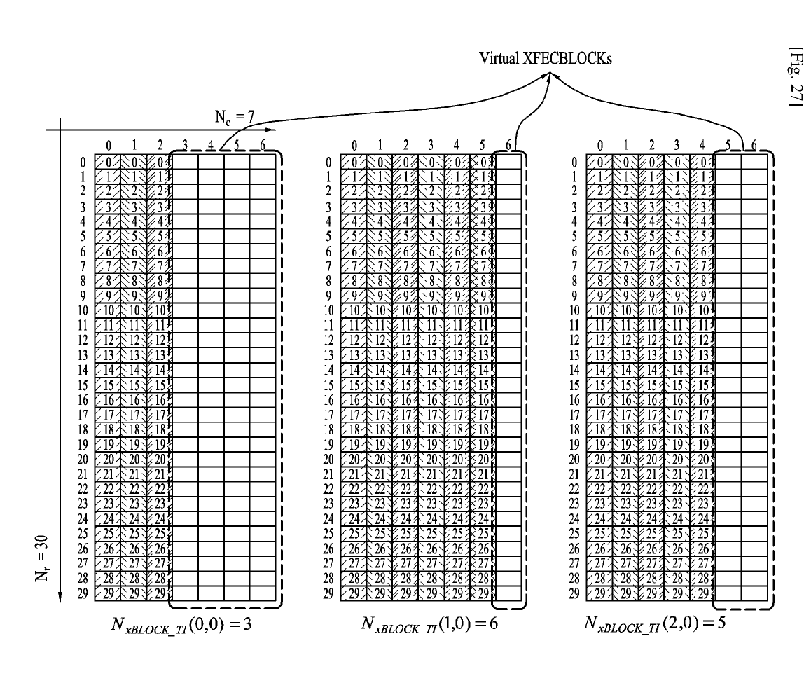

FIG. 28 illustrates a diagonal-wise reading pattern of a twisted row-column block interleaver according to an embodiment of the present invention.

More specifically FIG. 28 shows a diagonal-wise reading pattern from each interleaving array with parameters of

N′_{xBLOCK}_{_}_{TI}_{_}_{MAX}=7

and S_{shift}=(7−1)/2=3. Note that in the reading process shown as pseudocode above, if

Vᵢ≧N_{cells}N_{xBLOCK}_{_}_{TI}(n,s),

the value of Vᵢ is skipped and the next calculated value of Vᵢ is used.

FIG. 29 illustrates interleaved XFECBLOCKs from each interleaving array according to an embodiment of the present invention.

FIG. 29 illustrates the interleaved XFECBLOCKs from each interleaving array with parameters of

N′_{xBLOCK}_{_}_{TI}_{_}_{MAX}=7

and S_{shift}=3.

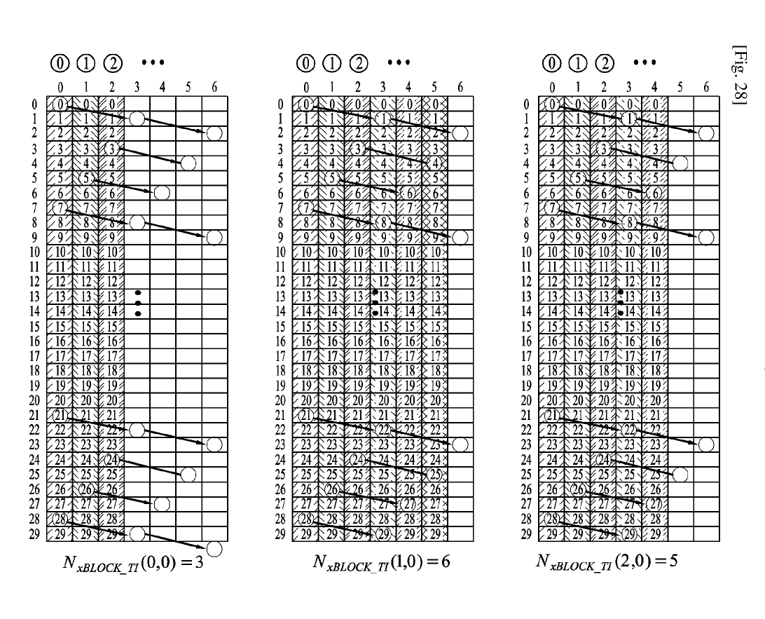

FIG. 30 is a view illustrating a configuration of a broadcast reception device according to another embodiment of the present invention.

In an embodiment of FIG. 30, the broadcast reception device 100 of FIG. 30 includes a broadcast reception unit 110, an internet protocol (IP) communication unit 130, and a control unit 150.

The broadcast reception unit 110 may include one or more processors, one or more circuits, and one or more hardware modules, which perform each of a plurality of functions that the broadcast reception unit 110 performs. In more detail, the broadcast reception unit 110 may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one. The broadcast reception unit 110 may include a physical layer module 119 and a physical layer IP frame module 117. The physical layer module 119 receives and processes a broadcast related signal through a broadcast channel of a broadcast network. The physical layer IP frame module 117 converts a data packet such as an IP datagram obtained from the physical layer module 119 into a specific frame. For example, the physical layer module 119 may convert an IP datagram into an RS Frame or GSE.

The IP communication unit 130 may include one or more processors, one or more circuits, and one or more hardware modules, which perform each of a plurality of functions that the IP communication unit 130 performs. In more detail, the IP communication unit 130 may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one. The IP communication unit 130 may include an internet access control module 131. The internet access control module 131 may control an operation of the broadcast reception device 100 to obtain at least one of service, content, and signaling data through an internet communication network (for example, broad band).

The control unit 150 may include one or more processors, one or more circuits, and one or more hardware modules, which perform each of a plurality of functions that the control unit 150 performs. In more detail, the control unit 150 may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one. The control unit 150 may include at least one of a signaling decoder 151, a service map database 161, a service signaling channel parser 163, an application signaling parser 166, an alert signaling parser 168, a targeting signaling parser 170, a targeting processor 173, an A/V processor 161, an alerting processor 162, an application processor 169, a scheduled streaming decoder 181, a file decoder 182, a user request streaming decoder 183, a file database 184, a component synchronization unit 185, a service/content acquisition control unit 187, a redistribution module 189, a device manager 193, and a data sharing unit 191.

The service/content acquisition control unit 187 controls operations of a receiver to obtain services or contents through a broadcast network or an internet communication network and signaling data relating to services or contents.

The signaling decoder 151 decodes signaling information.

The service signaling parser 163 parses service signaling information.

The application signaling parser 166 extracts and parses service related signaling information. At this point, the service related signaling information may be service scan related signaling information. Additionally, the service related signaling information may be signaling information relating to contents provided through a service.

The alert signaling parser 168 extracts and parses alerting related signaling information.

The target signaling parser 170 extracts and parses information for personalizing services or contents or information for signaling targeting information.

The targeting processor 173 processes information for personalizing services or contents.

The alerting processor 162 processes alerting related signaling information.

The application processor 169 controls application related information and the execution of an application. In more detail, the application processor 169 processes a state of a downloaded application and a display parameter.

The A/V processor 161 processes an A/V rendering related operation on the basis of decoded audio or video and application data.

The scheduled streaming decoder 181 decodes a scheduled streaming that is a content streamed according to a schedule defined by a contents provider such as broadcaster.

The file decoder 182 decodes a downloaded file. Especially, the file decoder 182 decodes a file downloaded through an internet communication network.

The user request streaming decoder 183 decodes a content (for example, On Demand Content) provided by a user request.

The file database 184 stores files. In more detail, the file database 184 may store a file downloaded through an internet communication network.

The component synchronization unit 185 synchronizes contents or services. In more detail, the component synchronization unit 185 synchronizes a content decoded by at least one of the scheduled streaming decoder 181, the file decoder 182, and the user request streaming decoder 183.

The service/content acquisition control unit 187 controls operations of a receiver to obtain services, contents or signaling information relating to services or contents.

When services or contents are not received through a broadcast network, the redistribution module 189 performs operations to support obtaining at least one of services, contents, service related information, and content related information. In more detail, the redistribution module 189 may request at least one of services, contents, service related information, and content related information from the external management device 300. At this point, the external management device 300 may be a content server.

The device manager 193 manages an interoperable external device. In more detail, the device manager 193 may perform at least one of the addition, deletion, and update of an external device. Additionally, an external device may perform connection and data exchange with the broadcast reception device 100.

The data sharing unit 191 performs a data transmission operation between the broadcast reception device 100 and an external device and processes exchange related information. In more detail, the data sharing unit 191 may transmit AV data or signaling information to an external device. Additionally, the data sharing unit 191 may receive AV data or signaling information from an external device.

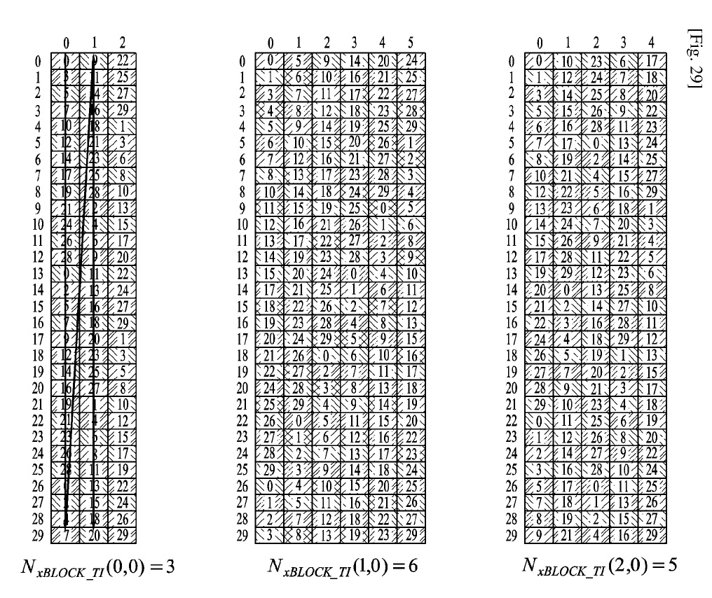

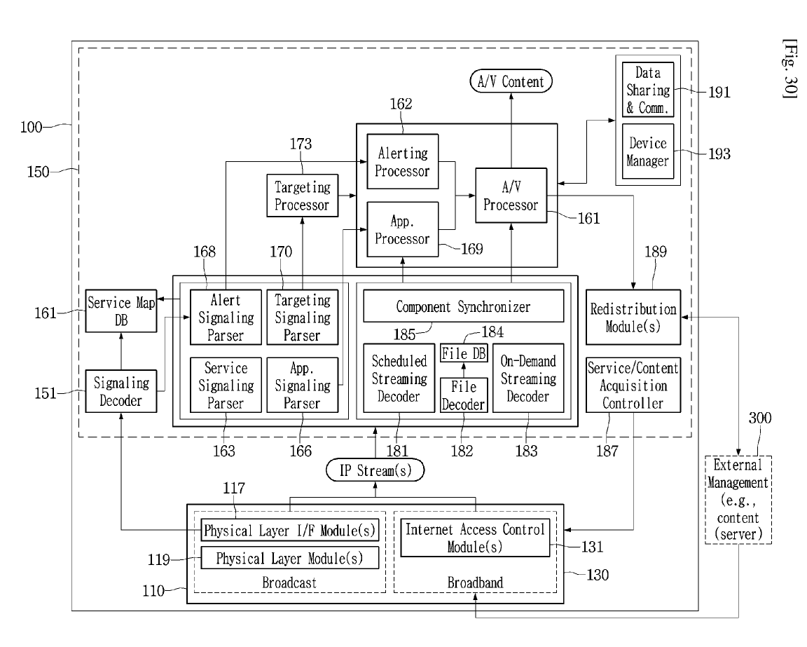

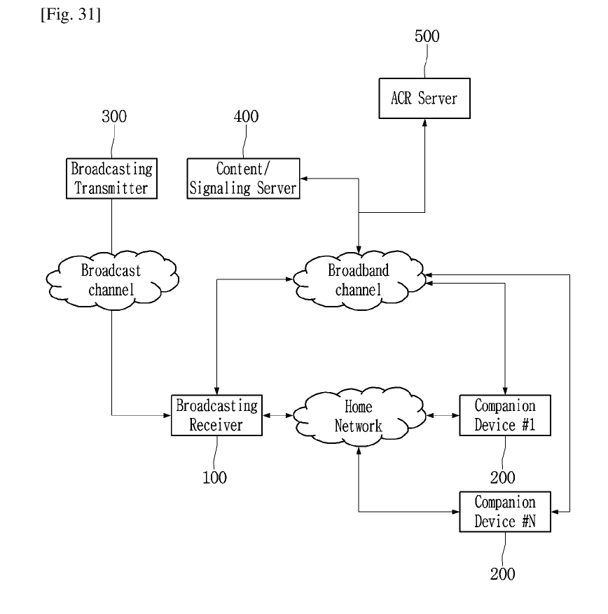

As the uses of terminal devices such as smartphones or tablets increase, broadcast services interoperating with such terminal devices increase also. Accordingly, terminal devices require the properties of broadcast services representing information on the broadcast services in order to interoperate with the broadcast services. However, in many cases, companion devices do not receive broadcast services directly. In such cases, an operating device needs to obtain the properties of broadcast services through broadcast transmission devices. Accordingly a broadcast reception device and an operating method thereof for efficiently transmitting the properties of broadcast services are required. This will be described with reference to FIGS. 31 to 43.

FIG. 31 is a view illustrating a broadcast system providing a broadcast service interoperating with a companion device according to an embodiment of the present invention.

The broadcast system includes a broadcast reception device 100, a companion device 200, a broadcast transmission device 300, and a content/signaling server 400, and an ACR server 500.

The broadcast transmission device 300 refers to a broadcast server transmitting broadcast services. At this point, the broadcast reception device 100 receives a broadcast service from the broadcast transmission device 300 through a broadcast channel. Additionally, the broadcast reception device 100 may receive information signaling a broadcast service from the broadcast transmission device 300 through a broadcast network. Additionally, the broadcast reception device 100 may receive additional information for broadcast service, for example, a trigger, a Trigger Parameter Table (TPT), a Trigger Declarative Object (TDO), from the broadcast transmission device 300 through a broadcast network.

The content/signaling server 400 generates and manages a content on broadcast service. At this point, the broadcast reception device 100 may receive at least one of additional information on broadcast service and signaling information of broadcast service from the content/signaling server 400 through a communication network (for example, broadcast channel).

The ACR server 300 manages ACR related data on broadcast service. At this point, the broadcast reception device 100 may receive at least one of a trigger and an application on broadcast service from the ACR server 300 through a communication network (for example, broadcast channel).

The companion device 200 executes a broadcast service related additional function as interoperating with the broadcast reception device 100 through a home network. In more detail, the companion device 200 may obtain at least one of applications and files relating to broadcast service. Additionally, the companion device 200 may execute applications and files relating to broadcast service. At this point, the companion device 200 may uses a mobile communication network such as 3GPP or an HTTP proxy server instead of a home network. Additionally, according to a specific embodiment, when broadcast service related applications or files are transmitted through File Delivery over Unidirectional Transport (FLUTE), the companion device 200 may receive at least one of the broadcast service related applications or files from the broadcast reception device 100. Additionally, the companion device 200 may be referred to as a second screen device. Additionally, the companion device 200 may include at least one of smartphones, tablets, and laptops. In more detail, the companion device 200 may be a terminal device having a communication function such as network instead of a broadcast reception function through a broadcast network. Additionally, the companion device 200 may be one or more. The companion device 200 may include a control unit controlling overall operations of the companion device 200 and a communication unit performing a communication with an external device. The control unit may include one or more processors, one or more circuits, and one or more hardware modules, which perform each of a plurality of functions that the control unit performs. In more detail, the control unit may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one. Additionally, a communication unit may include one or more processors, one or more circuits, and one or more hardware modules, which perform each of a plurality of functions that the communication unit performs. In more detail, the communication unit may be a System On Chip (SOC) in which several semiconductor parts are integrated into one. At this point, the SOC may be semiconductor in which various multimedia components such as graphics, audio, video, and modem and a semiconductor such as a processor and D-RAM are integrated into one.

Additionally, the broadcast reception device 100 may be referred to as a primary device.

Additionally, according to a specific embodiment, at least two of the broadcast transmission device 300, the content/signaling server 400, and the ACR server 500 are integrated into one server and used.

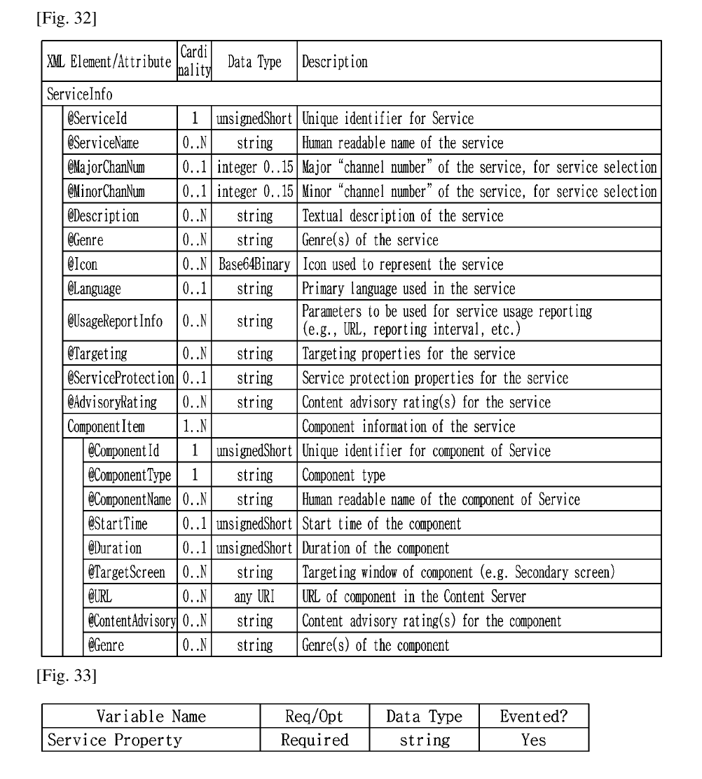

As described above, the broadcast reception device 100 may receive signaling information of broadcast service from the broadcast transmission device 300. Additionally, the broadcast reception device 100 may receive signaling information of broadcast service from the content/signaling server 400. At this point, the signaling information of broadcast service may include the properties of broadcast service. This will be described in more detail with reference to FIG. 32.

FIG. 32 is a view illustrating the properties of signaled broadcast service according to an embodiment of the present invention.

The signaling information of broadcast service that the broadcast reception device 100 receives may include the properties of broadcast service. At this point, the properties of broadcast service may include at least one of a broadcast service identifier for identifying a broadcast service, the name of a broadcast service, the channel number of a broadcast service, a description of a broadcast service, the genre of a broadcast service, an icon representing a broadcast service, the primary language of a broadcast service, usage report information relating to a broadcast service, a targeting property representing information of a device providing a broadcast service, a property for broadcast service protection, a content advisory rating, and information on a media component in a broadcast service. The targeting property may represent at least one of a primary device or the companion device 200, as a device providing service. The channel number of a broadcast service may include a major channel number and a minor channel number. The information on a media component may include at least one of an identifier for identifying a media component, the type of a media component, the name of a media component, the start time of a media component, the duration of a media component, information representing a screen that a media components targets, URL for receiving a media component, the advisory rating of a media component, and the genre of a media component. At this point, the screen that a media component targets may represent the companion device 200.

The property of a broadcast service may be signaled in XML format as shown in FIG. 33. However, the signaling format for the property of a broadcast service is not limited thereto and the property of a broadcast service may be signaled in another format such as bit stream.

In more detail, the information signaling the property of a broadcast service may include as an element at least one of ServiceID, ServiceName, MajorChanNum, MinorChanNum, Description, Genre, Icon, Language, UsageReportingInfo, Targeting, ServiceProtection, AdvisoryRating, and ComponentItem.

ServiceID represents a broadcast service identifier for identifying service. At this point, there may be only one ServiceID. Additionally, according to a specific embodiment, ServiceID may have an unsigned short data type. In more detail, the broadcast reception device 100 and the companion device 200 may identify broadcast service on the basis of ServiceID.

ServiceName represents the name of a broadcast service. ServiceName may be provided in zero, or one or more. According to a specific embodiment, ServiceName may have a string data type. In more detail, the broadcast reception device 100 and the companion device 200 may display the name of a broadcast service on the basis of ServiceName.

MajorChanNum and MinorChanNum respectively represent the major number and minor number of the channel number of a broadcast service. According to a specific embodiment, MajorChanNum and MinorChanNum may be provided in zero or one. Additionally, MajorChanNum and MinorChanNum may have an integer value among 0 to 15. MajorChanNum and MinorChanNum may be used to easily select a user's broadcast service. In more detail, the broadcast reception device 100 and the companion device 200 may display the channel number of a broadcast service on the basis of MajorChanNum and MinorChanNum.

Description represents a description of a broadcast service. Description may be provided in zero, or one or more. Description may have a string data type. A user may guess the content of a broadcast through Description. In more detail, the broadcast reception device 100 and the companion device 200 may display a description of a broadcast service on the basis of Description.

Genre represents the genre of a broadcast service. Genre may be provided in zero, or one or more. According to a specific embodiment, Genre may have a string data type. A user may know the genre of a broadcast service through Genre. In more detail, the broadcast reception device 100 and the companion device 200 may display the genre of a broadcast service on the basis of Genre.

Icon represents a broadcast service. Icon may be provided in zero, or one or more. Icon may have a base 64 binary data type. A user may easily know the content of a broadcast service through an icon representing a broadcast service. In more detail, the broadcast reception device 100 and the companion device 200 may display an icon representing a broadcast service on the basis of Icon.

Language represents the main Language of a broadcast service. Language may be provided in zero or one. Language may have a string data type. In more detail, the broadcast reception device 100 and the companion device 200 may display the primary language of a broadcast service on the basis of Language.

UsageReportingInfo represents usage report information relating to a broadcast service. UsageReportingInfo may be provided in zero, or one or more. UsageReportingInfo may have a string data type. In more detail, UsageReportingInfo may be used as a parameter for usage information report. For example, UsageReportingInfo may include at least one of a URL for usage information report and a report period. Through such usage information report, a broadcast service provider may obtain usage information of a broadcast service and billing information on a broadcast service. In more detail, the broadcast reception device 100 and the companion device 200 may report usage information of a broadcast service on the basis of UsageReportingInfo.

Targeting represents the targeting property of a broadcast service. Targeting may be provided in zero, or one or more. In more detail, Targeting may have a string data type. In more detail, Targeting may represent whether a corresponding broadcast service is for a primary device such as the broadcast reception device 100 or the companion device 200. In more detail, the broadcast reception device 100 and the companion device 200 may determine whether to display a broadcast service on the basis of Targeting.

ServiceProtection represents the property on protection of a broadcast service. ServiceProtection may be provided in zero or one. In more detail, ServiceProtection may have a string data type.

AdvisoryRating represents the advisory rating of a broadcast service. AdvisoryRating may be provided in zero, or one or more. AdvisoryRating may have a string data type. The broadcast reception device 100 and the companion device 200 may block a broadcast service on the basis of an advisory rating and personalization information.

ComponentItem represents information on a media component in a broadcast service. In more detail, ComponentItem may include at least one of componentId, ComponentType, ComponentName, StartTime, Duration, TargetScreen, URL, ContentAdvisory, and Genre.

ComponentId represents an identifier for identifying a corresponding media component. In more detail, ComponentId may be provided in one. In more detail, ComponentId may have an unsigned data type. In more detail, the broadcast reception device 100 and the companion device 200 may identify a media component on the basis of ComponentId.

CmponentType represents the type of a corresponding media component. In more detail, CmponentType may be provided in one. CmponentType may have a string data type. In more detail, the broadcast reception device 100 and the companion device 200 may display the type of a media component on the basis of CmponentType.

ComponentName represents the name of a corresponding media component. In more detail, ComponentName may be provided in zero, or one or more. ComponentName may have a string data type. In more detail, the broadcast reception device 100 and the companion device 200 may display the name of a media component on the basis of ComponentName.

StartTime represents the start time of a corresponding media component. In more detail, StartTime may be provided in zero or one. In more detail, StartTime may have an unsigned short data type. In more detail, the broadcast reception device 100 and the companion device 200 may determine the start time of a media component on the basis of StartTime.

Duration represents the Duration of a corresponding media component. In more detail, Duration may be provided in zero or one. In more detail, Duration may have an unsigned short data type. In more detail, the broadcast reception device 100 and the companion device 200 may determine the duration of a media component on the basis of Duration.

TargetScreen represents a screen that a corresponding media component targets. In more detail, TargetScreen may be provided in zero, or one or more. In more detail, TargetScreen may have a string data type. In more detail, the broadcast reception device 100 and the companion device 200 may determine whether to play a corresponding media component on the basis of TargetScreen.

URL represents an address for receiving a media component. In more detail, URL may be provided in zero, or one or more. In more detail, URL may have a URI data type. In more detail, URL may represent the address of the content/signaling server 400. In more detail, the broadcast reception device 100 and the companion device 200 may receive a media component on the basis of URL.

ContentAdvisory represents the advisory rating of a corresponding media component. When a value of ContentAdvisory conflicts a value of AdvisoryRating, the value of ContentAdvisory may have priority. In more detail, ContentAdvisory may be provided in zero, or one or more. In more detail, ContentAdvisory may have a string data type. In more detail, the broadcast reception device 100 and the companion device 200 may determine whether to play a media component on the basis of ContentAdvisory.

Genre represents the genre of a media component. In more detail, Genre may be provided in one or more. Genre may have a string data type. When Genre conflicts the above-mentioned genre of a service, Genre representing the genre of a media component may have priority. In more detail, the broadcast reception device 100 and the companion device 200 may display the genre of a media component on the basis of Genre.

As described above, the broadcast reception device 100 and the companion device 200 may interoperate with the broadcast reception device 200 through at least one of a home network, a mobile communication network such as 3GPP, and an HTTP proxy server. At this point, a communication between the broadcast reception device 100 and the companion device 200 may be made through various methods. In more detail, a communication between the broadcast reception device 100 and the companion device 100 may be made through Universal Plug and Play (UPnP).

UPnP classifies a device into a control point (CP) and controlled devices (CDs). The CP controls the CDs through an UPnP protocol. According to a specific embodiment, the broadcast reception device 100 corresponds to one of the CDs. Additionally, the companion device 200 may correspond to the CP. UPnP defines discovery, description, control, and eventing protocols. The discovery protocol is a protocol through which a CP searches for a CD. The description protocol is a protocol through which a CP obtains information of a CD. The control protocol is a protocol through which a CP invokes a predetermined operation of a CD. The eventing protocol is a protocol through which a CD delivers unsynchronized notifications to a CP. The broadcast reception device 100 and the companion device 200 may interoperate with each other through at least one of the discovery, description, and control, and eventing protocols of the UPnP protocol. For example, the broadcast reception device 100 may find the companion device 200 through the discovery protocol. Specific operations of the broadcast reception device 100 and the companion device 200 will be described with reference to FIGS. 33 to 43.

FIG. 33 is a view illustrating a parameter representing a state of a signaled broadcast service property according to an embodiment of the present invention.

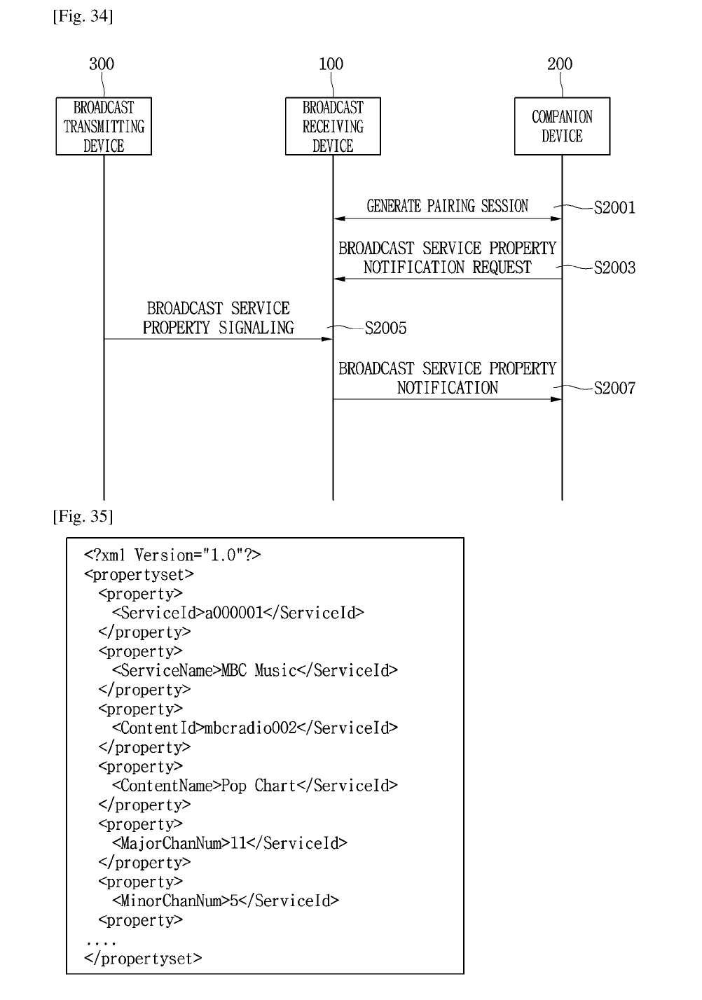

The broadcast reception device 100 may transmit one parameter representing the property of a broadcast service to a companion device. One parameter representing the property of a broadcast service may include the property of a current broadcast service. In more detail, as shown in the embodiment of FIG. 33, a parameter such as ServiceProperty may be transmitted. According to a specific embodiment, ServiceProperty may be an essential parameter and may have a string data type. Additionally, according to a specific embodiment, ServiceProperty may not have a related action. When a subscription for ServiceProperty is requested, the broadcast reception device 100 may transmit ServiceProperty to the companion device 200. A specific process of the broadcast reception device 100 to transmit the property of a broadcast service is described with reference to FIG. 34.

FIG. 34 is a ladder diagram illustrating operations when a broadcast reception device signals a broadcast service property to a companion device according to an embodiment of the present invention.

The broadcast reception device 100 and the companion device 200 generate a pairing session in operation S2001. In more detail, the broadcast reception device 100 may generate a pairing session with the companion device 200 through an IP communication unit 130. In more detail, the companion device 200 may generate a pairing session with the broadcast reception device 100 through a communication unit. In more detail, the broadcast reception device 100 and the companion device 200 may generate a pairing session for bidirectional communication. In more detail, the broadcast reception device 100 and the companion device 200 may generate a pairing session by using the UPnP protocol. According to a specific embodiment, the broadcast reception device 100 may find the companion device 200 through the discovery protocol of UPnP. For example, a discovery message that the broadcast reception device 100 searches for a companion device to interoperate through a well known IP address may be multicasted. At this point, the companion device 200 receiving a multicasted message may request a description from the broadcast reception device 100. The broadcast reception device 100 may provide the description to the companion device 200 on the basis of the description request of the companion device 200. The companion device 200 may access the broadcast reception device 200 on the basis of the description. According to another embodiment, the companion device 200 may find the broadcast reception device 100 through the discovery protocol of UPnP. For example, a message that the companion device 200 searches for the broadcast reception device 100 to interoperate through a well known IP address may be multicasted. At this point, the broadcast reception device 100 may reply with a display message on the basis of the multicasted message. Accordingly, the companion device 200 receiving the discovery message may request a description from the broadcast reception device 100. The broadcast reception device 100 may provide the description to the companion device 200 on the basis of the description request of the companion device 200. The companion device 200 may access the broadcast reception device 200 on the basis of the description.

The companion device 200 requests a property notification of a broadcast service from the broadcast reception device 100 in operation S2003. In more detail, the companion device 200 may request a property notification of a broadcast service from the broadcast reception device 100 through a control unit. In more detail, the companion device 200 may request a property notification of a broadcast service from the broadcast reception device 100 through the UPnP protocol. According to a specific embodiment, the companion device 200 may request an event subscription for the property of a broadcast service from the broadcast reception device 100 on the basis of an eventing protocol.

The broadcast reception device 100 receives information signaling a broadcast service property on the basis of a broadcast service in operation S2005. In more detail, the broadcast reception device 100 may receive information signaling a broadcast service property from the broadcast transmission device 300 through the broadcast reception unit 110.

The broadcast reception device 100 notifies the broadcast service property to the companion device 200 on the basis of the information signaling the property of a broadcast service in operation S2007. In more detail, the broadcast reception device 100 notifies the broadcast service property to the companion device 200 through the control unit 150 on the basis of the information signaling the property of a broadcast service. In more detail, the broadcast reception device 100 may determine whether the property of a broadcast service is changed compared to before. When the property of a broadcast service is changed compared to before, the broadcast reception device 100 may notify the property of a broadcast service to the companion device 200. According to a specific embodiment, the broadcast reception device 100 may notify the property of a broadcast service to the companion device 200 through a parameter representing a state of the broadcast service property. According to a specific embodiment, the parameter representing a state of the broadcast service property may be ServiceProperty of FIG. 33. A data format of the parameter representing a state of the broadcast service property will be described in more detail with reference to FIG. 35.

FIG. 35 is a view illustrating a data format of a broadcast service property that a broadcast reception device signals to a companion device according to an embodiment of the present invention.

The data format of a broadcast service property may be XML format as shown in FIG. 35. However, the data format of a broadcast service property is not limited thereto. In the embodiment of FIG. 35, the data format of a broadcast service property includes all the properties of a broadcast service described with reference to FIG. 32. Accordingly, even if only part of the broadcast service properties is changed, the broadcast reception device 100 needs to transmit the entire broadcast service properties and the companion device 200 needs to receive the entire broadcast service properties. In such a case, the data amount exchanged between the broadcast reception device 100 and the companion device 200 increases. Additionally, the companion device 200 needs to check which broadcast service property is changed again. Accordingly, a method of the broadcast reception device 100 to efficiently signal a broadcast service property to the companion device 200 is required. This will be described with reference to FIGS. 36 to 38.

FIG. 36 is a view illustrating a parameter representing a state of a broadcast service property that a broadcast reception device signals to a companion device, an action for broadcast service property, and an action argument according to another embodiment of the present invention.

According to another embodiment of the present invention, the parameter representing the property of a broadcast service may include at least one of a parameter representing a broadcast service property, a parameter representing the name of a broadcast service property, and a parameter representing whether a broadcast service property is changed. In more detail, when the companion device 200 requests a specific property of a broadcast service, the broadcast reception device 100 may transmit the property of a broadcast service on the basis of the request of the companion device 200. In more detail, the broadcast reception device 100 may transmit the specific property of the broadcast service that the companion device 200 requests. For example, the broadcast reception device 100 may notify the companion device 200 whether the property of a broadcast service is changed through a parameter representing whether the property of the broadcast service is changed. At this point, the companion device 200 may request the property of a broadcast service through a parameter representing the name of a broadcast service property. The broadcast reception device 100 may notify the broadcast service property to the companion device 200 through a parameter representing the broadcast service property.

According to a specific embodiment, the parameter representing the property of a broadcast service may include at least one of ServiceProperty, ServicePropertyName, and ServicePropertyChangeFlag. ServiceProperty represents the property of a broadcast service. According to a specific embodiment, ServiceProperty may be an essential parameter and may have a string data type. ServicePropertyName represents the name of a broadcast service property. ServicePropertyName is an essential parameter and may have a string data type. ServicePropertyChangeFlag represents whether a broadcast service property is changed. According to a specific embodiment, ServicePropertyChangeFlag may be an essential parameter and may have a Boolean data type. Additionally, when the companion device 200 request a subscription for ServicePropertyChangeFlag, the broadcast reception device 100 may transmit ServicePropertyChangeFlag to the companion device 200.

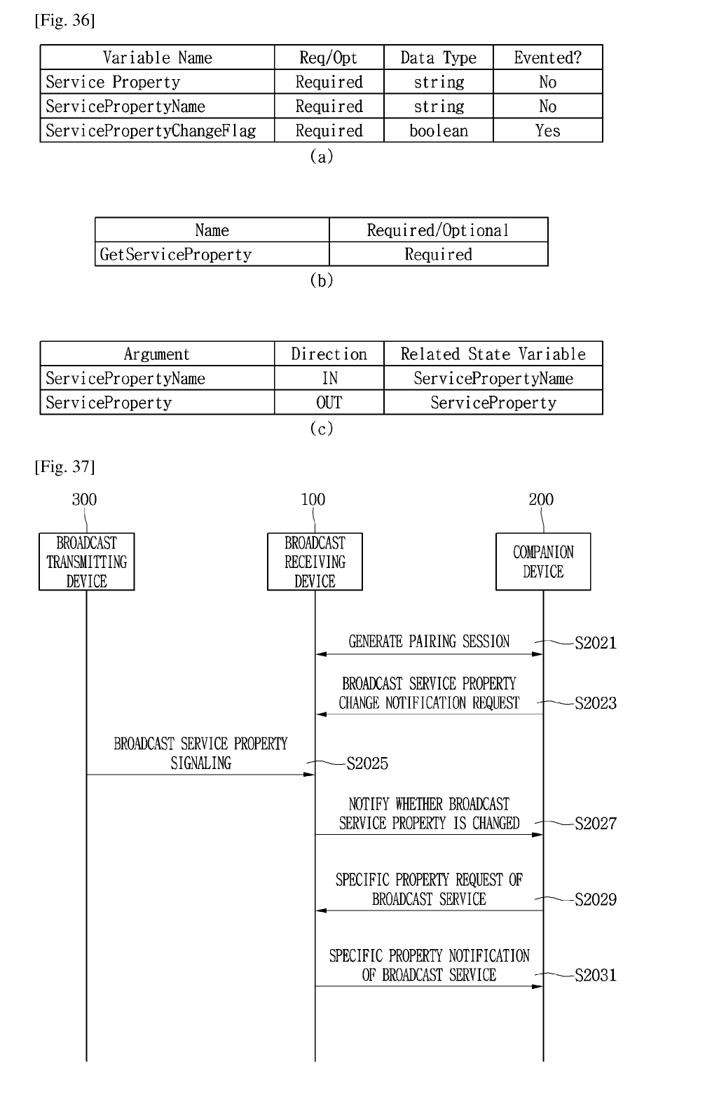

The companion device 200 may use a GetServiceProperty action to request the property of a broadcast service through a parameter representing the name of a broadcast service property. GetServiceProperty is an essential action. At this point, GetServiceProperty may have ServiceProgpertyName as an argument for input. Additionally, GetServiceProperty may have ServiceProperty as an argument for output. According to a specific embodiment, when the companion device 200 sets the property of a broadcast service to be obtained to SevicePropertyName and transmits a GetServiceProperty action to the broadcast reception device 100, the companion device 200 may receive the property of a broadcast service corresponding to ServicePropertyName as ServiceProperty. Specific operations of the broadcast reception device 100 and the companion device 200 will be described with reference to FIG. 37.

FIG. 37 is a ladder diagram illustrating operations when a broadcast reception device signals a broadcast service property to a companion device according to another embodiment of the present invention.

The broadcast reception device 100 and the companion device 200 generate a pairing session in operation S2021. In more detail, the broadcast reception device 100 may generate a pairing session with the companion device 200 through an IP communication unit 130. In more detail, the companion device 200 may generate a pairing session with the broadcast reception device 100 through a communication unit. As described above, the broadcast reception device 100 and the companion device 200 may generate a pairing session for bidirectional communication. In more detail, operations of the broadcast reception device 100 and the companion device 200 may be identical to those in the embodiment of FIG. 34.

The companion device 200 requests a property change notification of a broadcast service from the broadcast reception device 100 in operation S2023. In more detail, the companion device 200 may request a property change notification of a broadcast service from the broadcast reception device 100 through a control unit. In more detail, operations of the companion device 200 may be identical to those in the embodiment of FIG. 34.

The broadcast reception device 100 receives information signaling a broadcast service property on the basis of a broadcast service in operation S2025. In more detail, the broadcast reception device 100 may receive information signaling a broadcast service property from the broadcast transmission device 300 through the broadcast reception unit 110.

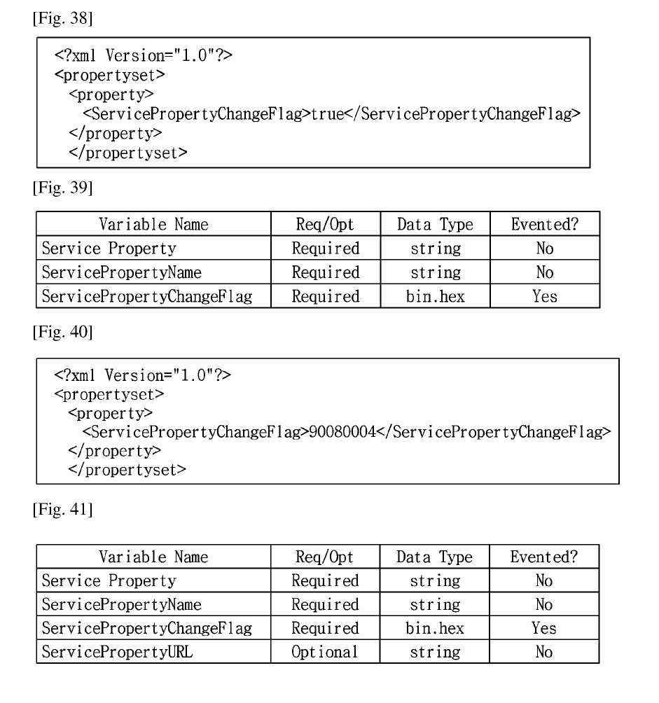

The broadcast reception device 100 notifies the companion device 200 whether the broadcast service property is changed on the basis of the information signaling the property of a broadcast service in operation S2027. In more detail, the broadcast reception device 100 notifies the companion device 200 whether the broadcast service property is changed through the control unit 150 on the basis of the information signaling the property of a broadcast service. In more detail, the broadcast reception device 100 may determine whether the property of a broadcast service is changed compared to before. When the property of a broadcast service is changed compared to before, the broadcast reception device 100 may notify the property change of a broadcast service to the companion device 200. In more detail, the broadcast reception device 100 may determine whether the property of a broadcast service is changed on the basis of the version of information signaling the property of a broadcast is changed compared to before. Additionally, according to a specific embodiment, the broadcast reception device 100 may notify the companion device 200 whether the property of a broadcast service is changed through a parameter representing whether the broadcast service property is changed. According to a specific embodiment, the parameter representing whether the broadcast service property is changed may be ServicePropertyChangedFlag of FIG. 33. At this point, a data format representing whether the broadcast service property is changed will be described in more detail with reference to FIG. 38.

FIG. 38 is a view illustrating a data format of whether a broadcast service property is changed that a broadcast reception device signals to a companion device according to another embodiment of the present invention.

The data format of whether a broadcast service property is changed may be XML format. However, the data format of whether a broadcast service property is not limited thereto. According to a specific embodiment, the broadcast reception device 100 may notify the companion device 200 only whether the property of a broadcast service is changed. As shown in the embodiment of FIG. 38, the broadcast reception device 100 may display whether the property of a broadcast service is changed to the companion device 200 through a Boolean parameter having a TRUE value or a FALSE value. For example, when the property of a broadcast service is changed, the broadcast reception device 100 may transmit to the companion device 200 data in which a parameter representing whether the property of a broadcast service has a TRUE value. However, in such an embodiment, the companion device 200 may not know which property in a broadcast service is changed and may only know that at least one of broadcast service properties is changed. Accordingly, even when a broadcast service property that the companion device 200 does not require is changed, the companion device 200 requests the property of a broadcast service. Accordingly, such an embodiment may cause unnecessary operations and unnecessary data exchanges of the broadcast reception device 100 and the companion device 200. To resolve this issue, the broadcast reception device 100 may need to notify a changed broadcast service property to the companion device 200. This will be described with reference to FIGS. 39 and 40.

FIG. 39 is a view illustrating parameters representing a state of a broadcast service property that a broadcast reception device signals to a companion device according to another embodiment of the present invention.

When the property of a broadcast service is changed, the broadcast reception device 100 may notify the companion device 200 the changed property and whether the broadcast service property is changed together. For this, the parameter representing whether a broadcast service property is changed may include information representing the changed property of a broadcast service. For this, the parameter representing whether a broadcast service property is changed may have a binary hex type. Accordingly, other parameters, actions, and action arguments are the same and according to an embodiment of FIG. 36, ServicePropertyChangedFlag that is a parameter representing whether the property of a broadcast service is changed may be a binary hex type. When a subscription for ServicePropertyChangedFlag is requested, the broadcast reception device 100 may transmit ServicePropertyChangedFlag to the companion device 200. A data format of whether the property of a broadcast service is changed that the broadcast reception device 100 signals to the companion device 200 will be described with reference to FIG. 40.

FIG. 40 is a view illustrating a data format of whether a broadcast service property is changed that a broadcast reception device signals to a companion device according to another embodiment of the present invention.

The data format of whether a broadcast service property is changed may be XML format. However, the data format of whether a broadcast service property is not limited thereto. The broadcast reception device 100 allocates a specific bit to each broadcast service property and when the property of a broadcast is changed, displays a corresponding bit with 1. In the embodiment of FIG. 4, a hexadecimal number 90080004 is a binary number 1001 0000 0000 1000 0000 0000 0100. At this point, the first four bits represent the primary language, genre, advisory rating, and targeting property of a broadcast, respectively. In this case, the companion device 200 may recognize that the primary language and targeting property of a broadcast are changed.

Again, referring to FIG. 37, the case that the broadcast reception device 100 signals a broadcast service property to the companion device 2200 will be described according to another embodiment of the present invention.

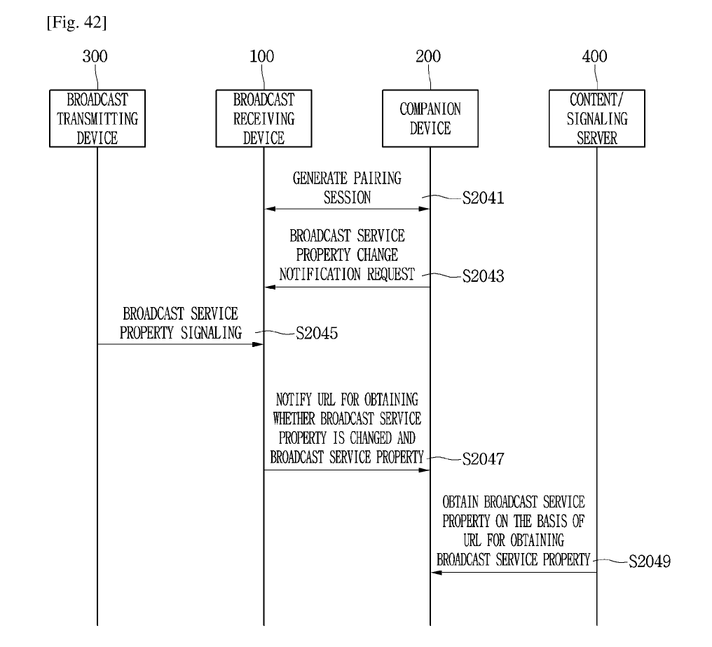

The companion device 200 requests a specific property of a broadcast service from the broadcast reception device 100 in operation S2029. The specific property of a broadcast service may be one or more properties among a plurality of broadcast service properties in information signaling the property of a broadcast. The companion device 200 may request a specific property of a broadcast service from the broadcast reception device 100 through a control unit. In more detail, when the broadcast reception device 100 transmits a property change notification of a broadcast service, the companion device 200 may request the specific property of the broadcast service from the broadcast reception device 100. At this point, the specific property of the broadcast service may be the property of a broadcast service necessary for the companion device 200 to provide broadcast service related additional services. Additionally, as shown in FIGS. 41 and 42, when the broadcast reception device 100 signals changed part among broadcast service properties, the companion device 100 may request the specific property of the broadcast service on the basis of the changed property type of the broadcast service. In more detail, when a specific property of a broadcast service is changed, the companion device 200 may request the specific property of the broadcast service. The specific property of the broadcast service may be a property necessary for the companion device 200 to provide broadcast service related additional services. For example, in the case that the companion device 200 determines whether to present a broadcast service on the basis of the targeting property of the broadcast service, when the targeting property of the broadcast service is changed, the companion device 200 may request the targeting property of the broadcast service.

The broadcast reception device 100 notifies the specific property of the broadcast service to the companion device 200 in operation S2031. In more detail, the broadcast reception device 100 may notify the specific property of the broadcast service to the companion device 200 through the control unit 150. In more detail, the broadcast reception device 100 may notify the specific property of the broadcast service on the basis of a request of the companion device 200. For example, the broadcast reception device 100 may transmit the specific property of the broadcast service that the companion device 200 requests to the companion device 200.

However, such an embodiment may require a continuous communication between the broadcast reception device 100 and the companion device 200. Especially, when the broadcast reception device 100 interoperates with a plurality of companion devices 200, a continuous communication may cause the overload to an operation of the broadcast reception device 100. This issue may be resolved if the companion device 100 receives the property of a broadcast service from the content/signaling server 400. This will be described with reference to FIGS. 41 and 42.

FIG. 41 is a view illustrating parameters representing a state of a broadcast service property that a broadcast reception device signals to a companion device according to another embodiment of the present invention.

When the property of a broadcast service is changed, the broadcast reception device 100 may notify the companion device 200 of a URL address for receiving whether the broadcast service property is changed and the property of the broadcast service. For this, a parameter representing a state of a broadcast service property that the broadcast reception device 100 signals to the companion device 200 may include information representing a URL address for the property of the broadcast service. According to a specific embodiment, a parameter representing a state of a signaled broadcast service property may include ServicePropertyChangeFlag representing a URL address for receiving the property of a broadcast service. According to a specific embodiment, ServicePropertyChangeFlag may be an optional parameter and may have a string data type. Specific operations of the broadcast reception device 100 and the companion device 200 will be described with reference to FIG. 42.

FIG. 42 is a ladder diagram illustrating operations when a broadcast reception device signals a broadcast service property to a companion device according to another embodiment of the present invention.

The broadcast reception device 100 and the companion device 200 generate a pairing session in operation S2041. In more detail, the broadcast reception device 100 may generate a pairing session with the companion device 200 through an IP communication unit 130. In more detail, the companion device 200 may generate a pairing session with the broadcast reception device 100 through a communication unit. As described above, the broadcast reception device 100 and the companion device 200 may generate a pairing session for bidirectional communication. In more detail, operations of the broadcast reception device 100 and the companion device 200 may be identical to those in the embodiment of FIG. 37.

The companion device 200 requests a property change notification of a broadcast service from the broadcast reception device 100 in operation S2043. In more detail, the companion device 200 may request a property notification of a broadcast service from the broadcast reception device 100 through a control unit. In more detail, operations of the companion device 200 may be identical to those in the embodiment of FIG. 37.

The broadcast reception device 100 receives information signaling a broadcast service property on the basis of a broadcast service in operation S2045. In more detail, the broadcast reception device 100 may receive information signaling a broadcast service property from the broadcast transmission device 300 through the broadcast reception unit 110.

The broadcast reception device 100 notifies the companion device 200 of a URL for obtaining whether the broadcast service property is changed and the property of a broadcast service on the basis of the information signaling the property of the broadcast service in operation S2047. In more detail, the broadcast reception device 100 notifies the companion device 200 of a URL for obtaining whether the broadcast service property is changed and the property of a broadcast service through the control unit 150 on the basis of the information signaling the property of a broadcast service. In more detail, the broadcast reception device 100 may determine whether the property of a broadcast service is changed compared to before. In more detail, the broadcast reception device 100 may determine whether the property of a broadcast service is changed on the basis of the version of information signaling the property of a broadcast is changed compared to before. Additionally, when the property of a broadcast service is changed compared to before, the broadcast reception device 100 may notify the companion device 200 of a URL address for obtaining the broadcast service property change and the broadcast service property. According to a specific embodiment, the broadcast reception device 100 may notify the companion device 200 whether the property of a broadcast service is changed through a parameter representing whether the broadcast service property is changed. According to a specific embodiment, the parameter representing whether the broadcast service property is changed may be ServicePropertyChangeFlag of FIG. 41. Additionally, the broadcast reception device 100 may notify the companion device 200 whether the property of a broadcast service is changed through a parameter representing a URL for obtaining the property of the broadcast service. According to a specific embodiment, the parameter representing a URL for obtaining the property of the broadcast service may be ServicePropertyURL of FIG. 41.

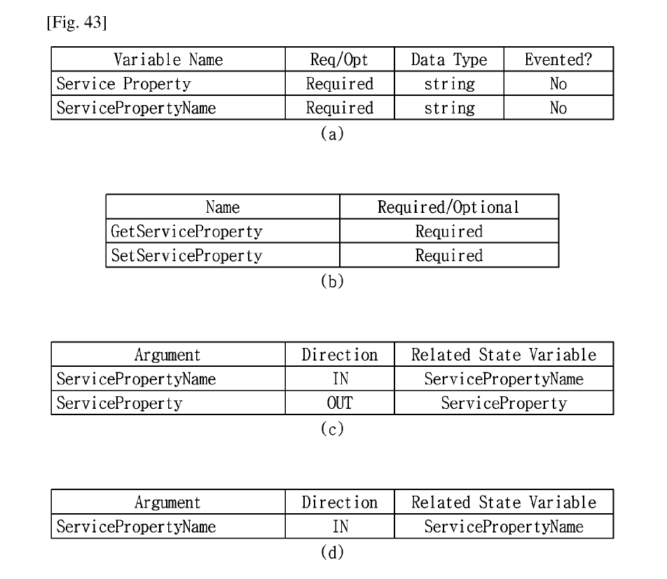

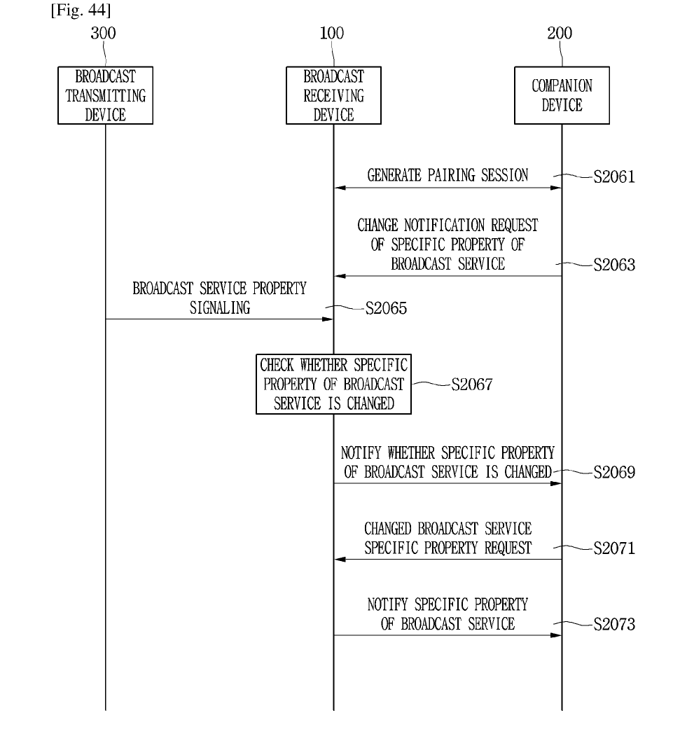

The companion device 200 obtains the property of a broadcast service on the basis of a URL for obtaining the property of the broadcast service in operation S2049. In more detail, the companion device 200 obtains the property of a broadcast service through a control unit on the basis of a URL for obtaining the property of the broadcast service. In more detail, the companion device 200 obtains the property of a broadcast service from the content/signaling server 400 on the basis of a URL for obtaining the property of the broadcast service. In more detail, the companion device 200 requests the property of a broadcast service from the content/signaling server 400 on the basis of a URL for obtaining the property of the broadcast service and then obtains the property of the broadcast service from the content/signaling server 400. Through this, the load of the broadcast communication device 100 resulting from a communication between the broadcast reception device 100 and the companion device 200 may be reduced. However, according to such an embodiment, even when the property of a broadcast service that the companion device 200 does not require is changed, the broadcast reception device 100 needs to notify the broadcast service property change. Accordingly, the broadcast reception device 100 needs to perform an unnecessary operation. As a necessary broadcast service property is set in advance when the companion device 200 requests a notification change from the broadcast reception device 100, unnecessary operations of the broadcast reception device 100 may be reduced. This will be described with reference to FIGS. 43 and 44.

FIG. 43 is a view illustrating a parameter representing a state of a broadcast service property that a broadcast reception device signals to a companion device, an action for broadcast service property, and an action argument according to another embodiment of the present invention.

The companion device 200 may designate a desired broadcast service property to be notified as requesting a property change notification of a broadcast service from the broadcast reception device 100. For this, the companion device 200 may include an action for designating the desired broadcast service property to be notified. At this point, the action may have a parameter representing a desired broadcast service property to be notified as an input argument. Such an action may be SetServiceProperty of FIG. 43. According to a specific embodiment, SetServiceProperty may be an essential action. Additionally, SetServiceProperty may have ServicePropertyName representing the type of a broadcast service property as an input argument. Specific operations of the broadcast reception device 100 and the companion device 200 will be described with reference to FIG. 44.

FIG. 44 is a ladder diagram illustrating operations when a broadcast reception device signals a broadcast service property to a companion device according to another embodiment of the present invention.

The broadcast reception device 100 and the companion device 200 generate a pairing session in operation S2061. In more detail, the broadcast reception device 100 may generate a pairing session with the companion device 200 through an IP communication unit 130. In more detail, the companion device 200 may generate a pairing session with the broadcast reception device 100 through a communication unit. As described above, the broadcast reception device 100 and the companion device 200 may generate a pairing session for bidirectional communication. In more detail, operations of the broadcast reception device 100 and the companion device 200 may be identical to those in the embodiment of FIG. 42.

The companion device 200 requests a specific property change notification of a broadcast service from the broadcast reception device 100 in operation S2063. In more detail, the companion device 200 may request a specific property change notification of a broadcast service from the broadcast reception device 100 through a control unit. The companion device 200 may request only a specific property change of a broadcast service necessary for providing broadcast service related additional services. According to a specific embodiment, the companion device 200 may request a specific property change notification of a broadcast service through an action for requesting only the specific property change notification. At this point, the action for requesting only the specific property change notification may be SetServiceProperty of FIG. 43. An operation of the companion device 200 to request a specific property change notification of a broadcast service from the broadcast reception device 100 may include the following operations. The companion device 200 requests a subscription for service property change notification from the broadcast reception device 100. When accepting the request for service property change notification subscription, the broadcast reception device 100 may transmit an acceptance message and a subscription identifier (SID) for identifying the subscription request to the companion device 200. The companion device 200 may request a specific property change notification of a broadcast service from the broadcast reception device 100 on the basis of the SID. In more detail, the companion device 200 may transmit both the SID and a specific property change of a broadcast service to be notified. Additionally, the companion device 200 may request a plurality of changed specific properties of a broadcast service from the broadcast reception device 100. At this point, the companion device 200 may request a plurality of specific properties of a broadcast service as in a list form.

The broadcast reception device 100 receives information signaling a broadcast service property on the basis of a broadcast service in operation S2065. In more detail, the broadcast reception device 100 may receive information signaling a broadcast service property from the broadcast transmission device 300 through the broadcast reception unit 110.

The broadcast reception device 100 checks whether a specific property of a broadcast is changed in operation S2067. In more detail, the broadcast reception device 100 may check whether a specific property of a broadcast service is changed through the control unit 150. In more detail, the broadcast reception device 100 may determine whether the specific property of a broadcast service is changed compared to before. In more detail, the broadcast reception device 100 may determine whether the specific property of a broadcast service is changed by comparing a previous value and the current value of the specific property of the broadcast service.

When the specific property of the broadcast service is changed, the broadcast reception device 100 notifies the companion device 200 whether the specific broadcast service property is changed on the basis of the information signaling the property of a broadcast service in operation S2069. In more detail, when the specific broadcast service property is changed, the broadcast reception device 100 notifies the companion device 200 whether the specific broadcast service property is changed through the control unit 150 on the basis of the information signaling the property of a broadcast service.

The companion device 200 requests a specific property of a broadcast service from the broadcast reception device 100 in operation S2071. In more detail, the companion device 200 may request a specific property of a broadcast service from the broadcast reception device 100 through a control unit. In more detail, when the broadcast reception device 100 transmits a specific property change notification of a broadcast service, the companion device 200 may request the specific property of the broadcast service from the broadcast reception device 100. Specific operations of the companion device 200 may be identical to those in the embodiment of FIG. 37.

The broadcast reception device 100 notifies the specific property of the broadcast service to the companion device 200 in operation S2073. The broadcast reception device 100 may notify the specific property of the broadcast service to the companion device 200 through the control unit 150. In more detail, the broadcast reception device 100 may notify the specific property of the broadcast service on the basis of a request of the companion device 200. For example, the broadcast reception device 100 may transmit the specific property of the broadcast service that the companion device 200 requests to the companion device 200.

Additionally, the companion device 200 does not obtain the specific property of the broadcast service from the broadcast reception device 100 but as described with reference to FIG. 42, obtains a URL for obtaining a broadcast service property and then obtains the specific property of the broadcast service on the basis of the URL for obtaining the broadcast service property. Through such an operation, unnecessary operations of the broadcast reception device 100 to notify the property change of a broadcast service to the companion device 200 may be reduced.

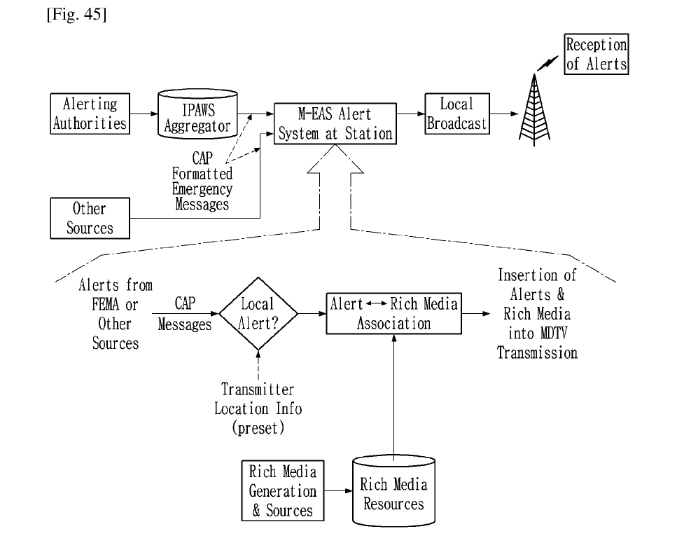

The broadcast reception device 100 may receive an emergency alert for disaster situations such as natural disasters, terrorism, and war through a network. Additionally, the broadcast reception device 100 may notify this to users. Through this, many people can recognize national disaster situations quickly and efficiently. However, if a user cannot stare at the broadcast reception device 100 all the time, there may be an emergency alert situation that is not recognized by the user. Even when a user cannot stare at the broadcast reception device 100 all the time, it is highly possible for the user to carry the companion device 200 such as a mobile phone or a tablet all the time. Accordingly, if the broadcast reception device 100 transmits an emergency alert to the companion device 200 and the companion device displays the emergency alert, a national disaster situation can be quickly notified to a user efficiently. This will be described with reference to FIGS. 45 to 57.

FIG. 45 is a view illustrating operations when an emergency alert is generated and transmitted through a broadcast network according to an embodiment of the present invention.

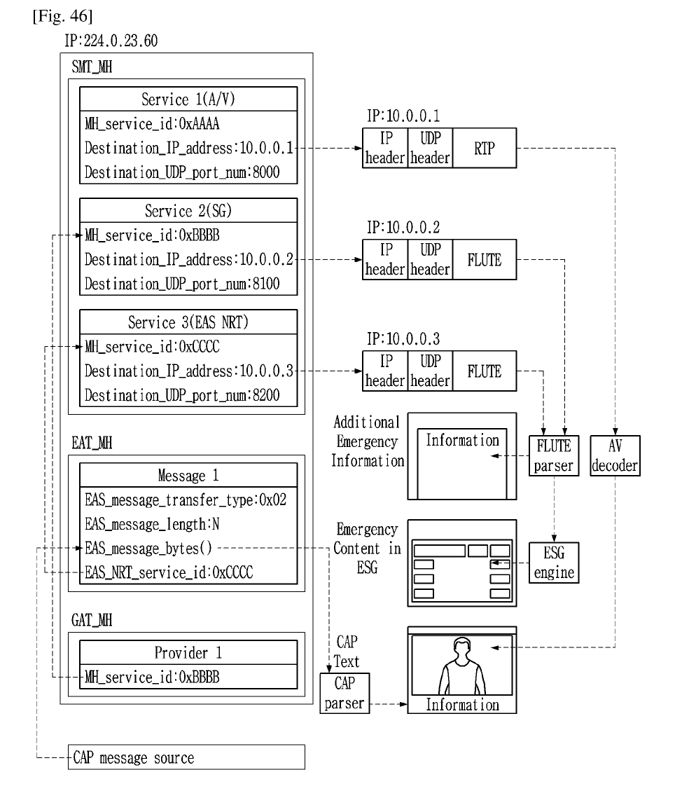

An alert system managing an emergency alert through broadcast service may receive an emergency situation from authorities having the authority to issue an emergency issue through Integrated Public Alert & Warning System (IPWS) or a message according to Common Alerting Protocol (CAP) through other sources. The alert system determines whether a CAP message corresponds to a current region. When the CAP message corresponds to the current region, the alert system inserts the CAP message into a broadcast signal. Accordingly, the CAP message is transmitted through a broadcast signal. An operation of the broadcast reception device 100 to receive a broadcast signal and transmit an emergency alert to a user is described with reference to FIG. 46.

FIG. 46 is a view when a broadcast reception device extracts and displays emergency information signaled through a broadcast network according to an embodiment of the present invention.

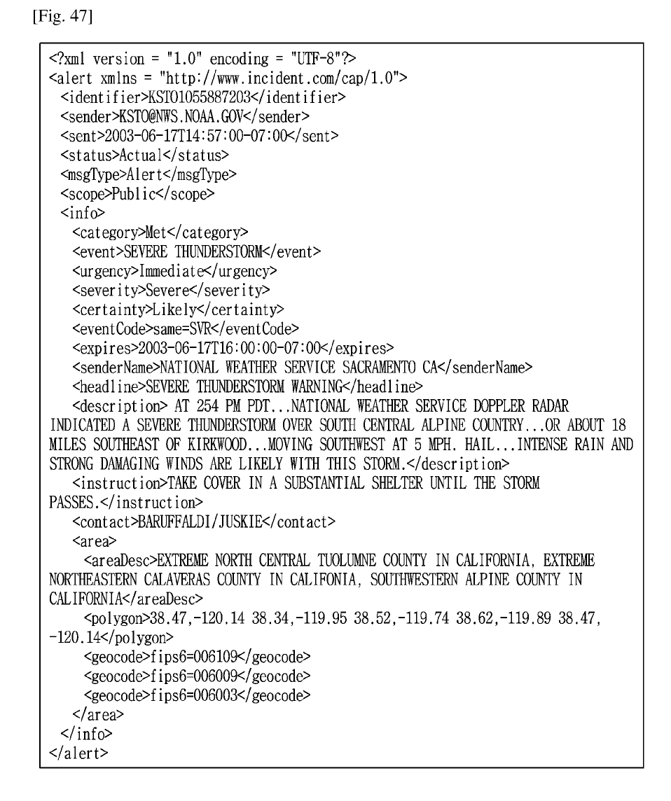

The broadcast transmission device 200 may extract an Emergency Alter Table (EAT) on the basis of a broadcast signal and may extract a CAP message from the EAT. Additionally, the broadcast transmission device 200 may obtain additional information relating to the emergency alert on the basis of an NRT service identifier in the EAT. In more detail, the broadcast reception device 200 may obtain additional information relating to the emergency alert on the basis of an EAS_NRT_service_id field in the EAT. In more detail, the broadcast reception device 200 may obtain information on a FLUTE session transmitting additional information relating to the emergency alert from a table signaling NRT service on the basis of the NRT service identifier in the EAT. At this point, the table signaling NRT service may be a Service Map Table (SMT). The broadcast reception device 200 may receive additional information relating to an emergency alert from a corresponding FLUTE session on the basis of information on the FLUTE session. The broadcast reception device 200 may receive the emergency alert and may then display it on a service guide displaying information on a broadcast service and a broadcast service program. In more detail, the broadcast reception device 200 extracts a service identifier from a Guide Access Table (GAT) and extracts and receives information corresponding to the service identifier from a table signaling NRT service. According to a specific embodiment, the broadcast reception device 200 may obtain information on the FLUTE session of a service corresponding to the extracted service identifier from the GAT. Then, the broadcast reception device 200 may receive an emergency alert message on the basis of the information on the FLUTE session and may display the emergency alert message on the service guide. The format of the CAP message may be the same as FIG. 47.

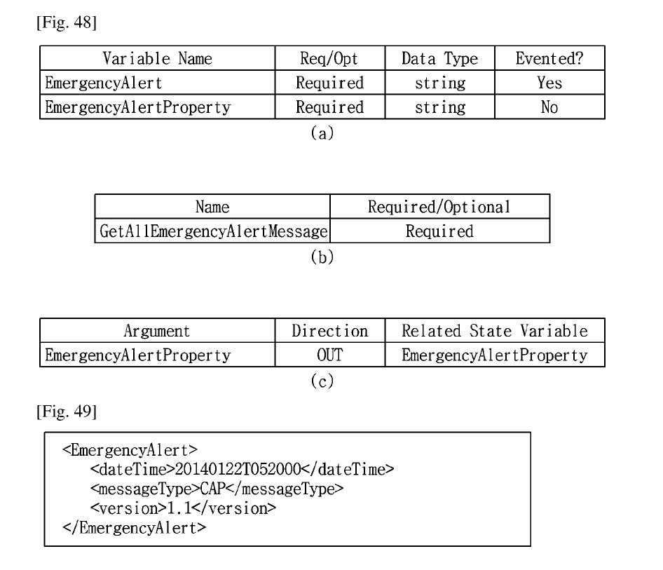

Specific operations of the broadcast reception device 100 and the companion device 200 will be described with reference to FIGS. 48 to 57.

FIG. 48 is a view illustrating a parameter representing a state of an emergency alert that a broadcast reception device signals, an action for emergency alert, and an action argument according to an embodiment of the present invention.

According to an embodiment of the present invention, the parameter representing a state of an emergency alert may include at least one of a parameter representing information on an emergency alert message including an emergency alert and a parameter representing information on an emergency alert including all emergency alert messages. In more detail, when receiving an emergency alert, the broadcast reception device 100 may notify the information on the emergency alert message to the companion device 100. The information on the emergency alert will be described with reference to FIG. 49.

FIG. 49 is a view illustrating information on an emergency alert message signaled by a broadcast reception device according to an embodiment of the present invention.

The information on an emergency alert message may include at least one of the version of an emergency alert, the format of an emergency alert message, the date of receiving an emergency alert message, and the time of receiving an emergency alert message. In more detail, the information may include at least one of messageType representing the format of an emergency alert message, dateTime representing the date of receiving an emergency alert message and the time of receiving an emergency alert message, and version representing the version of an emergency alert. According to a specific embodiment, information on a message including an emergency alert may be in XML format as shown in FIG. 49. However, the format of a message including an emergency alert is not limited thereto.

Again, referring to FIG. 48, a parameter representing a state of an emergency alert that a broadcast reception device signals, an action for emergency alert, and an action argument are described according to an embodiment of the present invention.

Additionally, the companion device 200 may request information on an emergency alert including all emergency alert messages through an action. At this point, the broadcast reception device 100 may signal to the companion device 100 the information on an emergency alert including all emergency alert messages through the parameter including information on an emergency alert. According to a specific embodiment, the parameter representing a state of an emergency alert may include at least one of EmergencyAlert and EmergencyAlertProperty. EmergencyAlert includes information on a message including an emergency alert. According to a specific embodiment, EmergencyAlert may be an essential parameter and may have a string data type. The broadcast reception device 100 may transmit EmergencyAlert through an eventing protocol of UPnP. According to a specific embodiment, when the broadcast reception device 100 receives an emergency alert, EmergencyAlertProperty includes information on an emergency alert. EmergencyAlertProperty is an essential parameter and may have a string data type. Additionally, an action for requesting information on an emergency alert including all emergency alert message may be GetAllEmergencyAlertMessage. According to a specific embodiment, GetAllEmergencyAlertMessage may be an essential action. Additionally, GetAllEmergencyAlertMessage may have EmergencyAlertProperty as an output argument.

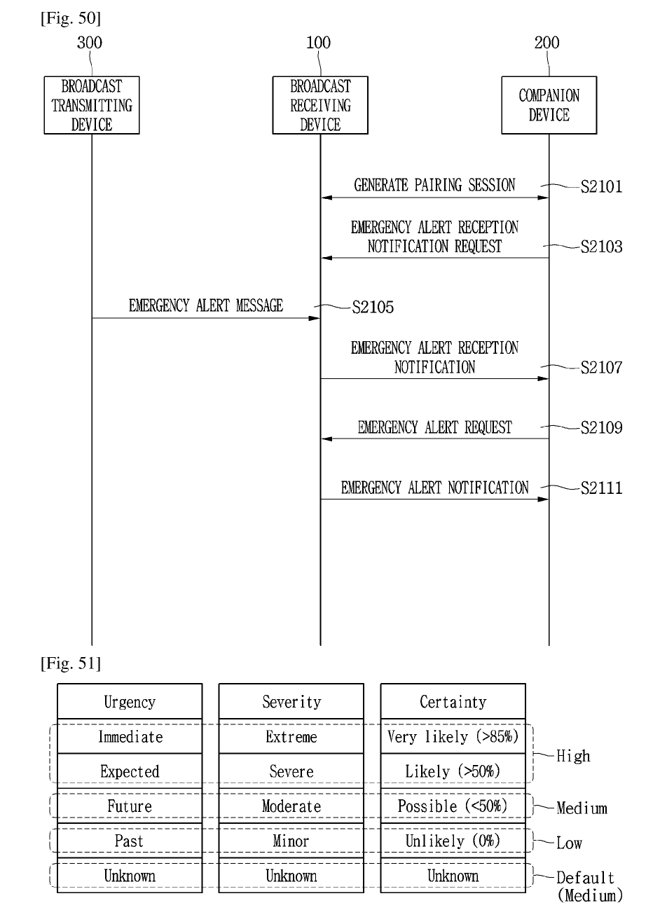

Operations of the broadcast reception device 100 and the companion device 200 will be described with reference to FIG. 50.

FIG. 50 is a ladder diagram illustrating operations when a broadcast reception device signals an emergency alert to a companion device according to an embodiment of the present invention.

The broadcast reception device 100 and the companion device 200 generate a pairing session in operation S2101. In more detail, the broadcast reception device 100 may generate a pairing session with the companion device 200 through an IP communication unit 130. In more detail, the companion device 200 may generate a pairing session with the broadcast reception device 100 through a communication unit. As described above, the broadcast reception device 100 and the companion device 200 may generate a pairing session for bidirectional communication. In more detail, operations of the broadcast reception device 100 and the companion device 200 may be identical to those in the embodiment of FIG. 34.

The companion device 200 requests an emergency alert reception notification from the broadcast reception device 100 in operation S2103. In more detail, the companion device 200 may request an emergency alert reception notification from the broadcast reception device 100 through a control unit. In more detail, the companion device 200 may request an emergency alert reception notification from the broadcast reception device 100 through the UPnP protocol. According to a specific embodiment, the companion device 200 may requests an event subscription for an emergency alert reception notification from the broadcast reception device 100 on the basis of an eventing protocol.

The broadcast reception device 100 receives a message including an emergency alert from the broadcast transmission unit 300 in operation S2105. In more detail, the broadcast reception device 100 may receive an emergency alert message from the broadcast transmission device 300 through the broadcast reception unit 110.

The broadcast reception device 100 notifies information on the emergency alert message to the companion device 200 on the basis of the emergency alert message in operation S2107. In more detail, the broadcast reception device 100 may notify information on the emergency alert message to the companion device 200 through the control unit 150 on the basis of the emergency alert message. According to a specific embodiment, the broadcast reception device 100 may notify the companion device 200 of the information on the emergency alert message through a parameter representing the information on the emergency alert message. According to a specific embodiment, the parameter representing the information on the emergency alert message may be EmergencyAlert of FIG. 49.

The companion device 200 requests the information on the emergency alert from the broadcast reception device 100 in operation S2109. In more detail, the companion device 200 may request an emergency alert from the broadcast reception device 100 through a control unit. According to a specific embodiment, the companion device 200 may request an emergency alert through an action requesting an emergency alert. According to a specific embodiment, the action requesting an emergency alert may be GetEmergencyAlertMessage of FIG. 49.

The broadcast reception device 100 notifies information on an emergency alert including all emergency alert messages to the companion device 200 in operation S2111. In more detail, the broadcast reception device 100 may notify information on the emergency alert including all emergency alert messages to the companion device 200 through the control unit 150. However, in such a case, since all emergency alert message need to be transmitted and received, this may serve as a load to operations of the broadcast reception device 100 and the companion device 200. Accordingly, a method of efficiently transmitting an emergency alert message to the companion device 200 is required.

The broadcast reception device 100 may extract information necessary for the companion device 200 from an emergency alert message and may then transmit the extracted information to the companion device 200. According to a specific embodiment, the broadcast reception device 100 may extract from the emergency alert message at least one of an identifier for identifying an emergency alert, information representing the category of an emergency alert, information representing a description for an emergency alert, information representing a region corresponding to an emergency alert, information representing the urgency of an emergency alert, information representing the severity of a disaster causing an emergency alert, and information representing the certainty of a disaster causing an emergency alert. According to a specific embodiment, the broadcast reception device 100 may extract from the emergency alert message at least one of identifier that is an element for identifying an emergency alert, category that is an element representing the category of an emergency alert, description that is an element representing a description for an emergency alert, areaDesc that is an element representing a region corresponding to an emergency alert, urgency that is an element representing the urgency of an emergency alert, severity that is an element representing the severity of a disaster causing an emergency alert, and certainty that is an element representing the certainty of a disaster causing an emergency alert.

The companion device 200 may determine the priority of an emergency alert and may operate on the basis of the priority of the emergency alert. A method of determining the priority of an emergency alert will be described with reference to FIGS. 51 to 53.

FIGS. 51 to 53 are views illustrating the criteria of a broadcast reception device to determine the priority of an emergency alert according to an embodiment of the present invention.

The companion device 200 may classify the priority of an emergency alert on the basis of each value of information representing the urgency of an emergency alert, information representing the severity of a disaster causing an emergency alert, and information representing the certainty of a disaster causing an emergency alert. At this point, the companion device 200 may determine the priority of an emergency alert according to a value having the highest priority among information representing the urgency of an emergency alert, information representing the severity of a disaster causing an emergency alert, and information representing the certainty of a disaster causing an emergency alert. According to a specific embodiment, the companion device 200 may classify the priority of an emergency alert into three urgencies according to values of information representing the urgency of an emergency alert, information representing the severity of a disaster causing an emergency alert, and information representing the certainty of a disaster causing an emergency alert. For example, as shown in FIG. 52, it is determined that the companion device 200 has the highest priority when the Urgency element corresponds to Immediate or Expected, has a medium priority lower than the highest priority and higher than the lowest priority when the Urgency element corresponds to Future, has the lowest priority when the Urgency element corresponds to Past, and has a priority corresponding to an initial value when the Urgency element corresponds to Unknown. At this point, the initial value may have a medium priority lower than the highest priority and higher than the lowest priority. Additionally, as shown in FIG. 52, it is determined that the companion device 200 has the highest priority when the Severity element corresponds to Extreme or Severe, has a medium priority lower than the highest priority and higher than the lowest priority when the Severity element corresponds to Moderate, has the lowest priority when the Severity element corresponds to Minor, and has a priority corresponding to an initial value when the Severity element corresponds to Unknown. At this point, the initial value may have a medium priority lower than the highest priority and higher than the lowest priority. Additionally, as shown in FIG. 52, it is determined that the companion device 200 has the highest priority when the Certainty element corresponds to Very likely or likely, has a medium priority lower than the highest priority and higher than the lowest priority when the Certainty element corresponds to Possible, has the lowest priority when the Certainty element corresponds to Unlikely, and has a priority corresponding to an initial value when the Certainty element corresponds to Unknown. At this point, the initial value may have a medium priority lower than the highest priority and higher than the lowest priority.

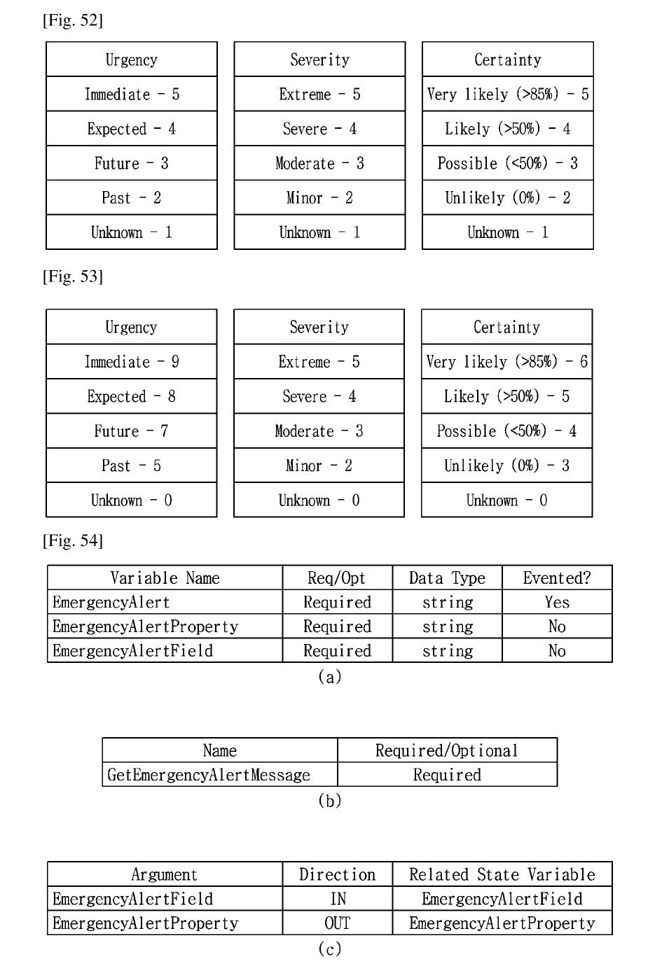

According to another embodiment, the companion device 200 may assign points on the basis of each value of information representing the urgency of an emergency alert, information representing the severity of a disaster causing an emergency alert, and information representing the certainty of a disaster causing an emergency alert, and may then determine the priority of an emergency alert according to the point sum. According to a specific embodiment, the companion device 200 may assign points with the same weight to information representing the urgency of an emergency alert, information representing the severity of a disaster causing an emergency alert, and information representing the certainty of a disaster causing an emergency alert. For example, as shown in FIG. 53, the companion device 200 may assign five points when the Urgency element corresponds to Immediate, four points when the Urgency element corresponds to Expected, three points when the Urgency element corresponds to Future, two points when Urgency element corresponds to Past, and one point when Urgency element corresponds to Unknown. Additionally, as shown in FIG. 53, the companion device 200 may assign five points when the Severity element corresponds to Extreme, four points when the Severity element corresponds to Severe, three points when the Severity element corresponds to Moderate, two points when Severity element corresponds to Minor, and one point when Severity element corresponds to Unknown. Additionally, as shown in FIG. 53, the companion device 200 may assign five points when the Certainty element corresponds to Very likely, four points when the Certainty element corresponds to likely, three points when the Certainty element corresponds to Possible, two points when Certainty element corresponds to Unlikely, and one point when Certainty element corresponds to Unknown. At this point, when the point sum is greater than 10 or less than 15, the companion device 200 determines that an emergency alert has the highest priority. Additionally, when the point sum is greater than 5 or less than 10, the companion device 200 determines that an emergency alert has a medium priority lower than the highest priority and higher than the lowest priority. Additionally, when the point sum is greater than 0 or less than 5, the companion device 200 determines that an emergency alert has the lowest priority.

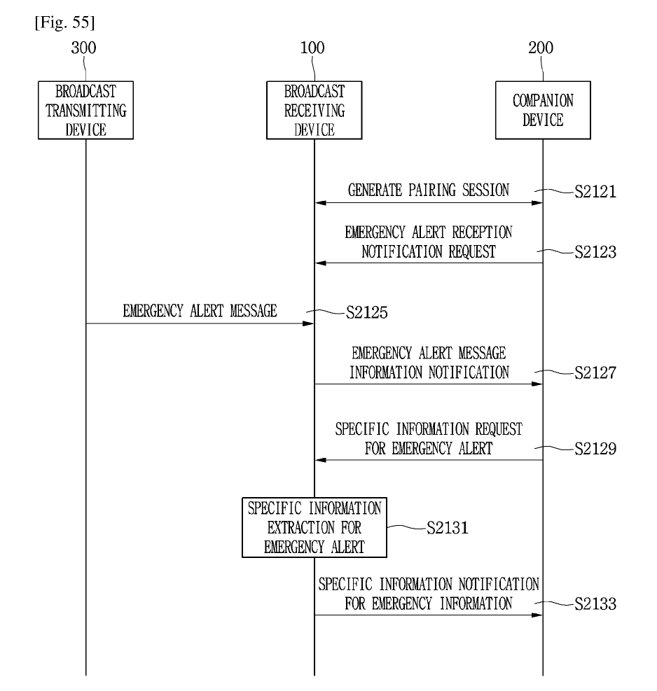

Additionally, according to another specific embodiment, the companion device 200 may assign points with different weights to information representing the urgency of an emergency alert, information representing the severity of a disaster causing an emergency alert, and information representing the certainty of a disaster causing an emergency alert. For example, as shown in FIG. 200, the companion device 200 may assign nine points when the Urgency element corresponds to Immediate, eight points when the Urgency element corresponds to Expected, seven points when the Urgency element corresponds to Future, five points when Urgency element corresponds to Past, and zero point when Urgency element corresponds to Unknown. Additionally, as shown in FIG. 54, the companion device 200 may assign five points when the Severity element corresponds to Extreme, four points when the Severity element corresponds to Severe, three points when the Severity element corresponds to Moderate, two points when Severity element corresponds to Minor, and zero point when Severity element corresponds to Unknown. Additionally, as shown in FIG. 54, the companion device 200 may assign six points when the Certainty element corresponds to Very likely, five points when the Certainty element corresponds to likely, four points when the Certainty element corresponds to Possible, three points when Certainty element corresponds to Unlikely, and zero point when Certainty element corresponds to Unknown. At this point, when the point sum is greater than 10 or less than 15, the companion device 200 determines that an emergency alert has the highest priority. Additionally, when the point sum is greater than 5 or less than 10, the companion device 200 determines that an emergency alert has a medium priority lower than the highest priority and higher than the lowest priority. Additionally, when the point sum is greater than 0 or less than 5, the companion device 200 determines that an emergency alert has the lowest priority.

The companion device 200 may display an emergency alert on the basis of the priority of an emergency alert. According to a specific embodiment, the companion device 200 may change at least one of an alarm sound according to an emergency alert, the duration of an alarm, the number of alarms, and an emergency alert display time on the basis of the priority of an emergency alert. For example, as the priority of an emergency alert is higher, the companion device 200 may allow an alarm sound to be higher. Additionally, as the priority of an emergency alert is higher, the companion device 200 may allow an alarm sound to be longer.

According to the embodiments described with reference to FIGS. 50 and 51, the broadcast reception device 100 needs to transmit all emergency alert message to the companion device 200. However, the companion device 200 may require only part of information of an emergency alert message. Accordingly, the broadcast reception device 200 requires an operating method thereof to transmit only part of information of an emergency alert message that the companion device 200 requires. This will be described in more detail with reference to FIGS. 54 and 55.

FIG. 54 is a view illustrating a parameter representing a state of an emergency alert that a broadcast reception device signals, an action for emergency alert, and an action argument according to another embodiment of the present invention.

The companion device 200 may designate specific information of emergency information that the companion device 200 wants to obtain while requesting information on an emergency alert from the broadcast reception device 100. Specific information of an emergency alert may be one or more information among a plurality of information included in an emergency alert message. At this point, the broadcast reception device 100 may transmit specific information on an emergency alert to the companion device 200. For this, the companion device 200 may use an action for requesting specific information on an emergency alert. At this point, the action may have a parameter for identifying specific information on an emergency alert as an input argument. According to a specific embodiment, a parameter that the companion device 200 wants to obtain specific information of an emergency alert may be EmergencyAlertField. According to a specific embodiment, EmergencyAlertField may be an essential parameter and may have a string data type. An action for requesting specific information on an emergency alert may be GetEmergencyAlerMessage. GetEmergencyAlerMessage is an essential parameter and may have EmergencyAlertField as an input argument. Specific operations of the broadcast reception device 100 and the companion device 200 will be described with reference to FIG. 55.

FIG. 55 is a ladder diagram illustrating operations when a broadcast reception device signals an emergency alert to a companion device according to another embodiment of the present invention.

The broadcast reception device 100 and the companion device 200 generate a pairing session in operation S2121. In more detail, the broadcast reception device 100 may generate a pairing session with the companion device 200 through an IP communication unit 130. In more detail, the companion device 200 may generate a pairing session with the broadcast reception device 100 through a communication unit. As described above, the broadcast reception device 100 and the companion device 200 may generate a pairing session for bidirectional communication. In more detail, operations of the broadcast reception device 100 and the companion device 200 may be identical to those in the embodiment of FIG. 50.

The companion device 200 requests an emergency alert reception notification from the broadcast reception device 100 in operation S2123. In more detail, the companion device 200 may request an emergency alert reception notification from the broadcast reception device 100 through a control unit. In more detail, operations of the companion device 200 may be identical to those in the embodiment of FIG. 50.

The broadcast reception device 100 receives an emergency alert message including an emergency alert on the basis of broadcast service in operation S2125. In more detail, the broadcast reception device 100 may receive an emergency alert message including an emergency alert from the broadcast transmission device 300 through the broadcast reception unit 110.

The broadcast reception device 100 notifies information on the emergency alert message to the companion device 200 on the basis of the emergency alert message in operation S2127. In more detail, the broadcast reception device 100 may notify information on the emergency alert message to the companion device 200 through the control unit 150 on the basis of the emergency alert message. Additionally, according to a specific embodiment, the broadcast reception device 100 may notify the companion device 200 of the information on the emergency alert message through a parameter representing the information on the emergency alert message. According to a specific embodiment, the broadcast reception device 100 may notify the companion device 200 of the information on the emergency alert message through a parameter representing the information on the emergency alert message. According to a specific embodiment, the parameter representing the emergency alert message may be EmergencyAlert of FIG. 49.

The companion device 200 requests specific information on the emergency alert from the broadcast reception device 100 in operation S2129. The companion device 200 may requests specific information on the emergency alert from the broadcast reception device 100 through a control unit. At this point, the specific information on the emergency alert may be information necessary for the companion device 200 to provide additionally information on the emergency alert. According to a specific embodiment, the companion device 200 may request from the broadcast reception device 100 at least one of an identifier for identifying an emergency alert, information representing the category of an emergency alert, information representing a description for an emergency alert, information representing a region corresponding to an emergency alert, information representing the urgency of an emergency alert, information representing the Severity of a disaster causing an emergency alert, and information representing the certainty of a disaster causing an emergency alert in the emergency alert message. For example, the companion device 200 may request from the broadcast reception device 100 at least one of identifier that is an element for identifying an emergency alert, category that is an element representing the category of an emergency alert, description that is an element representing a description for an emergency alert, areaDesc that is an element representing a region corresponding to an emergency alert, urgency that is an element representing the urgency of an emergency alert, severity that is an element representing the severity of a disaster causing an emergency alert, and certainty that is an element representing the certainty of a disaster causing an emergency alert in the emergency alert message. According to a specific embodiment, the companion device may request specific information on the emergency alert from the broadcast reception device 100 through the GetEmergencyAlertMessage action and EmergencyAlertField of FIG. 54.

The broadcast reception device 100 extracts specific information on the emergency alert on the basis of the emergency alert message in operation S2131. In more detail, the broadcast reception device 100 may extract the specific information on the emergency alert through the control unit 150 on the basis of the emergency alert message. In more detail, the broadcast reception device 100 may extract the specific information on the emergency alert from the emergency alert message through the control unit 150.

The broadcast reception device 100 notifies a specific property on the emergency alert to the companion device 200 in operation S2133. In more detail, the broadcast reception device 100 may notify the specific property on the emergency alert to the companion device 200 through the control unit 150. In more detail, the broadcast reception device 100 may notify the specific property on the emergency alert on the basis of a request of the companion device 200.

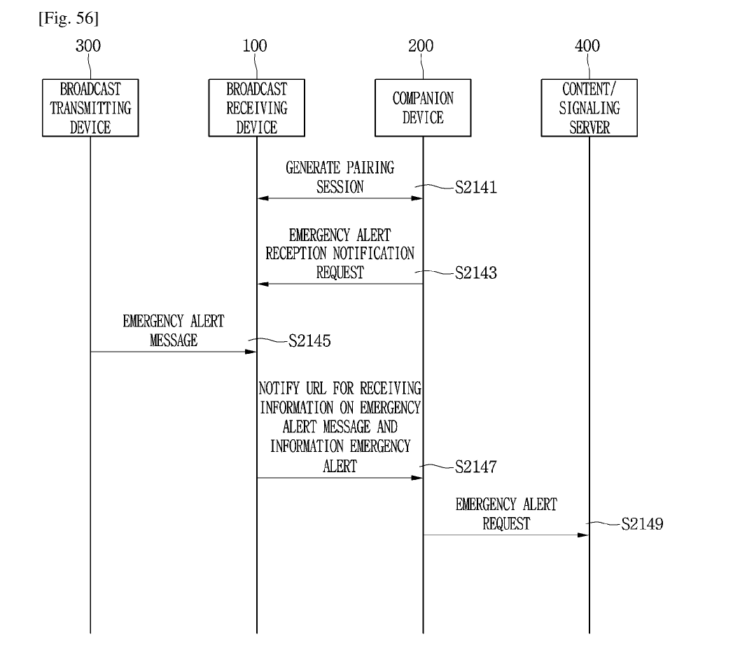

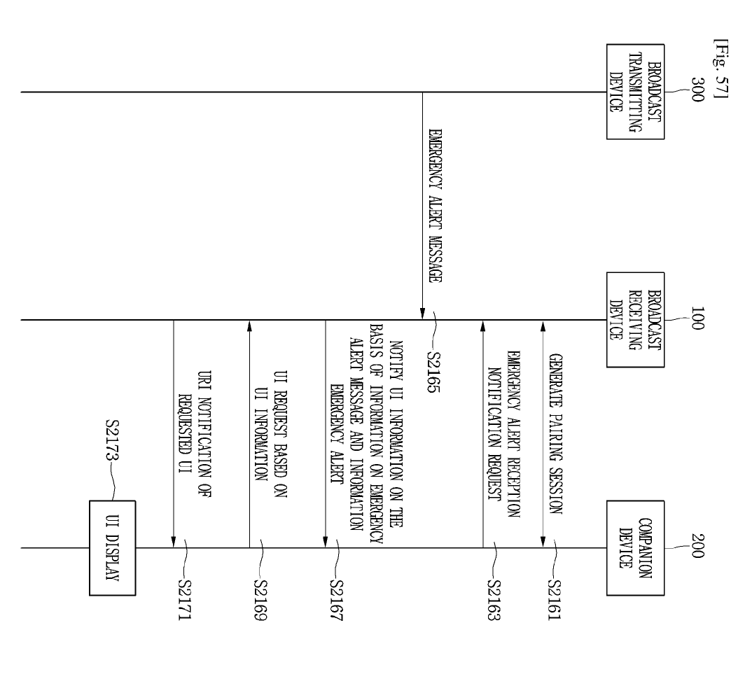

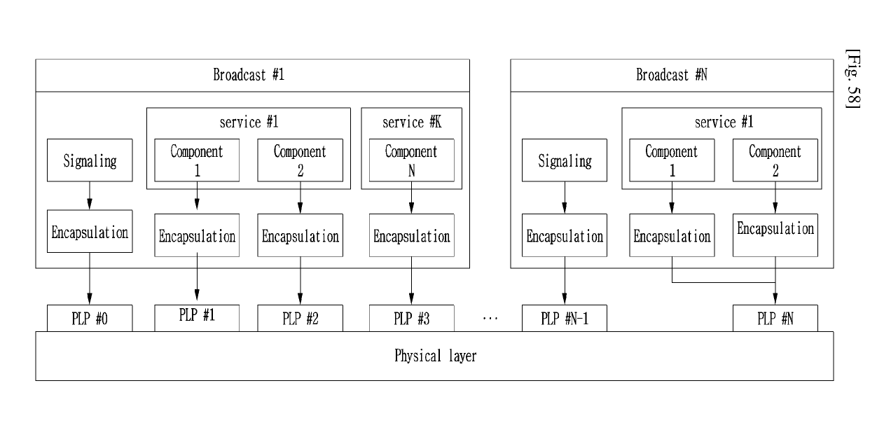

However, when the broadcast reception device 100 interoperates with a plurality of companion devices 200, as the broadcast reception device 100 directly transmits the specific information on the emergency alert necessary for the companion device 200, this may cause the overload to an operation of the broadcast reception device 100. Accordingly, a method of signaling an emergency alert to the companion device 200, which reduces the load of the broadcast reception device 100, may be required. This will be described with reference to FIG. 56.

FIG. 56 is a ladder diagram illustrating operations when a broadcast reception device signals an emergency alert to a companion device according to another embodiment of the present invention.

The broadcast reception device 100 and the companion device 200 generate a pairing session in operation S2141. In more detail, the broadcast reception device 100 may generate a pairing session with the companion device 200 through an IP communication unit 130. In more detail, the companion device 200 may generate a pairing session with the broadcast reception device 100 through a communication unit. As described above, the broadcast reception device 100 and the companion device 200 may generate a pairing session for bidirectional communication. In more detail, operations of the broadcast reception device 100 and the companion device 200 may be identical to those in the embodiment of FIG. 55.

The companion device 200 requests an emergency alert reception notification from the broadcast reception device 100 in operation S2143. In more detail, the companion device 200 may request an emergency alert reception notification from the broadcast reception device 100 through a control unit. In more detail, operations of the companion device 200 may be identical to those in the embodiment of FIG. 55.

The broadcast reception device 100 receives an emergency alert message including an emergency alert on the basis of broadcast service in operation S2145. In more detail, the broadcast reception device 100 may receive an emergency alert message including an emergency alert from the broadcast transmission device 300 through the broadcast reception unit 110.

The broadcast reception device 100 notifies a URL for obtaining information on an emergency alert message and information on an emergency alert to the companion device 200 on the basis of the emergency alert message in operation S2147. In more detail, the broadcast reception device 100 notifies a URL for obtaining information on an emergency alert message and information on an emergency alert to the companion device 200 through the control unit 150 on the basis of the emergency alert message.

The companion device 200 obtains information on an emergency alert on the basis of a URL for obtaining the information on the emergency alert. In more detail, the companion device 200 may obtain information on an emergency alert on the basis of a URL for obtaining the information on the emergency alert through a control unit. In more detail, the companion device 200 may obtain information on an emergency alert from the content/signaling server 400 on the basis of a URL for obtaining the information on the emergency alert. In more detail, the companion device 200 may request information on an emergency alert from the content/signaling server 400 on the basis of a URL for obtaining the information on the emergency alert and may then obtain the information on the emergency alert from the content/signaling server 400. Through this, the load of the broadcast communication device 100 resulting from a communication between the broadcast reception device 100 and the companion device 200 may be reduced.

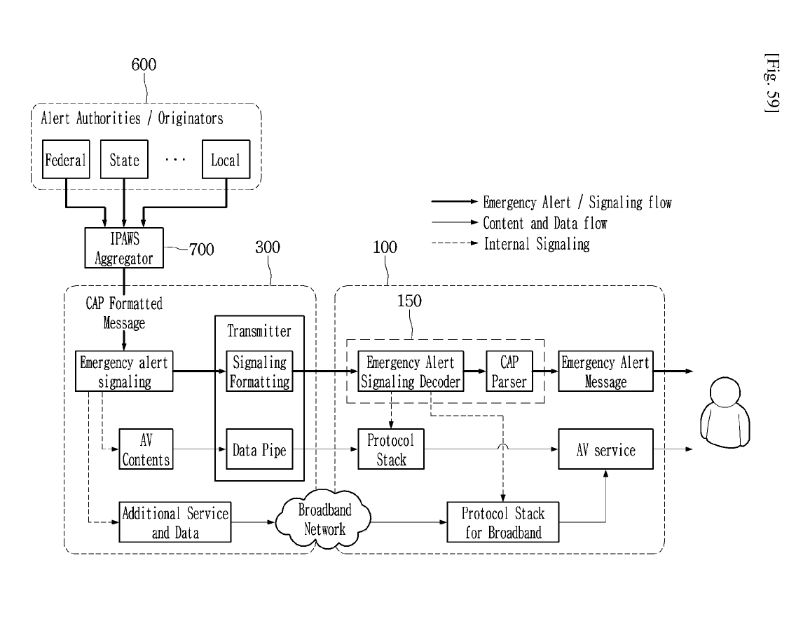

When the broadcast reception device 100 transmits a user interface (UI) representing an emergency alert to the companion device 200, the load for processing the emergency alert of the companion device 200 may be reduced. This will be described with reference to FIG. 57.

FIG. 57 is a ladder diagram illustrating operations when a broadcast reception device signals an emergency alert to a companion device according to another embodiment of the present invention.

The broadcast reception device 100 and the companion device 200 generate a pairing session in operation S2161. In more detail, the broadcast reception device 100 may generate a pairing session with the companion device 200 through an IP communication unit 130. In more detail, the companion device 200 may generate a pairing session with the broadcast reception device 100 through a communication unit. As described above, the broadcast reception device 100 and the companion device 200 may generate a pairing session for bidirectional communication. In more detail, operations of the broadcast reception device 100 and the companion device 200 may be identical to those in the embodiment of FIG. 56.

The companion device 200 requests an emergency alert reception notification from the broadcast reception device 100 in operation S2163. In more detail, the companion device 200 may request an emergency alert reception notification from the broadcast reception device 100 through a control unit. In more detail, operations of the companion device 200 may be identical to those in the embodiment of FIG. 56.

The broadcast reception device 100 receives an emergency alert message including an emergency alert on the basis of broadcast service in operation S2165. In more detail, the broadcast reception device 100 may receive an emergency alert message including an emergency alert from the broadcast transmission device 300 through the broadcast reception unit 110.

The broadcast reception device 100 notifies information on an emergency alert message and UI information on an emergency alert to the companion device 200 on the basis of the emergency alert message in operation S2167. In more detail, the broadcast reception device 100 notifies the information on the emergency alert message and the UI information on the emergency alert to the companion device 200 through the control unit 150 on the basis of the emergency alert message. At this point, the UI information on the emergency alert may include a list of UIs representing the emergency alert.

The companion device 200 requests a UI for emergency alert from the broadcast reception device 100 on the basis of the UI information on the emergency alert in operation S2169. In more detail, the companion device 200 may request a UI for emergency alert from the broadcast reception device 100 through a control unit on the basis of the UI information on the emergency alert.

The broadcast reception device 100 transmits a URI for obtaining the UI for emergency alert to the companion device 200 on the basis of a request of the companion device 200 in operation S2171. The broadcast reception device 100 may transmit a UI for obtaining the UI for emergency alert through the control unit 150 on the basis of a request of the companion device 200.

The companion device 200 displays the UI for emergency alert on the basis of a URI for obtaining the UI for emergency alert in operation S2173. The companion device 200 may display a UI for emergency alert on the basis of a URI for obtaining the UI for emergency alert. In more detail, the companion device 200 may obtain a UI on the basis of a URI for obtaining the UI for emergency alert. At this point, the companion device 200 may obtain the UI for emergency information from an external server. For example, the companion device 200 may receive at least one of image files, HTML files, and XML files for the UI for emergency information. At this point the external server may be the content/signaling server 400. According to another specific embodiment, the companion device 200 may store a UI for emergency alert in advance and may call a UI corresponding to URI among stored UIs. Additionally, the companion device 200 may display the UI for emergency obtained through such an operation. Since the companion device 200 processes an emergency alert through such an operation, the load of the companion device 200 may be reduced.

FIG. 58 is a view illustrating a transport layer of broadcast service according to an embodiment of the present invention.

A broadcast transmission device 300 may transport broadcast service through broadcast signal comprising a plurality of layers. Transport layer, which is one of a plurality of layers for transmitting a broadcast signal and is for transmitting/receiving a broadcast signal through a physical medium, may be physical layer. At this point, physical layer may be at least one of cooper and optical fiber.

A broadcast transmission device 300 may transport broadcast service and broadcast service related data through at least one physical layer pipe (PLP) on one frequency or a plurality of frequencies. At this point, the PLP is a series of logical data delivery paths identifiable on a physical layer. The PLP may be also referred to as a data pipe. One broadcast service may include a plurality of components. At this point, each of the plurality of components may be one of audio, video, and data components. Each broadcasting station may transmit encapsulated broadcast service by using a broadcast transmission device through one PLP or a plurality of PLPs. In more detail, a broadcasting station may transmit a plurality of components included in one service to a plurality of PLPs through a broadcast transmission device. Additionally, a broadcasting station may transmit a plurality of components included in one service to one PLP through a broadcast transmission device. For example, according to the embodiment of FIG. 58, a first broadcasting station Broadcast #1 may transmit signaling information by using a broadcast transmission device through one PLP PLP#0. Additionally, according to the embodiment of FIG. 58, the first broadcasting station Broadcast #1 may transmit a first component Component 1 and a second component Component 2 included in a first broadcast service by using a broadcast transmission device through a different first PLP PLP #1 and second PLP PLP #2. Additionally, according to the embodiment of FIG. 58, the Nth broadcasting station Broadcast #N may transmit a first component Component 1 and a second component Component 2 included in a first broadcast service Service #1 through an Nth PLP PLP #N. At this point, realtime broadcast service may be encapsulated into one of the user datagram protocol (UDP) and a protocol for realtime contents transmission, for example, the realtime transport protocol (RTP). In the case of non-realtime contents and non-realtime data, realtime broadcast service may be encapsulated into a packet of at least one of IP, UDP, and a contents transmission protocol, for example, FLUTE. Therefore, a plurality of PLPs delivering a least one component may be included in a transport frame that a broadcast transmission device transmits. Accordingly, the broadcast reception device 100 may need to check all of a plurality of PLPs to perform a broadcast service scan for obtaining broadcast service connection information. Therefore, a broadcast transmission method and a broadcast reception method of the broadcast reception device 100 to perform a broadcast service scan are required.

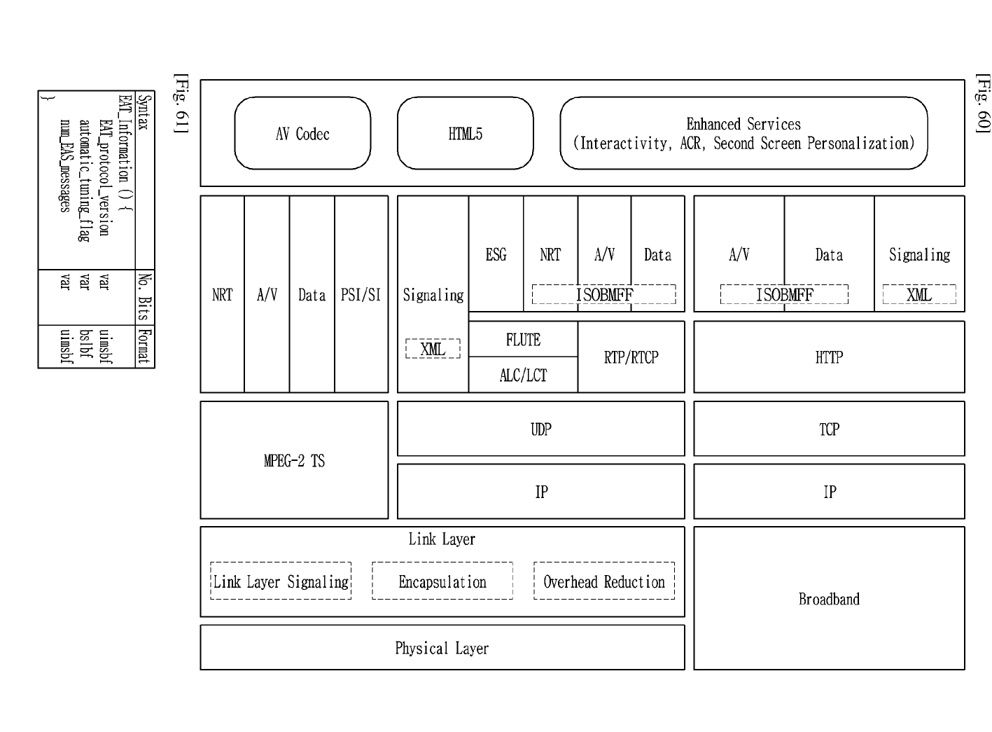

FIG. 59 is a block diagram illustrating an entire configuration of an emergency alert system according to an embodiment of the present invention.

As shown in FIG. 59, an emergency alert system according to an embodiment of the present invention may include alert authorities 600, a broadcast transmission device 300 (for example, a broadcaster), the broadcast reception device 100, and an information collection device 700.

The alert authorities 600 may include agencies concerned in countries or corresponding areas. When emergency alert information needs to be transmitted through a broadcast network, the alert authorities 600 generate an emergency alert and deliver it to the information collection device 700 (or an agency). At this point, the information collection device 700 may be an Integrated Public Alert Warning System (IPAWS) aggregator.

The information collection device 700 may configure emergency alert information to be delivered through a broadcast network, with a common alerting protocol (CAP) based message and may then deliver it to the broadcast transmission device 300. Herein, the CAP may be in XML file for warning an emergency situation and exchanging information. The CAP may propagate a warning message through a plurality of emergency alert systems simultaneously. Hereinafter, according to an embodiment of the present invention, a process after a CAP message is delivered to the broadcast transmission device 300 will be described mainly.

When the CAP message is delivered to the broadcast transmission device 300, the broadcast transmission device 300 that processes a corresponding message may transmit related audio/video content and additional service together with the CAP message. In more detail, the broadcast transmission device 300 inserts related audio/vide content or additional service together with a CAP message into a broadcast signal and transmits it to the broadcast reception device 100. In an embodiment, emergency alert related data including the CAP message may be transmitted through another path according to each purpose and format. In a specific example, the other path may be one of a signaling channel, a data pipe, and a broadband.

The broadcast reception device 100 receives a broadcast signal including emergency alert related data from the broadcast transmission device 300. Then, the broadcast reception device 100 decodes the received broadcast signal through an emergency alert signaling decoder. At this point, the emergency alert signaling decoder may be the signaling decoder 151 of FIG. 30.

The broadcast reception device 100 receives audio/video service according to information obtained by decoding a broadcast signal. In more detail, the broadcast reception device 100 may obtain a physical layer pipe information transmitting audio/video service from a broadcast signal. At this point, the physical layer pipe may be a data which is included a physical layer frame. Then, the broadcast reception device 100 may receive audio/video service data relating to an emergency alert message through a physical layer pipe.

Additionally, the broadcast reception device 100 may extract NRT service information relating to an emergency alert from the information obtained by decoding a broadcast signal. In more detail, the NRT service information may be address information through which NRT service is obtained. For example, NRT service is delivered through a broadband and address information may be URI information for obtaining NRT service.

FIG. 60 is a view illustrating a protocol stock for supporting a broadcast service according to an embodiment of the present invention.

A broadcast service according to an embodiment of the present invention may provide additional service such as HTML5 application, interactive service, ACR service, second screen service, and personalization service in addition to Audio/Video (A/V).

Such a broadcast service may be transmitted through a physical layer that is a broadcast signal of terrestrial wave or a cable satellite. Additionally, a broadcast service according to an embodiment of the present invention may be transmitted through an internet communication network (for example, broadband).

When broadcast service is transmitted through a physical layer that is a broadcast signal of terrestrial wave or a cable satellite, the broadcast reception device 100 may extract an encapsulated MPEG-2 transport stream (TS) and an encapsulated IP datagram by demodulating a broadcast signal. The broadcast reception device 100 may extract a User Datagram Protocol, (UDP) datagram from an IP datagram. The broadcast reception device 100 may extract signaling information from the UDP datagram. At this point, the signaling information may be in XML format. Additionally, the broadcast reception device 100 may extract an Asynchronous Layered Coding/Layered Coding Transport (ALC/LCT) packet from the UDP datagram. The broadcast reception device 100 may extract a File Delivery over Unidirectional Transport (FLUTE) packet from the ALC/LCT packet. At this point, the FLUTE packet may include Real-Time audio/video/subtitle data, Non-Real Time (NRT) data, and Electronic Service Guide (ESG) data. Additionally, the broadcast reception device 100 may extract a Real-time Transport Protocol (RTCP) packet and a RTP Control Protocol (RTCP) packet from the UDP datagram. The broadcast reception device 100 may extract A/V data and additional data from a real-time transport packet such as a RTP/RTCP packet. At this point, at least one of NRT data, A/V data, and additional data may be in ISO Base Media File Format (ISO BMFF). Additionally, the broadcast reception device 100 may extract signaling information such as NRT data. A/V, and PSI/PSIP from an MPEG-2 TS packet or an IP packet. At this point, the signaling information may be in XML or binary format.

When broadcast service is transmitted through an internet communication network (for example, broadband), the broadcast reception device 100 may receive an IP packet from the internet communication network. The broadcast reception device 100 may extract a TCP packet from an IP packet. The broadcast reception device 100 may extract an HTTP packet from a TCP packet. The broadcast reception device 100 may extract A/V, additional data, and signaling information from an HTTP packet. At this point, at least one of A/V and additional data may be in ISO BMFF. Additionally, the signaling information may be in XML format.

The broadcast transmission device 300 according to an embodiment of the present invention may transmit an emergency alert message through a protocol layer included in a protocol stack. In this case, a corresponding protocol layer may be a link layer. According to an embodiment, the broadcast transmission device 300 may format an emergency alert message in table format according to a transport protocol. At this point, an emergency alert message may be formatted in table format in a link layer included in a protocol stack. Additionally, the emergency alert message may include information for signaling a link layer and a link layer operation.

According to another embodiment, the broadcast transmission device 300 may packetize an emergency alert message according to a transport protocol. In more detail, the broadcast transmission device 300 may encapsulate an emergency alert message in a transmission packet. In this case, emergency alert information may be prevented from being signaled to the broadcast reception device 100 through a plurality of layers.

An emergency alert message needs to be configured with a format transmittable in a broadcast system in order for transmission. For example, according to an embodiment, a section table for transmission of an emergency alert message may be used in general. According to another embodiment, an emergency alert message may be transmitted, as part of another section table, with a configuration of a descriptor format. According to another embodiment, an emergency alert message may be transmitted as a packet of a physical layer. In more detail, an emergency alert message may be transmitted in a packet format through a PLP. In this case, an emergency alert message may be included in a packet payload in a packet and then may be transmitted. Information for identifying a packet including an emergency alert message is included a packet header. Additionally, Information for identifying a packet including an emergency alert message is included a extended header. At this point, extended header may be an additional field included in a packet header.

FIG. 61 is a view illustrating a syntax for an Emergency Alert Table (EAT). At this point, an EAT may be in one format of an emergency alert message. As shown in FIG. 61, EAT information may include version information of a protocol that the EAT has. According to a specific embodiment, corresponding information may be an EAT_protocol_version field.

Additionally, the EAT information may include information for notifying whether to perform switching of a channel automatically to the broadcast reception device 100. For example, the EAT information may include information for notifying whether to perform switching of a channel automatically to the broadcast reception device 100 through a channel for notifying detailed information on an emergency alert. According to a specific embodiment, information for notifying whether to perform switching of a channel automatically may be an automatic_tuning_flag field.

Additionally, the EAT information may include information on the number of messages included in an EAT. According to a specific embodiment, message count information may be a num_EAS_message field.

FIG. 62 is a view illustrating a syntax for emergency alert message. An emergency alert message according to an embodiment of the present invention may directly include a CAP message. According to another embodiment, an emergency alert message may include information on a path through which a CAP message is delivered.

As shown in FIG. 62, an emergency alert message according to an embodiment of the present invention may include identifier information for identifying an EAS message. According to a specific embodiment, identifier information may be an EAS_message_id field. In this case, the EAS_message_id field may be 32 bits.

Additionally, a syntax for emergency alert message may include information representing the version of IP. In this case, the version information may be an EAS_IP_version_flag field. According to a specific embodiment, when a value of the EAS_IP_version_flag field is 0, this represents that an IP version is IPv4. According to another embodiment, when a value of the EAS_IP_version_flag field is 1, this represents that an IP version is IPv6. The EAS_IP_version_flag field may be 1 bit.

Additionally, the emergency alert message may include information representing a transfer type of an EAS message. In this case, the EAS message transfer type may be an EAS_message_transfer_type field. The EAS_message_transfer_type field may be 3 bits.

According to a specific embodiment, the EAS_message_transfer_type field may represent that the transfer type of an EAS message is not specified. In this case, the EAS_message_transfer_type field may have a value of 000(2).

According to another embodiment, the EAS_message_transfer_type field may represent that the transfer type of an EAS message is a type that does not include an alert message. That is, an EAT transmitted through a broadcast signal may represent that it includes only information on audio/video contents without an alert message. In this case, the EAS_message_transfer_type field may have a value of 001(2).

According to another embodiment, the EAS_message_transfer_type field may represent that an EAS message is included in an EAT and transferred. In this case, the EAS_message_transfer_type field may have a value of 010(2).

Furthermore, when the EAS_message_transfer_type field has a value of 010(2), a table including an EAS message may represent the length of an EAS message. In this case, information representing the length of an EAS message may be an EAS_message_length field. The EAS_message_length field may be 12 bits. Additionally, when the EAS_message_transfer_type field has a value of 010(2), a table including an EAS message may additionally include information on an EAS message.

According to another embodiment, the EAS_message_transfer_type field may represent that an EAS message is transferred in an IP datagram format through a data pipe. In this case, the EAS_message_transfer_type field may have a value of 011(2). Furthermore, when the EAS_message_transfer_type field has a value of 011(2), a table including an emergency alert message may additionally include at least one of IP address information for obtaining an IP datagram, UDP port information, and information on a transferred physical layer frame.

Additionally, an emergency alert message may include information representing the encoding type of an EAS message. In this case, information on the encoding type of an EAS message may be an EAS_message_encoding_type field. The EAS_message_encoding_type field may be 3 bits.

According to a specific embodiment, the EAS_message_encoding_type field may represent that the encoding type of an EAS message is not specified. In this case, the EAS_message_encoding_type field may have a value of 000(2).

According to another embodiment, the EAS_message_encoding_type field may represent that an EAS message is not encoded. In this case, the EAS_message_encoding_type field may have a value of 001(2).

According to another embodiment, the EAS_message_encoding_type field may represent that an EAS message is encoded by a DEFLATE algorithm. The DEFLATE algorithm is a lossless compression data format. In this case, the EAS_message_encoding_type field may have a value of 010(2).

Additionally, an emergency alert message may represent whether information on NRT content relating to a received EAS message and additional data is included in an emergency alert table. In this case, information representing whether NRT content and additional content exist may be an EAS_NRT_flag field. The EAS_NRT_flag field may be 1 bit.

In a specific embodiment, when the EAS_NRT_flag field is set to 0, this represents that NRT content information relating to the received EAS message is not included in an emergency alert table. In another embodiment, when the EAS_NRT_flag field is set to 1, this represents that NRT content information relating to the received EAS message is included in an emergency alert table.

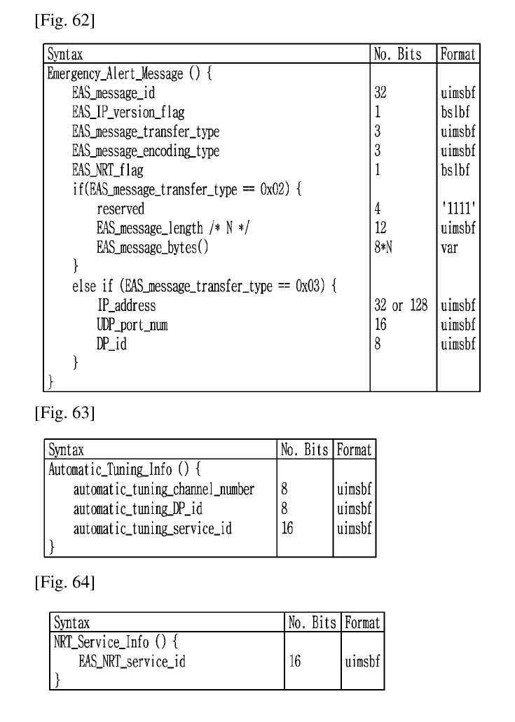

FIG. 63 is a view illustrating a syntax for automatic channel tuning information. When related audio/video content is transmitted simultaneously with an emergency alert message, the automatic channel tuning information includes information for automatically tuning to a channel thorough which related audio/video content is transmitted. That is, when a channel displayed on the current broadcast reception device 100 does not include content including an emergency alert message, automatic channel tuning information is information for automatically tuning to a channel through which related audio/video content is transmitted. In a specific embodiment, when the automatic_tuning_flag field of FIG. 61 is enabled, an emergency alert table includes automatic channel tuning information. For example, when the automatic_tuning_flag field is 1, an emergency alert table includes automatic channel tuning information.

In an embodiment, a table for automatic channel tuning information may represent information on a channel number for channel tuning. In more detail, it may represent information on a channel including content relating to emergency alert information. In this case, tuning channel number information may be an automatic_tuning_channel_number field. According to a specific embodiment, the automatic_tuning_channel_number field may be 8 bits.

In another embodiment, a table for automatic channel tuning information may represent path information for receiving content relating to an emergency alert message. In more detail, a table for automatic channel tuning information may represent information for identifying a physical layer frame including audio/video content relating to an emergency alert message. In this case, corresponding information may be an automatic_tuning_DP_id field. The automatic_tuning_DP_id field may be 8 bits.

In another embodiment, a table for automatic channel tuning information may represent identification information on content relating to an emergency alert message. In more detail, it may represent service ID information on content relating to an emergency alert message. In this case, corresponding information may be an automatic_tuning_service_id field. The automatic_tuning_service_id field may be 16 bits.

FIG. 64 is a view illustrating a syntax for NRT service information. Herein, the NRT service information includes information for obtaining NRT data relating to an emergency alert message. When the EAS_NRT_flag field of FIG. 62 is enabled, the NRT service information may be included in an EAT. For example, when the EAS_NRT_flag field has a value of 1, the NRT service information may be included in an EAT.

When NRT content and data relating to an emergency alert message are transmitted to the broadcast reception device 100, the NRT service information includes identifier information on a corresponding NRT service. At this point, the identifier information on NRT service may be an EAS_NRT_service_id field. The EAS_NRT_service_id field may be 16 bits.

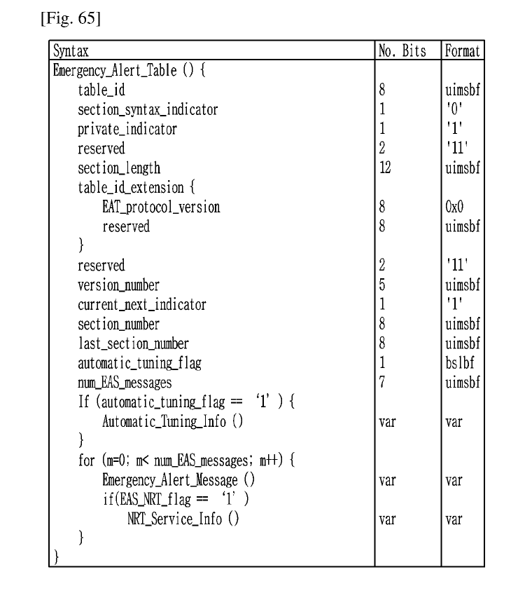

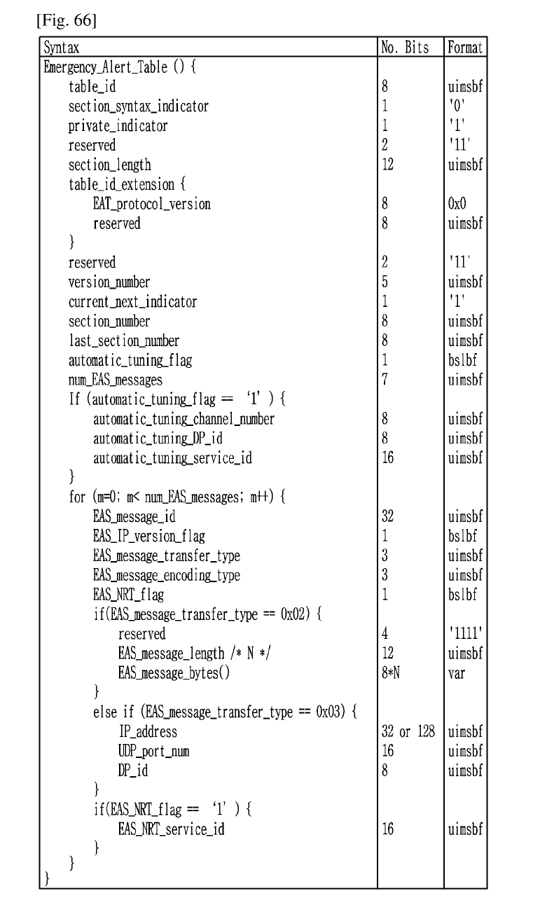

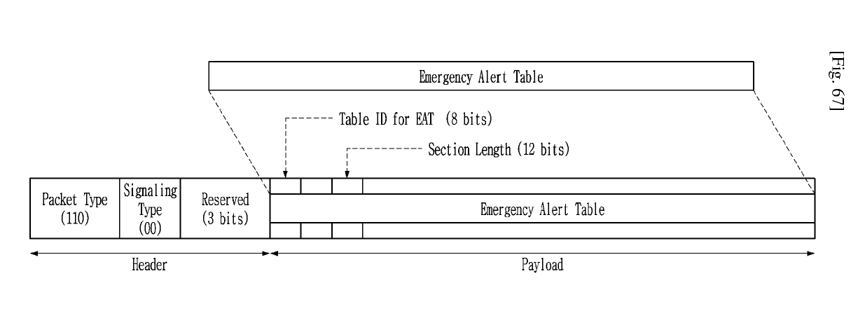

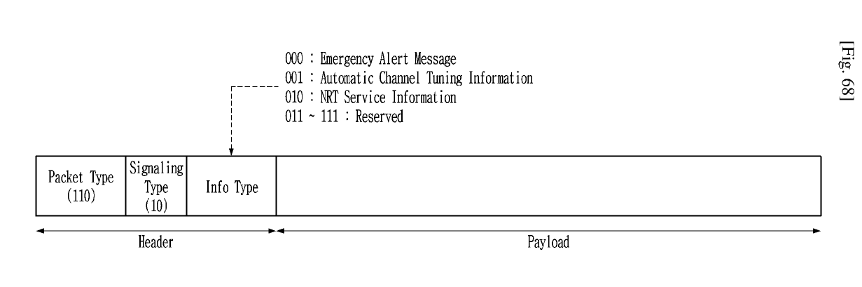

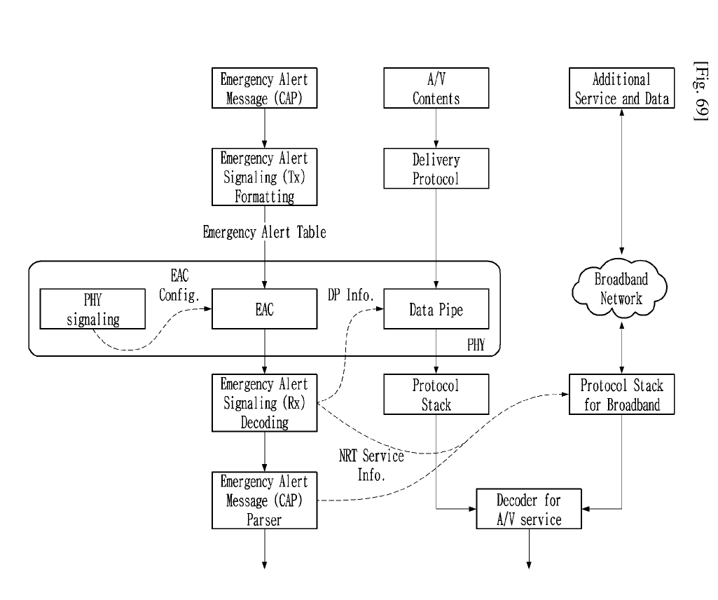

FIGS. 65 and 66 are views illustrating a section table for transmitting an emergency alert message according to an embodiment of the present invention. Some field in a configuration of a section table shown in FIG. 65 may use a field used in existing ATSC M/H standards for compatibility with a broadcast system as it is or may added additional field in order for the transmission of an emergency alert message. Additionally, when added some fields are applied to an actual broadcast system, the number of bits that a field has and the order of fields may be adjustable through an optimization process.

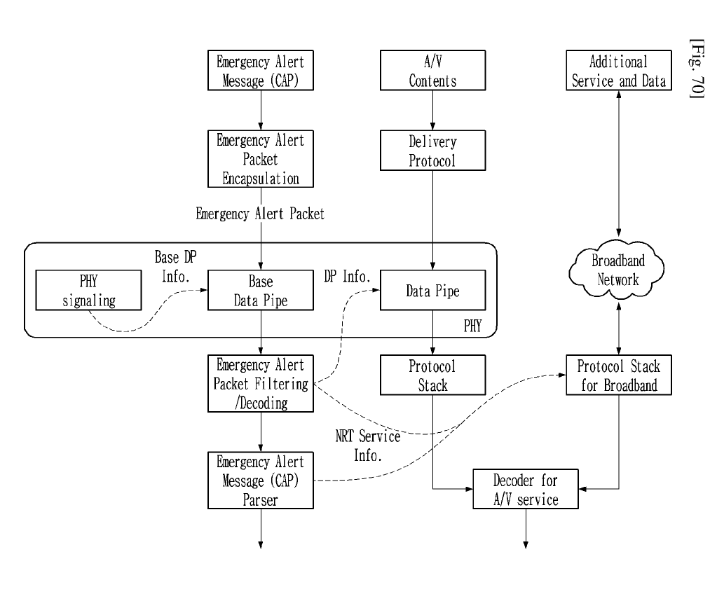

FIGS. 67 and 68 are views of transmitting an emergency alert table in a packet format through a physical layer pipe according to an embodiment of the present invention.

In general, a broadcast packet includes a packet payload into which data to be transmitted through a corresponding packet is inserted and a packet header into which information for signaling the packet payload is inserted. Therefore, according to an embodiment of the present invention, a broadcast transmission device may insert an emergency alert message to be transmitted into the payload of a packet and may insert information for signaling the emergency alert message into the header of the packet.

FIG. 67 is a view illustrating the payload of a packet without modifying the format of an emergency alert table according to an embodiment of the present invention. As shown in FIG. 67, an emergency alert table is included in the packet payload as it is and additionally, an identifier for the emergency alert table and length information on the emergency alert table.

Additionally, the packet header may include information representing the type of a packet. According to an embodiment, the packet type information may represent that the payload of a packet includes data for emergency alert signaling. In a specific embodiment, the information representing a packet type may be 110(2).

Additionally, the packet header may include information representing the type of signaling data included in the payload of packet. In one embodiment, the signaling data type information may represent that corresponding signaling data is in a section table format. In a specific embodiment, when the signaling data type information has a value of 00(2), it may represent that corresponding signaling data is in a section table format.

FIG. 68 is a view illustrating an emergency alert message inserted as individual information instead of a section table format. At this point, the section table refers to an intermediate format for configuring a final table. In more detail, the broadcast reception device 100 may collect packets to configure a section table and also may collect section tables again to configure a final table. Accordingly, the embodiment of FIG. 68 represents packetizing each field included in an emergency alert message into an additional packet. Accordingly, the broadcast reception device 100 may obtain completed information from one packet without collecting at least one packet to configure a section table. For example, this may be the case that one packet payload includes only EAT protocol version information or only automatic channel tuning information.

In this case, information representing a packet type may represent that the payload of a packet includes data for emergency alert signaling. In this case, the information representing a packet type may be set to 110(2). Additionally, the information representing a signaling type may represent that data included in a packet payload is in an individual information format. In this case, the information representing a signaling type may be set to 10(2).

Additionally, unlike FIG. 67, since data for an emergency alert included in a packet payload varies, a packet header may additionally include information for identifying this. The corresponding information may be a Info Type field.

In a specific embodiment, when the Info Type field has a value of 000(2), data for an emergency alert included in a packet payload may be an emergency alert message. In another embodiment, when the Info Type field has a value of 001(2), data for an emergency alert included in a packet payload may be automatic channel tuning information. In another embodiment, when the Info Type field has a value of 010(2), data for an emergency alert included in a packet payload may be NRT service information.

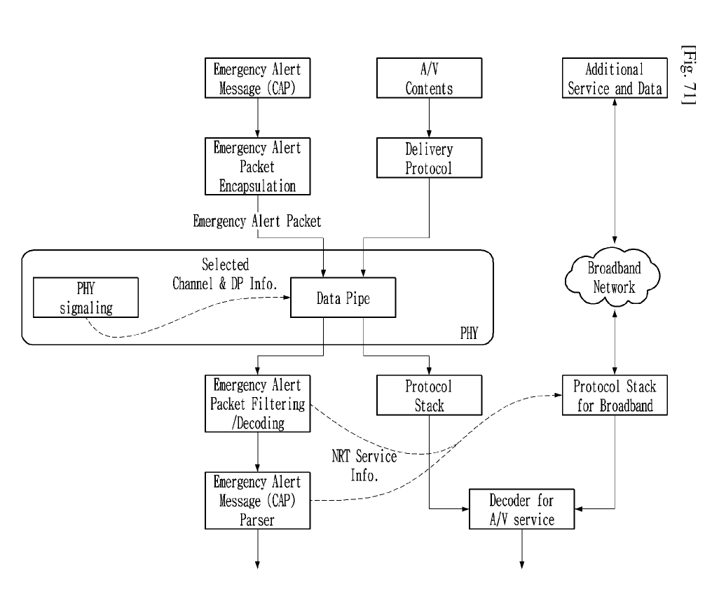

Hereinafter, FIGS. 69 to 75 illustrate views of transmitting an Emergency Alert Table (EAT) according to various embodiments of the present invention. In a specific embodiment, a PLP for transmitting an EAT may vary according to an embodiment. This will be described with reference to FIGS. 69 to 75. When the broadcast transmission device 300 transmits emergency alert information through a physical layer pipe, a broadcast reception device 100 extracts the emergency alert information from physical layer directly. As a result, the broadcast reception device 100 obtains emergency alert information promptly.

FIG. 69 is a view when the broadcast transmission device 300 transmits emergency alert message through a dedicated PLP according to an embodiment of the present invention. emergency alert message through a dedicated PLP includes at least one of an EAT and an transmission packet.

According to an embodiment, the broadcast transmission device 300 may transmit an EAT through a dedicated PLP. At this point, a PLP dedicated for transmitting an EAT may be referred to as an Emergency Alert Channel (EAC). That is, the EAC may be a dedicated PLP for transmitting only an emergency message. Herein, the PLP may be a unit of data transmitted through a physical layer frame. The physical layer may include at least one physical layer frame and a physical layer pipe may be transmitted through the physical layer frame. Hereinafter, this embodiment will be described in more detail with reference to FIG. 69.

The broadcast transmission device 300 generates an EAT on the basis of emergency information collected from the alert authorities 600. Herein, the emergency alert information received by the broadcast transmission device 300 may be a CAP message received from an information collection device 700.

Herein, a dedicated PLP, as mentioned above, may be an EAC for transmitting only an EAT or a transmission packet including the EAT. The broadcast transmission device 300 generates a broadcast signal, including the generated EAT. In more detail, a broadcast signal may include a transmission packet including an EAT or a transmission packet including the EAT. Then, the broadcast transmission device 300 transmits a broadcast signal including an EAC. In more detail, the broadcast transmission device 300 may transmit a broadcast signal through a dedicated PLP for only a transmission packet including an EAT.

The broadcast reception device 100 receives the broadcast signal through the designated PLP. As described above, a PLP may be a dedicated physical layer pipe for transmitting only emergency alert information in a physical layer. Dedicated physical layer pipe may be emergency alert channel. The broadcast reception device 100 may extract an EAT from a physical layer pipe. Additionally, the broadcast reception device 100 may obtain from a physical layer, information on whether a physical layer includes an EAC. At this point, information representing whether a physical layer delivering a physical layer frame includes an EAC may be referred to as PHY signaling. The broadcast reception device 100 may determine a data pipe transmitting emergency alert information on the basis of the PHY signaling.

The broadcast reception device 100 decodes the physical layer pipe including an EAT. The physical layer pipe may be decoded through the signaling decoder 151 of FIG. 30. At this point, the broadcast reception device 100 may obtain a CAP message, related content information, and related NRT service information through a physical layer pipe.

The broadcast reception device 100 may parse the obtained CAP message to obtain emergency alert information. In a specific embodiment, a CAP parser may parse the CAP message. The CAP parser may be an alert signaling parser 168 shown in FIG. 30.

In this case, the broadcast reception device 100 may obtain related NRT service information together with emergency alert information. If there is overlapping information in the EAT and CAP messages, the broadcast transmission device 300 may adjust this while configuring an EAT.

The broadcast reception device 100 may receive audio/video content on the basis of obtained related content information. In more detail, the obtained related content information may be information for identifying a PLP that transmits audio/video content. Furthermore, the obtained related content information may be information for identifying audio/video content.

The broadcast reception device 100 identifies a PLP including related content on the basis of related content information. Then, the broadcast reception device 100 obtains audio/video content by decoding the identified PLP. At this point, a PLP for transmitting related content may be distinguished from a PLP for transmitting emergency alert information. Additionally, the broadcast reception device 100 may obtain an NRT service relating to emergency alert information on the basis of the obtained NRT service information. In more detail, the broadcast reception device 100 may obtain address information for obtaining NRT service from the NRT service information. At this point, the broadcast reception device 100 may receive NRT service through broadband.

The broadcast reception device 100 provides the obtained emergency alert message together with audio/video content. If information on automatic channel tuning is transmitted, the broadcast reception device 100 may provide an emergency alert message as changing a channel automatically.

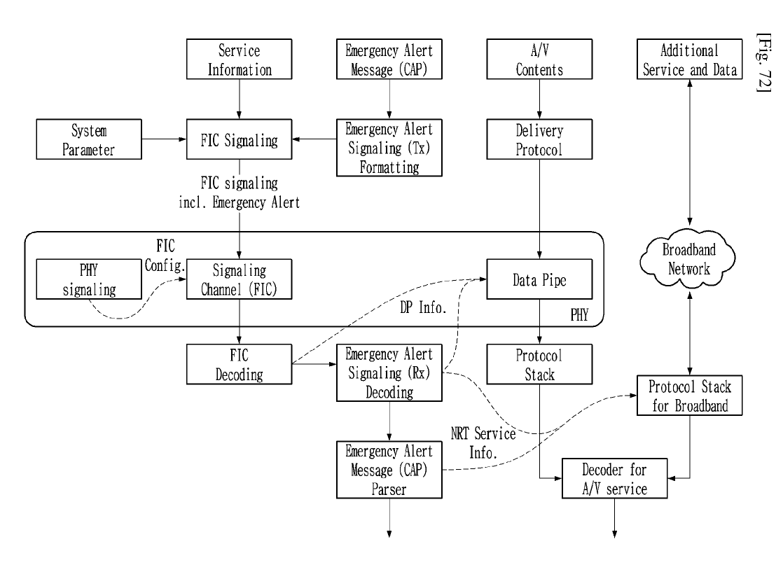

FIGS. 70 and 71 are views when the broadcast transmission device 300 encapsulates an ET in a packet and transmits the packet according to an embodiment of the present invention. A packet including an ET may be referred to as an emergency alert packet.

In an embodiment, a PLP included in a physical layer of a broadcast signal may exist in plurality. Additionally, there may be an additional PLP for transmitting specific information on a plurality of broadcast services transmitted through a plurality of PLPs included in a physical layer of a broadcast signal. At this point, an additional PLP for transmitting broadcast service information may be referred to as a basic data pipe. In more detail, the broadcast transmission device 300 may transmit signaling information on a broadcast service or common data applied to a plurality of broadcast services through a basic data pipe. Herein, the signaling information or the common data may be information for signaling a physical layer pipe transmitted through a physical layer or data commonly applied to a physical layer pipe. FIG. 70 is a view when the broadcast transmission device 300 transmits an EAT through a basic data pipe according to an embodiment of the present invention.

The broadcast transmission device 300 generates a packet to be transmitted through a physical layer by encapsulating emergency information collected from the alert authorities 600. At this pint, the emergency alert information encapsulated packet may be referred to as an emergency alert packet. Herein, the emergency alert information received by the broadcast transmission device 300 may be a CAP message received from an information collection device 700.

In an embodiment, the emergency alert packet may include a packet header and a packet payload. In a specific embodiment, the packet payload may include an EAT as it is. In a specific embodiment, the packet payload may include some information in an EAT. Herein, the some information may be information of which importance is high in the EAT.

Additionally, the packet header may include information representing the data included in the packet payload is emergency alert information. Additionally, the packet header may represent that a transmission packet includes emergency alert information. In more detail, the packet header may represent that a transmission packet includes emergency alert information, by including different type information than a general packet. That is, the packet header may represent that a transmission packet is an emergency alert packet.

The broadcast transmission device 300 transmits an EAT encapsulated packet through a PLP for transmitting signaling information on broadcast service or common data. That is, the broadcast transmission device 300 transmits an emergency alert packet through a basic data pipe. In this case, the basic data pipe, as one format of a PLP, may be distinguished from another PLP (or a data pipe).

On the other hand, a physical layer including a basic data pipe may transmit information for signaling that a basic data pipe exists in the physical layer. At this point, the information for signaling that a basic data pipe exists may be referred to as PHY signaling. The broadcast reception device 100 may determine that a data pipe exists in a physical layer of a broadcast signal on the basis of the PHY signaling. Then, the broadcast reception device 100 may obtain emergency alert information through a basic data pipe that is one format of a PLP. At this point, the obtained emergency alert information may be in a format of an emergency alert packet. The broadcast reception device 100 receives the broadcast signal through the basic data pipe. That is, the broadcast reception device 100 receives an emergency alert packet through a basic data pipe.

The broadcast reception device 100 may extract a physical layer pipe including an emergency alert packet from the received broadcast signal. At this point, physical layer pipe included in a emergency alert packet may be base data pipe. Then, the broadcast reception device 100 may obtain emergency alert information by decoding the extracted physical layer pipe. In more detail, the emergency alert information may be obtained by decoding an emergency alert packet included in a physical layer pipe.

At this point, the emergency alert packet may include a packet payload having an EAT inserted and a packet header signaling the packet payload. In a specific embodiment, the broadcast reception device 100 may determine whether a corresponding packet includes emergency alert information from the packet header. That is, the broadcast reception device 100 may determine whether a corresponding packet is an emergency alert packet on the basis of information extracted from a packet header.

Additionally, the broadcast reception device 100 may determine the type of emergency alert information included in a packet payload from a packet header. For example, a determination may be made on whether a packet payload includes an entire EAT.

The broadcast reception device 100 may obtain emergency alert information from a packet payload on the basis of information obtained from a packet header. Herein, the obtained emergency alert information may be an EAT or a CAP message. Additionally, it may be related content information or NRT service information.

The broadcast reception device 100 may obtain emergency alert information by parsing the obtained CAP message. In this case, the broadcast reception device 100 may obtain related NRT service information together with emergency alert information. If there is overlapping information in the EAT and CAP messages, the broadcast transmission device 300 may omit the overlapping part while configuring an EAT. Hereinafter, a process of obtaining related service on the basis of emergency alert information is the same as the above and thus is omitted.

FIG. 71 is a view when the broadcast transmission device 300 transmits an EAT through a normal PLP according to an embodiment of the present invention. Herein, the normal PLP is a PLP of which purpose is not specified.

This embodiment is the case that a basic data pipe is not included in a physical layer unlike the embodiment of FIG. 70 and a difference compared to FIG. 70 will be mainly described below.

In this embodiment, the broadcast transmission device 300 configures a packet header differently from a normal packet header while encapsulating emergency alert information. In more detail, the broadcast transmission device 300 may differently set a value representing a packet type included in a packet header. For example, a normal packet sets a corresponding value to 000(2) and an emergency alert packet sets a corresponding value to a value of 110(2) so that each packet may be identified.

On the other hand, a physical layer including a PLP may transmit information for signaling a PLP in a physical layer. At this point, the information for signaling a PLP may be referred to as PHY signaling. The broadcast reception device 100 may obtain information on a PLP included in a received physical layer on the basis of the PHY signaling. In the embodiment of FIG. 71, the broadcast reception device 100 may receive a packet including an emergency alert and a packet including broadcast content through a plurality of PLPs included in a physical layer. Additionally, the broadcast reception device 100 may obtain emergency alert information from a packet including emergency information. Additionally, the broadcast reception device 100 identifies another PLP for transmitting a broadcast content relating to an emergency alert on the basis of the emergency alert information. Additionally, the broadcast reception device 100 may obtain path information for receiving an NRT content relating to an emergency alert on the basis of the emergency alert information.

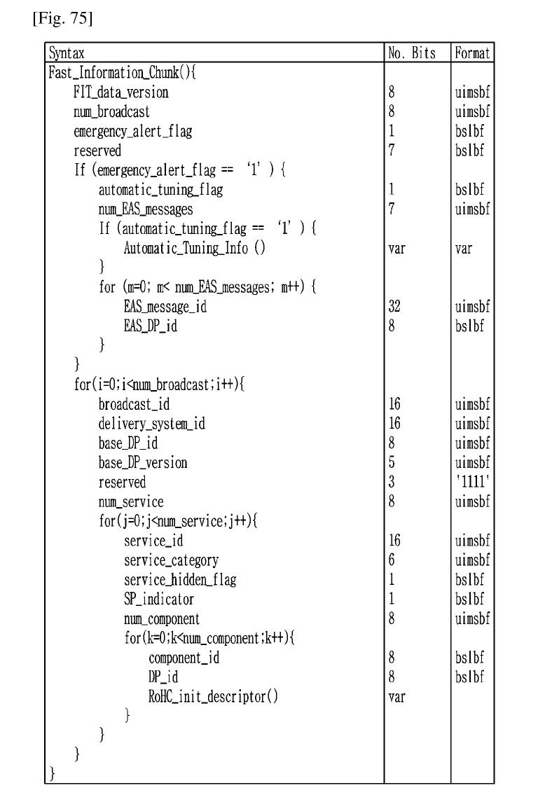

FIGS. 72 and 75 are views when the broadcast transmission device 300 transmits emergency alert information through a PLP according to another embodiment of the present invention. In this case, the other PLP may be a PLP for broadcast service scan included in a physical layer of a broadcast signal. In more detail, the broadcast transmission device 300 may transmit service signaling information for broadcast service scan to a physical layer of a broadcast signal through a PLP without going through another layer. At this point, the PLP for broadcast service scan may be referred to as a signaling channel. The broadcast reception device 100 may obtain at least one of configuration information on broadcast stream, simple broadcast service information, and component information from a signaling channel. In a specific embodiment, the signaling channel may be one of a Fast Information Channel (FIC) and Low Layer Signaling (LLS).

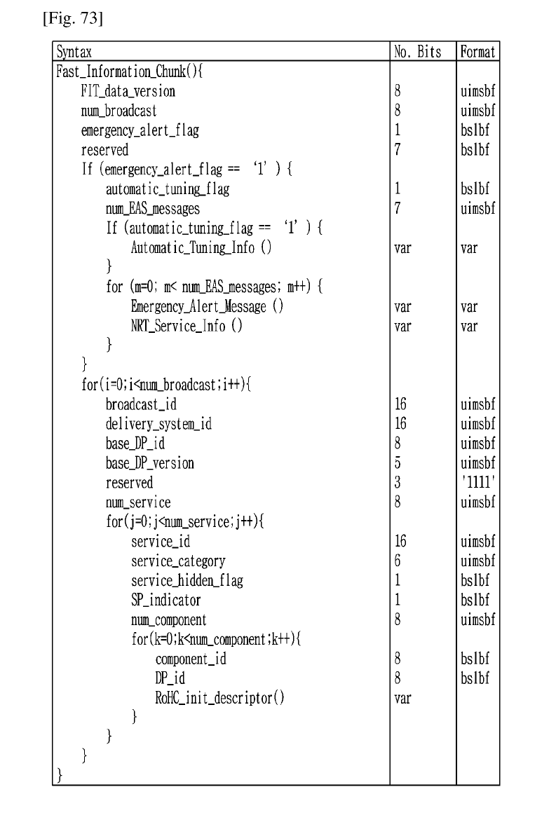

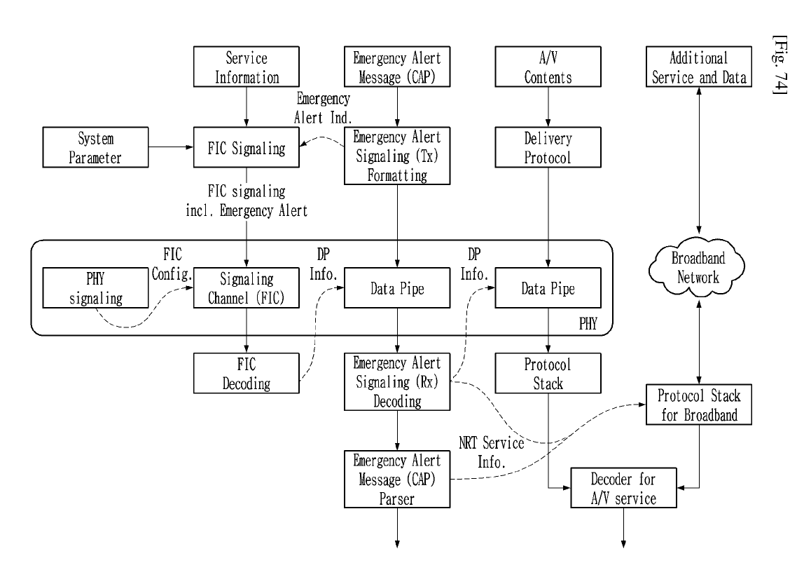

In an embodiment of the present invention, the broadcast transmission device 300 may transmit a CAP message based emergency alert message through a signaling channel. This embodiment will be described in more detail with reference to FIGS. 72 and 73.

In another embodiment of the present invention, the broadcast transmission device 300 may transmit the minimum information for indicating an emergency alert through a signaling channel and may transmit an actual emergency alert message (for example, an EAT) through a PLP distinguished from a signaling channel. This embodiment will be described in more detail with reference to FIGS. 74 and 75.

FIG. 72 is a view illustrating contents for directly transmitting an emergency alert message through a signaling channel.

The broadcast transmission device 300 generates an EAT on the basis of emergency information collected from the alert authorities 600. Herein, the emergency alert information received by the broadcast transmission device 300 may be a CAP message received from an information collection device 700.

The broadcast transmission device 300 generates a broadcast signal including the generated EAT. In more detail, an EAT may be transmitted through a signaling channel that is one format of a PLP of a broadcast signal. At this point, the signaling channel may refer to a general signaling channel that is not the dedicated signaling channel described in the embodiment of FIG. 69. Then, the broadcast transmission device 300 transmits a broadcast signal including emergency alert information through a signaling channel.

The broadcast reception device 100 may obtain emergency alert information from a broadcast signal received through a signaling channel. In more detail, the obtained emergency alert information may be an EAT. The broadcast reception device 100 decodes the signaling channel. At this point, the broadcast reception device 100 may obtain a CAP message, related content information, and related NRT service information from a signaling channel.

The broadcast reception device 100 may obtain emergency alert information by parsing the obtained CAP message. In this case, the broadcast reception device 100 may obtain related NRT service information together with emergency alert information. If there is overlapping information in the EAT and CAP messages, the broadcast transmission device 300 may omit the overlapping part while configuring an EAT. Hereinafter, a process of obtaining related service on the basis of emergency alert information is the same as the above and thus is omitted. FIG. 73 is a view illustrating a syntax for an emergency alert message transmitted through a signaling channel according to an embodiment of the present invention. In a specific embodiment, the emergency alert message may be part of a table transmitted through a signaling channel. Additionally, a field shown in FIG. 73 may be changed according to a need in the future.

A table for an emergency alert message may represent whether a corresponding EAT includes emergency alert related signaling. In more detail, information representing whether emergency alert related signaling is included may be an emergency_alert_flag field.

In an embodiment, when the emergency_alert_flag field has a value of 0, this represents that an EAT does not include emergency alert information. Additionally, when the emergency_alert_flag field has a value of 1, this represents that an EAT includes emergency alert information.

If the emergency_alert_flag field is enabled, a table for an emergency alert message may include an emergency alert message related field. Additionally, a table for an emergency alert message may include an automatic channel tuning related field.

FIG. 74 is a view illustrating contents for transmitting only a delivery path of emergency alert information through a signaling channel.

The broadcast transmission device 300 signals emergency alert information collected from the alert authorities 600 in a transmittable format. In more detail, the broadcast transmission device 300 may configure emergency alert information (for example, a CAP message and related data) with a table, a descriptor, or a packet. At this point, when the broadcast transmission device 300 does not include a module for additional emergency alert signaling, it may signal emergency alert information in a transmittable format through a general signaling module.

The broadcast transmission device 300 may insert information on whether to transmit an emergency alert message and information on a path through which the emergency alert message is transmitted, together with the emergency alert information, in to a table or a transmission packet including the table. At this pint, the information on whether to transmit an emergency alert message and a transmission path may be referred to as an emergency alert indicator. A descriptor included in a table or a transmission packet may include an emergency alert indicator. Additionally, a table included in a physical layer frame may include an emergency alert indicator as one field. Information in an emergency alert indicator may be included as an individual field if necessary and information having a high priority may be included according to a priority. Herein, the priority may be defined by each information according to the importance in transmitting an emergency alert message.

The broadcast reception device 300 transmits an emergency alert indicator and related data through a signaling channel. Additionally, the broadcast transmission device 300 may transmit information relating to an emergency alert through a PLP instead of a signaling channel. At this point, the PLP that is not a signaling channel may be referred to as a general PLP.

Additionally, emergency alert related data transmitted by the broadcast transmission device 300 may be path information for obtaining emergency alert information from a physical layer pipe. In more detail, the emergency alert related data may be information for identifying a data pipe from a general PLP for transmitting emergency alert information.

The broadcast reception device 100 receives an emergency alert indicator and related data through a signaling channel. Additionally, a physical layer may include information representing whether there is a signaling channel for transmitting emergency alert information in a physical layer of a broadcast signal. At this point, the information representing whether there is a signaling channel may be referred to as PHY signaling. The broadcast reception device 100 checks whether there is a signaling channel in a physical layer on the basis of the PHY signaling and receives an emergency alert indicator and related data from a signaling channel.

The broadcast reception device 100 may decode a signaling channel through an emergency alert signaling decoder and may obtain an emergency alert indicator and related data from the signaling channel.

The broadcast reception device 100 obtains delivery path information of an emergency alert message on the basis of an emergency alert indicator and related data obtained from a signaling channel. In more detail, the broadcast transmission device 100 may obtain information on a PLP for transmitting an emergency alert message from an emergency alert indicator. In more detail, the broadcast reception device 100 may obtain identification information for identifying a PLP for transmitting an emergency alert message from an emergency alert indicator.

The broadcast reception device 100 decodes a packet transmitted through the identified PLP on the basis of an emergency alert indicator.

In a specific embodiment, the broadcast reception device 100 may determine whether a corresponding packet includes emergency alert information on the basis of the packet header. Additionally, the broadcast reception device 100 may determine the type of emergency alert information included in a packet payload from a packet header. For example, the broadcast reception device 100 may determine whether a packet payload includes an entire EAT.

The broadcast reception device 100 may obtain emergency alert information from a packet payload on the basis of information obtained from a packet header. Herein, the obtained emergency alert information may be an EAT or a CAP message. Additionally, it may be related content information or NRT service information.

The broadcast reception device 100 may obtain emergency alert information by parsing the obtained CAP message. In this case, the broadcast reception device 100 may obtain related NRT service information together with emergency alert information. If there is overlapping information in the EAT and CAP messages, the broadcast transmission device 300 may omit the overlapping part while configuring an EAT.

The broadcast reception device 100 may receive audio/video content on the basis of obtained related content information. In more detail, the obtained related content information may be information for identifying a data pipe that transmits audio/video content. Furthermore, the obtained related content information may be information for identifying audio/video content. The broadcast reception device 100 may identify a data pipe transmitting audio/video content on the basis of related content information. Then, the broadcast reception device 100 may obtain audio/video content through the identified data pipe and may obtain a content relating to emergency alert information in the obtained audio/video content. At this point, a PLP for transmitting content may be distinguished from a PLP for transmitting emergency alert information. Additionally, the broadcast reception device 100 may obtain an NRT service relating to emergency alert information on the basis of the obtained NRT service information. In more detail, the broadcast reception device 100 may obtain address information for obtaining NRT service from the NRT service information. At this point, the broadcast reception device 100 may receive NRT service through broadband.

The broadcast reception device 100 provides the obtained emergency alert message together with audio/video content. If information on automatic channel tuning is transmitted together with an emergency alert message, the broadcast reception device 100 may provide an emergency alert message as changing a channel automatically.

FIG. 75 is a view illustrating a syntax for signaling an emergency alert transmitted through a signaling channel according to an embodiment of the present invention. In a specific embodiment, the emergency alert message may be part of a table transmitted through a signaling channel. Additionally, a field shown in FIG. 75 may be changed according to a need in the future.

A table for signaling an emergency alert may represent whether a corresponding EAT includes emergency alert related data. In more detail, information representing whether emergency alert related data is included may be an emergency_alert_flag field. In an embodiment, when the emergency_alert_flag field has a value of 0, this represents that data for an emergency alert is not included in the current signaling channel or a table. Additionally, when the emergency_alert_flag field has a value of 1, this represents that data for an emergency alert is included in the current emergency alert table.

If the emergency_alert_flag field is enabled, a table for an EAT may include an emergency alert information related field. Additionally, an EAT may include an automatic channel tuning related field.

A table for signaling an emergency alert may include PLP information for receiving an emergency alert message that a corresponding table signals. In this case, the PLP information may be an EAS_DP_id field. In more detail, the EAS_DP_id field may be information for identifying a data pipe in a broadcast signal that delivers an emergency alert message.

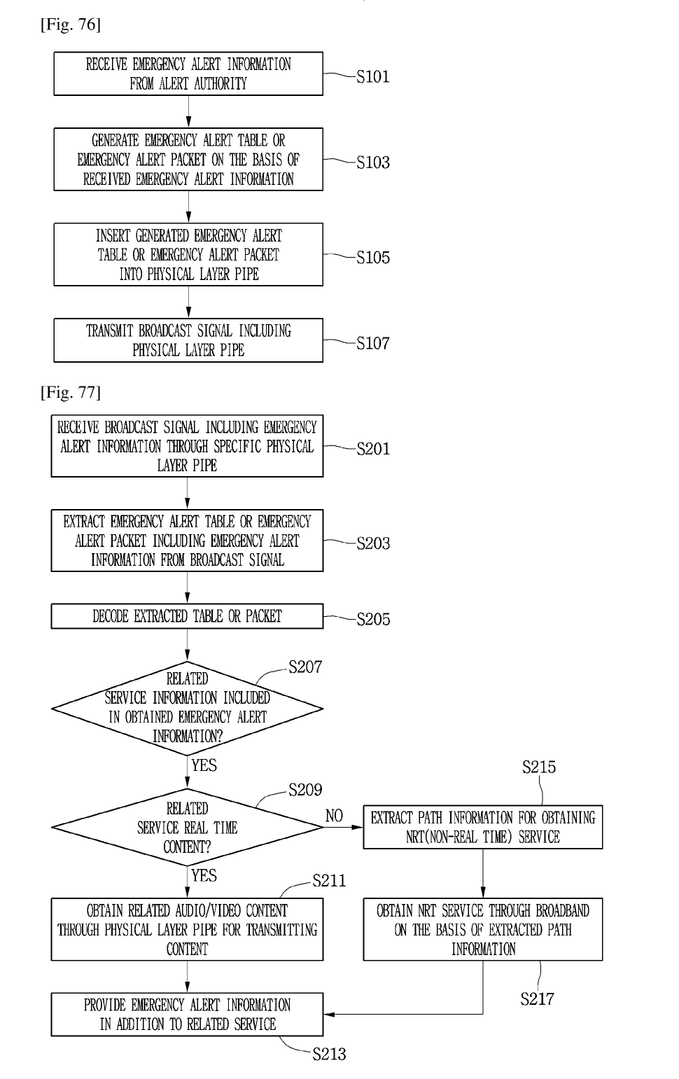

FIG. 76 is a flowchart illustrating an operating method of the broadcast transmission device 300 according to an embodiment of the present disclosure.

The broadcast transmission device 300 receives emergency alert information from the alert authorities 600 in operation S101. Herein, the alert authorities 600 may be one of emergency management authorities and agencies concerned. Additionally, the broadcast transmission device 300 may receive emergency alert information from the information collection device 700. In this case, the broadcast transmission device 300 may receive emergency alert information processed as a CAP message.

The broadcast transmission device 300 generates an emergency alert packet including a table with emergency alert information or an EAT on the basis of the received emergency alert information in operation S103. In more detail, a control unit of the broadcast transmission device 300 may generate an EAT or an emergency alert packet according to a PLP transmitting emergency alert information.

In an embodiment, when emergency alert information is transmitted through a dedicated PLP, the control unit may generate an EAT including emergency alert information. In this case, according to a first embodiment, an EAT may include all emergency alert information. Additionally, according to a second embodiment, an EAT may include only part of emergency alert information. Herein, part of emergency alert information may include only the minimum information for transmitting entire emergency alert information.

According to another embodiment, a control unit of the broadcast transmission device 300 may encapsulate emergency alert information as a packet when the emergency alert information is transmitted through a PLP for packet transmission. The emergency alert information encapsulated packet may be referred to as an emergency alert packet. In an embodiment, the control unit of the broadcast transmission device 300 may encapsulate emergency alert information into the payload of a packet. In another embodiment, the control unit may encapsulate the EAT into the payload of a packet.

Additionally, the control unit of the broadcast transmission device 300 may encapsulate information for identifying the data of the packet payload into the header of a packet. Additionally, information encapsulated into the header of a packet may be information for notifying that a corresponding packet is a packet including emergency alert information.

The control unit of the broadcast transmission device 300 may insert a generated EAT or an emergency alert packet into a physical layer pipe in operation S105. In more detail, the control unit inserts an EAT or an emergency alert packet into a physical layer pipe. At this point, the physical layer may include information representing that the physical layer includes emergency alert information.

When physical alert information is inserted into a physical layer pipe, the broadcast transmission device 300 transmits a broadcast signal including a physical layer pipe in operation S107. In an embodiment, a specific PLP may be a dedicated PLP for transmitting only emergency alert information. In another embodiment, a specific PLP may be a PLP for transmitting signaling information on broadcast service or common data applied to a plurality of broadcast services. In another embodiment, a specific PLP may be a PLP for transmitting information necessary for service scan including at least one of configuration information on broadcast service, simple broadcast service information, and component information. In another embodiment, a specific PLP may be a normal PLP of which purpose is not specified.

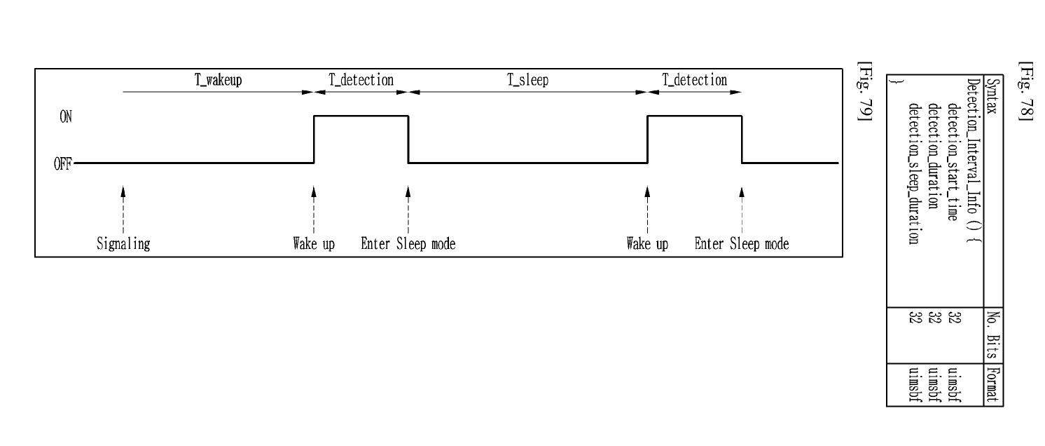

FIG. 77 is a flowchart illustrating an operating method of the broadcast reception device 100 according to an embodiment of the present disclosure.

The broadcast reception device 100 receives a broadcast signal including emergency alert information by using a broadcast reception unit 110 through a PLP in operation S201. In an embodiment, a PLP may be a dedicated PLP for transmitting only emergency alert information. In another embodiment, a PLP may be a PLP for transmitting signaling information on broadcast service or common data applied to a plurality of broadcast services. In another embodiment, a PLP may be a PLP for transmitting at least one of configuration information on broadcast service, simple broadcast service information, and component information. In another embodiment, a PLP may be a normal PLP of which purpose is not specified.

The control unit 150 of the broadcast reception device 100 may extract a transmission packet including emergency alert information from the received broadcast signal in operation S203. In an embodiment, a transmission packet may include an EAT. In this case, an EAT may include only the minimum information for obtaining emergency alert information. In another embodiment, a transmission packet may include an emergency alert packet. The control unit 150 of the broadcast reception device 100 may obtain emergency alert information by decoding the extracted transmission packet in operation S205. In other words, the control unit 150 extracts emergency alert information from a transmission packet. In more detail, the emergency alert information may be obtained by decoding an EAT or an emergency alert packet included in a transmission packet. In an embodiment, the control unit 150 may decode a transmission packet on the basis of specific information on an EAT or the header of an emergency alert packet. In another embodiment, the broadcast reception device 100 may decode a transmission packet on the basis of information obtained by decoding an EAT. In more detail, a physical layer pipe transmitting emergency alert information may be identified from an EAT or an identified physical layer pipe may be decoded.

The control unit 150 of the broadcast reception device 100 may determine whether related service information is included in the obtained emergency alert information in operation S207. In more detail, the control unit 150 determines whether information on related content relating to emergency alert information is included. Herein, the related content may be one of real time content and NRT content.

If it is determined that there is related content, the control unit 150 of the broadcast reception device 100 may determine whether the obtained related content information is real time content in operation S209. In more detail, it is determined whether the emergency alert information related content is real time content or NRT content. Herein, the real time content may be audio/video content. Whether it is real time content is determined according to specific information on an EAT. Alternatively, it is determined according to information in the packet header.

When it is determined that related content is real time content, the control unit 150 obtains related content by decoding a physical layer pipe transmitting content in operation S211. In more detail, the emergency alert information may include path information for obtaining related content. Accordingly, the control unit may obtain content by identifying a physical layer pipe transmitting related content on the basis of corresponding information.

However, when it is determined that related content is NRT content, the control unit 150 extracts path information for obtaining NRT content in operation S215. The information for obtaining NRT content may be address information. For example, it may be URI information.

The broadcast reception device 100 obtains NRT service through an IP communication unit 130 on the basis of the extracted path information in operation S217. In more detail, the broadcast reception device 100 obtains NRT service through broadband by using address information.

The broadcast reception device 100 provides the obtained emergency alert information together with related content in operation S213. In more detail, the broadcast reception device 100 outputs emergency alert information together with related service. At this point, the related service may be one of real time service and NRT service.

As mentioned above, the broadcast transmission device 300 may transmit emergency alert information to the broadcast reception device 100 through a broadcast network. In a specific embodiment, the broadcast reception device 100 may be a mobile broadcast reception device. Additionally, a mobile broadcast reception device may be a companion device 200 for receiving a broadcast signal separately from the broadcast transmission device 300 or, as mentioned above, receiving a broadcast signal through the broadcast transmission device 300.

At this point, in general, the broadcast reception device 100 may check a broadcast signal for each frame by repeating a wake up state and a sleep state so as to receive a broadcast signal including emergency alert information. Herein, the wake up state may be a state of the broadcast reception device 100 for detecting whether a broadcast signal transmitted through a physical layer includes emergency alert information. That is, an emergency alert information detection function of a broadcast reception device may be in an activation state. On the other hand, the sleep state may refer to a state of the broadcast reception device 100 that does not detect emergency alert information from a broadcast signal. That is, an emergency alert information detection function of a broadcast reception device may be in an inactivation state.

However, in this case, when there is no emergency alert information in a broadcast signal, the broadcast reception device 100 may wake up periodically to cause unnecessary power and resource consumption. To compensate for this, the broadcast transmission device 300 may transmit information for checking emergency alert information together to the broadcast reception device 100 through a broadcast network. In more detail, the broadcast transmission device 300 may transmit time information for detecting emergency alert information to the broadcast reception device 100. Herein, the time information may be information on a time at which a companion device wakes up. Accordingly, the broadcast reception device 100 may wake up for a predetermined time to detect emergency alert information and may then return to a sleep state. As a result, since it is unnecessary that the broadcast reception device 100 wakes up by each frame unit check emergency alert information, unnecessary power and resource consumption may be reduced.

FIG. 78 is a view illustrating a syntax for a detection time interval table that the broadcast transmission device 300 transmits to the broadcast reception device 100.

As shown in FIG. 78, the detection interval table may include detection start time information. In more detail, the detection start time information may be start time information for starting the detection of emergency alert information. That is, the detection start time information may be time information for the broadcast reception device 100 to wake up. In a specific embodiment, the detection start time information may be expressed in milliseconds. Additionally, the detection start time information may be a detection_start_time field. The detection_start_time field may be 32 bits.

Additionally, the detection interval table may include detection duration time information. In more detail, when a state of the broadcast reception device 100 wakes up for detecting emergency alert information, the detection interval table may include time information for maintaining a wake up state. In a specific embodiment, the detection duration time information may be expressed in a decimal number of milliseconds. Additionally, the detection duration time information may be a detection_duration field. The detection_duration field may be 32 bits.

Additionally, the detection interval table may include sleep duration time information. In more detail, the detection interval table may include time information for maintaining a sleep state in which a state of the broadcast reception device 100 does not detect an emergency alert. In a specific embodiment, the sleep duration time information may be a detection_sleep_duration field. Additionally, the detection_sleep_time field may be 32 bits.

FIG. 79 is a view illustrating an operation of the broadcast reception device 100 according to detection interval information. As shown in FIG. 79, the broadcast reception device 100 becomes a wake up state according to a detection start time included in detection interval information delivered together with emergency alert information. That is, the broadcast reception device 100 may become a wake up state according to detection start time information by using a time at which the detection interval information is received as a reference time. In this case, the detection start time information may be relative time information based on a time at which the detection interval information is received.

The broadcast reception device 100 may maintain a wake up state according to the detection duration time information while in a wake up state. In this case, the detection duration time information may be relative time information based on the detection start time information.

Then, the broadcast reception device 100 returns to a sleep state when a detection duration time elapses. The sleep state may be maintained according to the sleep duration time information. In this case, the sleep duration time information may be a relative time based on a time at which it changes to a sleep state.

On the other hand, according to an embodiment of the present invention, the detection start time information may be used only at the initial wake up of the broadcast reception device 100. After this, a state of the broadcast reception device 100 may change according to the detection duration time information and the sleep duration time information. In another embodiment, when additional detection interval information is not received, a companion device may change a state according to existing detection interval information. In this case, in order to change a state maintenance interval of the broadcast reception device 100, the broadcast transmission device 300 may transmit new detection interval information to the broadcast reception device 100.

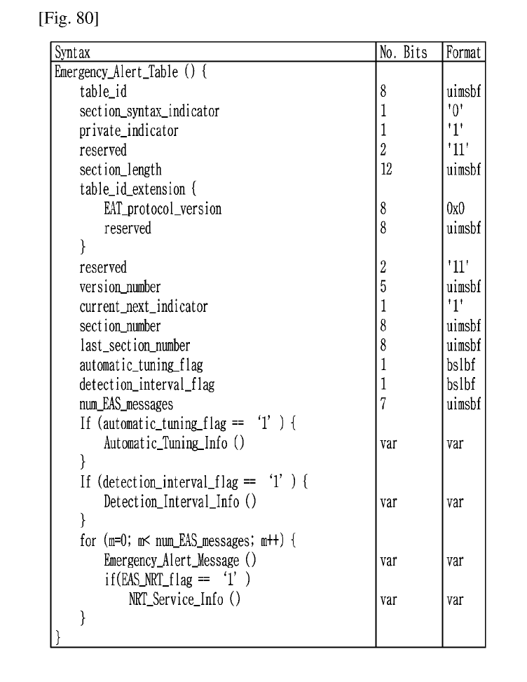

FIG. 80 is a view illustrating a syntax of an EAT with added detection interval information.

As shown in FIG. 80, the EAT may represent whether a corresponding table includes detection interval information. At this point, information representing whether it includes detection interval information may be a detetion_interval_flag field. In a specific embodiment, when the detetion_interval_flag field is enabled, this may represent that a corresponding table includes detection interval period. For example, when the detetion_interval_flag field has a value of 1, it may be set that the detetion_interval_flag field is enabled.

If the detetion_interval_flag field is enabled, an EAT may include detection interval information. On the other hand, when the detetion_interval_flag field is not enabled (for example, when the detetion_interval_flag field has a value of 0), an EAT may not include detection interval information.

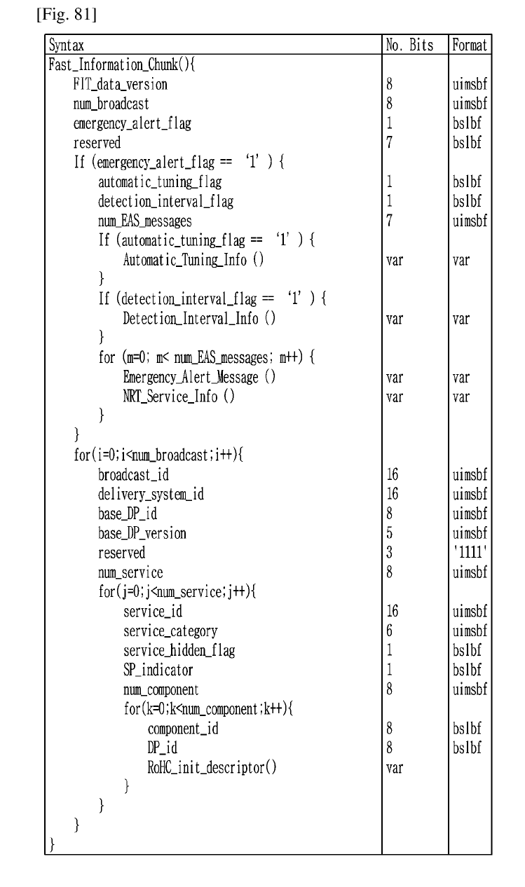

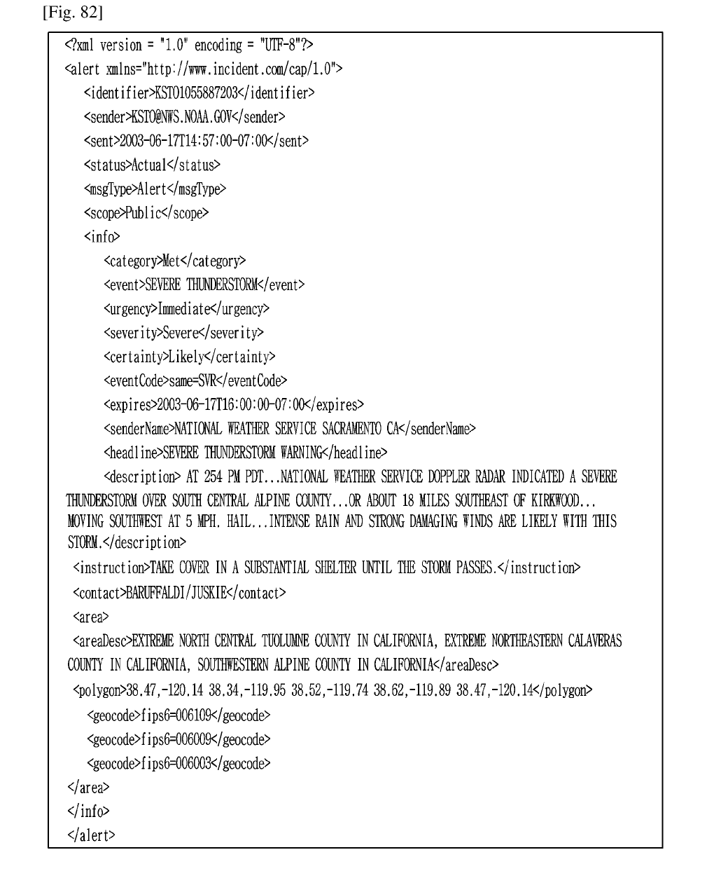

FIG. 81 is a view when emergency alert information and detection interval information are included in a signaling channel according to an embodiment of the present invention. In a specific embodiment, the signaling channel may be fast information chunk.

As described with reference to FIG. 80, the signaling channel may include information representing whether it includes detection interval information. Then, it may include detection interval information according to corresponding information.

Moreover, the broadcast transmission device 300 may set detection interval information arbitrarily but may set it on the basis of emergency situation information. At this point, the broadcast transmission device 300 may use an emergency alert message to obtain emergency situation information. Herein, the emergency alert message may be delivered in a Common Alerting Protocol (CAP) message format.

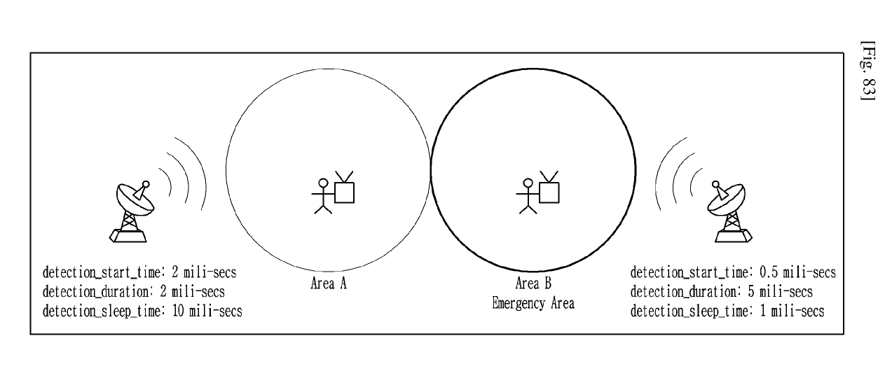

FIG. 83 is a view illustrating a CAP message for transmitting emergency situation information according to an embodiment of the present invention. In this case, the CAP message may be in XML format.

FIG. 83 is a view illustrating emergency situation information for setting detection interval information according to an embodiment of the present invention.

This embodiment sets a detection interval on the basis of area information especially in emergency situation information. In more detail, as shown in FIG. 82, the broadcast transmission device 300 corresponding to an area where an emergency situation occurs may set a detection interval to be shorter than a typical situation to maintain a wake up state of the broadcast reception device 100 more frequently.

For example, as shown in FIG. 83, the current B area is an emergency occurrence area and needs to transmit emergency alert information to the broadcast reception device 100 more frequently than an A area where an emergency does not occur. Accordingly, in this case, a broadcast transmission device in the B area may set detection time information and a state maintenance time to be shorter relatively compared to a broadcast device in the A area.

According to an embodiment of the present invention, battery consumption may be reduced by detecting emergency alert information according to a detection interval but it may be difficult to receive emergency alert information immediately compared to an hourly frame checking method. Accordingly, the above issues may be overcome as the broadcast transmission device 300 differently sets a detection interval according to an emergency occurrence area.

At this point, location information on an emergency area for detection interval setting by the broadcast transmission device 300 may be obtained from a CAP message received from the information collection device 700. In more detail, emergency area location information may be obtained through <area> information in the CAP message.

In another embodiment, when the broadcast reception device 100 moves from the B area, that is an emergency area, to the A area, it may detect emergency alert information according to a general interval. In more detail, as the location of the broadcast reception device 100 moves, a broadcast transmission device for transmitting emergency alert information may vary. Accordingly, compared to when a user is located in an emergency area, the need to deliver emergency alert information immediately is reduced, so that a detection interval may be longer relatively than a detection interval in an emergency area.

In another embodiment, when a plurality of broadcast signals is received, the broadcast reception device 100 may detect emergency alert information on the basis of a broadcast signal having shorter detection interval information. In a specific embodiment, the broadcast reception device 100 may receive both a broadcast signal with a detection interval of 2 milliseconds and a broadcast signal with a detection interval of 0.5 milliseconds. In this case, the broadcast reception device 100 may obtain emergency alert information on the basis of detection interval information with a detection interval of 0.5 milliseconds that is a shorter interval.

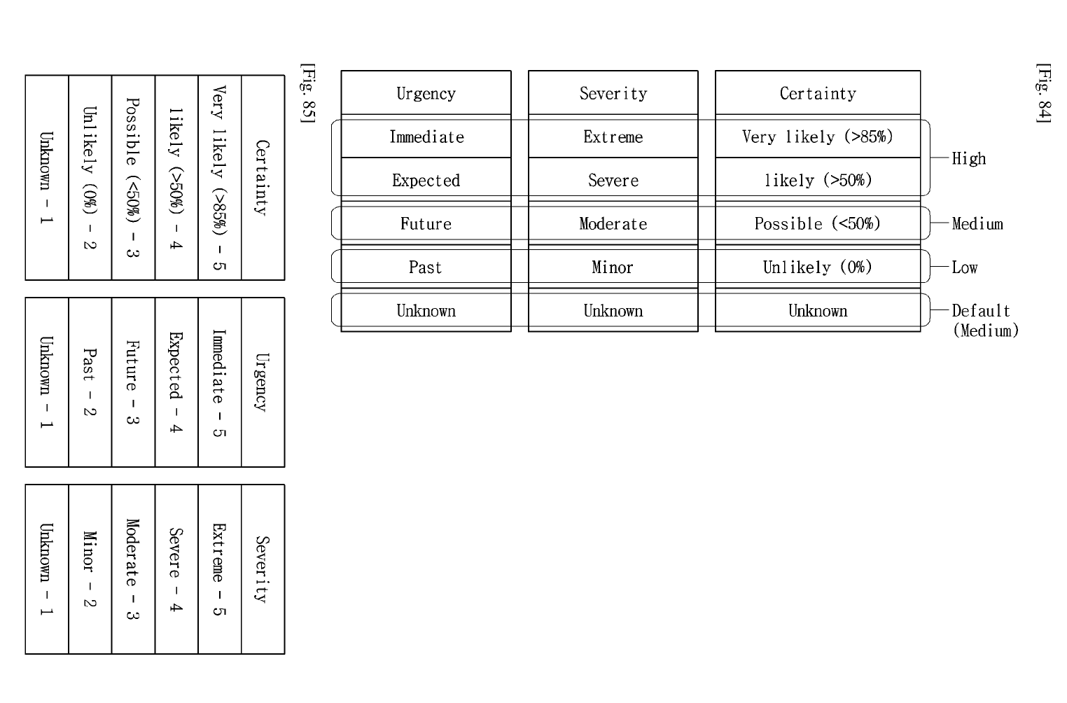

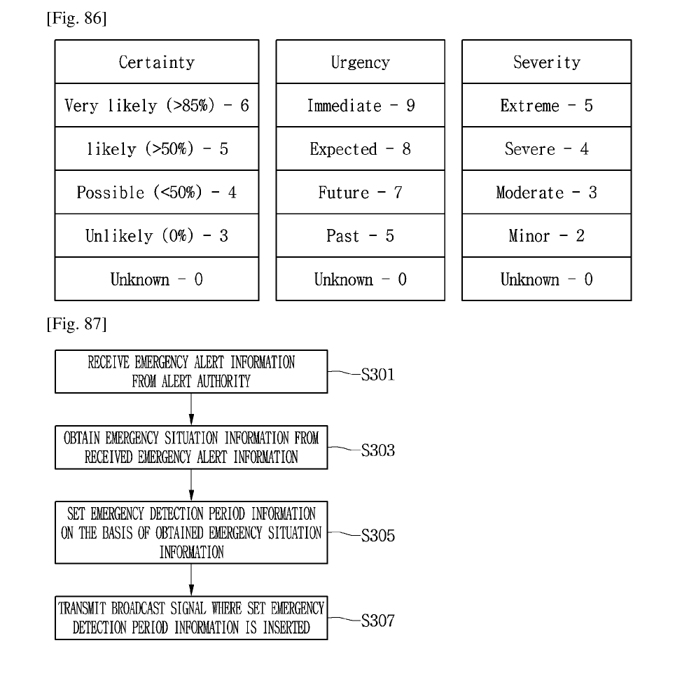

Hereinafter, FIGS. 84 to 86 are views when the broadcast transmission device 300 sets detection interval information on the basis of emergency alert priority information.

Emergency information may not all have the same level. Accordingly, when the same level of a detection interval is set to all emergencies, it may be difficult to achieve the purpose of reducing battery and resource consumption.

According to an embodiment of the present invention, the broadcast transmission device 300 may receive information on the priority and may set a detection interval on the basis of this. Herein, the priority of an emergency alert may be received from the information collection device 700. In more detail, priority information on an emergency alert may be obtained from a CAP message received by the information collection device 700. In a specific embodiment, the broadcast transmission device 300 may obtain one information in <urgency>, <severity>, and <certainty> included in the CAP message. A broadcast transmission device may set a detection interval on the basis of corresponding information.

According to an embodiment of the present invention, the broadcast transmission device 300 may determine the priority for each category of emergency alert information included in the CAP message. In more detail, the broadcast transmission device 300 may determine the priority according to an interval included by each category. Herein, the category may be emergency alert information included in the CAP message.

The broadcast reception device 100 may identify a priority on the basis of the respective ratings of information representing the urgency of an emergency alert, information representing the severity of an emergency causing an emergency alert, and information representing the certainty of an emergency causing an emergency alert. At this point, the broadcast reception device 100 may determine the priority of an emergency alert according to a value having the highest priority among information representing the urgency of an emergency alert, information representing the severity of an emergency causing an emergency alert, and information representing the certainty of an emergency causing an emergency alert.

In a specific embodiment, the broadcast reception device 100 may classify as three urgencies according to the ratings of information representing the urgency of an emergency alert, information representing the severity of an emergency causing an emergency alert, and information representing the certainty of an emergency causing an emergency alert.

For example, the broadcast reception device 100, as shown in the embodiment of FIG. 52, may determine the highest priority when the rating of an Urgency element corresponds to Immediate or Expected, an intermediate priority that is a lower priority than the highest priority and a higher priority than the lowest priority when it corresponds to Future, the lowest priority when it corresponds to Past, and a priority corresponding to an initial value when it corresponds to Unknown. At this point, the initial value may be an intermediate value that is a lower priority than the highest priority and a higher priority than the lowest priority.

Additionally, the broadcast reception device 100, as shown in the embodiment of FIG. 52, may determine the highest priority when the rating of a Severity element corresponds to Extreme or Severe, an intermediate priority that is a lower priority than the highest priority and a higher priority than the lowest priority when it corresponds to Moderate, the lowest priority when it corresponds to Minor, and a priority corresponding to an initial value when it corresponds to Unknown. At this point, the initial value may be an intermediate value that is a lower priority than the highest priority and a higher priority than the lowest priority.

Additionally, the broadcast reception device 100, as shown in the embodiment of FIG. 52, may determine the highest priority when the rating of a Certainty element corresponds to Very likely or likely, an intermediate priority that is a lower priority than the highest priority and a higher priority than the lowest priority when it corresponds to Possible, the lowest priority when it corresponds to Unlikely, and a priority corresponding to an initial value when it corresponds to Unknown. At this point, the initial value may be an intermediate value that is a lower priority than the highest priority and a higher priority than the lowest priority.

In another embodiment, the broadcast reception device 100 may assign points to the priority of an emergency alert on the basis of the respective ratings of information representing the urgency of an emergency alert, information representing the severity of an emergency causing an emergency alert, and information representing the certainty of an emergency causing an emergency alert and may determine the priority of an emergency alert according to the point total.

In a specific embodiment, the broadcast reception device 100 may assign a point in the same proportion to information representing the urgency of an emergency alert, information representing the severity of an emergency causing an emergency alert, and information representing the certainty of an emergency causing an emergency alert. For example, the broadcast reception device 100, as shown in the embodiment of FIG. 53, may assign 5 points when the rating of an Urgency element corresponds to Immediate, 4 points when it corresponds to Expected, 3 points when it corresponds to Future, 2 points when it is corresponds to Past, and 1 point when it corresponds to Unknown.

Additionally, the broadcast reception device 100, as shown in the embodiment of FIG. 53, may assign 5 points when the rating of a Severity element corresponds to Extreme, 4 points when it corresponds to Severe, 3 points when it corresponds to Moderate, 2 points when it is corresponds to Minor, and 1 point when it corresponds to Unknown.

Additionally, the broadcast reception device 100, as shown in the embodiment of FIG. 53, may assign 5 points when the rating of a Certainty element corresponds to Very likely, 4 points when it corresponds to likely, 3 points when it corresponds to Possible, 2 points when it is corresponds to Unlikely, and 1 point when it corresponds to Unknown. At this point, when the sum of points is greater than 10 or less than 15, the broadcast reception device 100 may determine that an emergency alert has the highest priority.

Additionally, when the sum of points is greater than 5 or less than 10, the broadcast reception device 100 may determine that an emergency alert has an intermediate priority that is a lower priority than the highest priority and a higher priority than the lowest priority.

Additionally, when the sum of points is greater than 0 or less than 5, the broadcast reception device 100 may determine that an emergency alert has the lowest priority.

In another specific embodiment, the broadcast reception device 100 may assign a point in a different proportion to information representing the urgency of an emergency alert, information representing the severity of an emergency causing an emergency alert, and information representing the certainty of an emergency causing an emergency alert.

For example, the broadcast reception device 100, as shown in the embodiment of FIG. 54, may assign 9 points when the rating of an Urgency element corresponds to Immediate, 8 points when it corresponds to Expected, 7 points when it corresponds to Future, 2 points when it is corresponds to Past, and 0 point when it corresponds to Unknown.

Additionally, the broadcast reception device 100, as shown in the embodiment of FIG. 54, may assign 5 points when the rating of a Severity element corresponds to Extreme, 4 points when it corresponds to Severe, 3 points when it corresponds to Moderate, 2 points when it is corresponds to Minor, and 0 point when it corresponds to Unknown.

Additionally, the broadcast reception device 100, as shown in the embodiment of FIG. 54, may assign 6 points when the rating of a Certainty element corresponds to Very likely, 5 points when it corresponds to likely, 4 points when it corresponds to Possible, 3 points when it is corresponds to Unlikely, and 0 point when it corresponds to Unknown. At this point, when the sum of points is greater than 10 or less than 15, the broadcast reception device 100 may determine that an emergency alert has the highest priority.

Additionally, when the sum of points is greater than 5 or less than 10, the broadcast reception device 100 may determine that an emergency alert has an intermediate priority that is a lower priority than the highest priority and a higher priority than the lowest priority.

Additionally, when the sum of points is greater than 0 or less than 5, the broadcast reception device 100 may determine that an emergency alert has the lowest priority.

At this point, the broadcast transmission device 300 may set a detection interval according to the classified priority. In more detail, in the case of the highest priority, the detection interval is set to be the shortest and in case of the lowest priority, the detection interval is set to be longest. In the case of an emergency alert having an intermediate priority that is higher than the lowest priority, a longer detection interval than the shortest detection interval may be set.

At this point, the shortest detection interval and the longest detection interval may be preset values in the broadcast transmission device 300. Additionally, the broadcast transmission device 300 may pre-store a detection interval value corresponding to each priority. At this point, the broadcast transmission device 300 may set a detection interval value corresponding to the obtained priority to a broadcast signal.

FIG. 87 is a flowchart illustrating an operating method of the broadcast transmission device 300 according to an embodiment of the present disclosure.

The broadcast transmission device 300 receives emergency alert information from the alert authorities 600 in operation S301. In this case, the broadcast transmission device 300 may receive emergency alert information through the information collection device 700. In a specific embodiment, the received emergency alert information may be a CAP message. Then, the CAP message may include emergency alert information.

The control unit of the broadcast transmission device 300 obtains emergency situation information from the received emergency alert information in operation S303. In more detail, emergency situation information may be obtained by parsing emergency alert information. As one example, the emergency situation information may be location information on where the current emergency occurs. As another example, the emergency situation information may be information on the urgency of an occurring emergence.

The control unit of the broadcast transmission device 300 sets emergency detection interval information on the basis of the obtained emergency situation information in operation S305. In more detail, the control unit sets an emergency detection interval for the broadcast reception device 100 according to an emergency situation.

In an embodiment, the control unit of the broadcast transmission device 300 may encapsulate emergency alert information into the payload of a packet. For example, when an emergency occurs in an area where the corresponding transmission device 300 is located, an emergency detection interval for the broadcast reception device 100 may be set to be shorter than a typical interval.

In another embodiment, the control unit of the broadcast transmission device 300 may set an emergency detection interval according to the urgency of an occurring emergency. For example, when the emergency urgency is determined as a high priority, an emergency detection interval may be set to be shorter than a typical period. At this point, the priority may be determined based on information representing a plurality of urgencies.

The transmission unit of the broadcast transmission device 300 transmits a broadcast signal including emergency detection interval information in operation S307. In an embodiment, the control unit of the broadcast transmission device 300 may insert emergency alert information into an EAT and may then transmit it. In another embodiment, the control unit of the broadcast transmission device 300 may insert emergency detection interval information into a signaling channel and may then transmit it. In another embodiment, the control unit of the broadcast transmission device 300 may insert emergency detection interval information into a packet and may then transmit it.

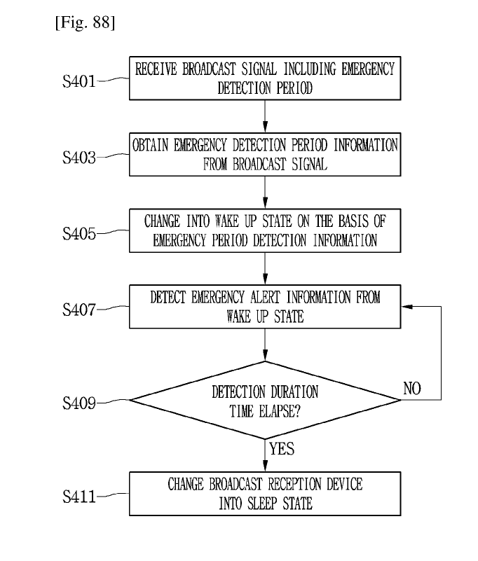

FIG. 88 is a flowchart illustrating an operating method of the broadcast reception device 100 according to an embodiment of the present disclosure. Herein, the broadcast reception device 100 may be a mobile broadcast reception device.

The broadcast reception unit 110 of the broadcast reception device 100 receives a broadcast signal including an emergency detection interval in operation S401. The broadcast reception device 100 may receive a broadcast signal through one of a terrestrial broadcast network and a broadband.

The control unit 150 of the broadcast reception unit 150 obtains emergency detection interval information from the broadcast signal in operation S403. In more detail, the control unit 150 may obtain emergency detection interval information by decoding the broadcast signal. At this point, the emergency detection interval information may include at least one of detection start time information, detection duration time information, and sleep duration time information. In an embodiment, the emergency detection interval information may be expressed in a decimal number of milliseconds and may have a relative time value to a specific reference value.

The control unit 150 of the broadcast reception unit 150 changes the broadcast reception device 100 into a wake up state on the basis of emergency interval detection information in operation S405. Herein, the wake up state is a state in which the broadcast reception device 100 detects whether a broadcast signal includes emergency alert information. That is, a function for emergency alert information detection of the control unit 150 is in an activated state. On the other hand, a sleep state is a state in which a function for emergency alert information detection of the control unit 150 is in an inactivated state.

The control unit 150 of the broadcast reception unit 150 changes the broadcast reception device 100 into a wake up state on the basis of emergency interval detection information in operation S405. At this point, the control unit may change a state of the broadcast reception device 100 on the basis of a time at which a broadcast signal is received.

The control unit 150 of the broadcast reception unit 150 detects emergency alert information in a wake up state in operation S407. In more detail, the control unit 150 determines whether a broadcast signal includes emergency alert information and obtains emergency alert information when it is included.

The control unit 150 of the broadcast reception unit 150 determines whether a detection duration time elapses in a wake up state in operation S409. In more detail, the control unit 150 determines whether the detection duration time elapses on the basis of the detection duration time included in the emergency interval detection information. In this case, the control unit 150 may determine whether the detection duration time elapses on the basis of a time at which the broadcast reception device 100 becomes in a wake up state.

If it is determined that the detection duration time does not elapse, the control unit 150 continuously detects emergency alert information.

However, it is determined that the detection duration time elapses, the control unit 150 changes the broadcast reception device 100 into a sleep state. Herein, the sleep state may be a state in which the broadcast reception device 100 does not detect emergency alert information. The control unit 150 may maintain the sleep state on the basis of sleep duration time information included in the emergency detection interval information. In this case, a time at which the detection duration time is terminated may be a reference time for maintaining the sleep state.

Moreover, the control unit 150 maintains an existing interval until new emergency detection interval information is received.

According to an embodiment of the present invention, provided are a broadcast transmission device and an operating method thereof, and a broadcast reception device and an operating method thereof, which configure a signaling system for transmitting emergency alert information and apply this to a transport protocol.

According to an embodiment of the present invention, provided are a broadcast transmission device and an operating method thereof, and a broadcast reception device and an operating method thereof, which configure a signaling system for delivering emergency alert information.

According to an embodiment of the present invention, provided are a broadcast transmission device and an operating method thereof, and a broadcast reception device and an operating method thereof, which configure a section table for delivering emergency alert information.

According to an embodiment of the present invention, provided are a broadcast transmission device and an operating method thereof, and a broadcast reception device and an operating method thereof, which configure a packet for delivering emergency alert information and receive it.

According to an embodiment of the present invention, provided are a broadcast transmission device and an operating method thereof, and a broadcast reception device and an operating method thereof, which transmit/receive emergency alert information through a specific physical layer pipe in a physical layer.

According to an embodiment of the present invention, provided are a broadcast transmission device and an operating method thereof, and a broadcast reception device and an operating method thereof, which set a detection interval on the basis of emergency situation information and transmit/receive it.

The present invention is not limited to the features, structures, and effects described in the above embodiments. Furthermore, the features, structures, and effects in each embodiment may be combined or modified by those skilled in the art. Accordingly, it should be interpreted that contents relating to such combinations and modifications are included in the scope of the present invention.

While this invention has been particularly shown and described with reference to preferred embodiments thereof, it will be understood by those skilled in the art that various changes in form and details may be made therein without departing from the spirit and scope of the invention as defined by the appended claims. For example, each component in an embodiment is modified and implemented. Accordingly, it should be interpreted that differences relating to such modifications and applications are included in the scope of the appended claims.

1. A broadcast reception device providing emergency alert information for notifying an emergency situation, the device comprising:
a broadcast reception unit receiving a transmission packet for transmitting the emergency alert information through a transmission path included in a physical layer, which is one of a plurality of layers for transmitting a broadcast signal and is for transmitting/receiving a broadcast signal through a physical medium; and
a control unit obtaining the emergency alert information by decoding the transmission packet received through the transmission path.

2. The broadcast reception device according to claim 1, wherein the broadcast reception unit receives the transmission packet for the emergency alert information transmission through a first transmission path that is a transmission path specified for transmitting only the emergency alert information.

3. The broadcast reception device according to claim 2, wherein the physical layer comprises information for notifying that the first transmission path is included in the physical layer.

4. The broadcast reception device according to claim 1, wherein the broadcast reception unit receives the transmission packet for the emergency alert information transmission through a second transmission path that is a transmission path transmitting signaling information on a broadcast service or common data applied to a plurality of broadcast services.

5. The broadcast reception device according to claim 1, wherein the broadcast reception unit receives the transmission packet for the emergency alert information transmission on the basis of a third transmission path that is a transmission path for directly transmitting information for broadcast service scan to a physical layer without passing through another layer.

6. The broadcast reception device according to claim 5, wherein the transmission packet received based on the third transmission path comprises path information for the emergency alert information acquisition,
wherein the broadcast reception unit receives the physical layer frame for the emergency alert information acquisition through a fourth transmission path that his different from the third transmission path on the basis of the path information.

7. The broadcast reception device according to claim 6, wherein the path information comprises information for identifying a transmission path that transmits the emergency alert information.

8. The broadcast reception device according to claim 1, wherein
the control unit obtains broadcast service information relating to the emergency alert information by decoding the transmission packet; and
the related broadcast service information is at least one of transmission path information transmitting a real time service relating to the emergency alert information and address information for receiving a non-real time service relating to the emergency alert information.

9. The broadcast reception device according to claim 1, wherein the control unit obtains first information for activating a function for detecting whether emergency alert information is transmitted through the physical layer on the basis of the emergency alert information.

10. The broadcast reception device according to claim 9, wherein the first information comprises at least one of activation start time information of a detection function, activation duration time information of a detection function, and deactivation duration time information of a detection function.

11. The broadcast reception device according to claim 9, wherein the first information is determined by a location of a broadcast transmission device transmitting the emergency alert information.

12. The broadcast reception device according to claim 11, wherein the first information comprises a deactivation duration time of a detection function proportional to a distance between a location of the broadcast reception device and an emergency occurring area.

13. The broadcast reception device according to claim 11, wherein
the first information is determined based on second information representing a priority of an emergency alert; and
the second information comprises information representing an urgency of an emergency alert, information representing a severity of an emergency causing an emergency alert, and information representing a certainty of an emergency causing an emergency alert.

14. An operating method of a broadcast reception device providing emergency alert information for notifying an emergency situation, the method comprising:
receiving a transmission packet for transmitting the emergency alert information through a transmission path included in a physical layer, which is one of a plurality of layers for transmitting a broadcast signal and is for transmitting/receiving a broadcast signal through a physical medium;
decoding the transmission packet received through the transmission path; and
obtaining the emergency alert information from the decoded transmission packet.

15. The method according to claim 14, wherein the receiving of the physical layer frame comprises receiving the physical layer frame for the emergency alert information acquisition through a first transmission path that is a transmission path specified for transmitting only the emergency alert information.

16. The method according to claim 14, wherein the receiving of the transmission packet comprises receiving the transmission packet for the emergency alert information transmission through a second transmission path that is a transmission path transmitting signaling information on a broadcast service or common data applied to a plurality of broadcast services.

17. The method according to claim 14, wherein the receiving of the transmission packet comprises receiving the transmission packet for the emergency alert information transmission on the basis of a third transmission path that is a transmission path for directly transmitting information for broadcast service scan to a physical layer without passing through another layer.

18. The method according to claim 17, wherein
the transmission packet received based on the third transmission path comprises path information for the emergency alert information acquisition; and
the receiving of the transmission packet comprises receiving the transmission packet for the emergency alert information acquisition through a fourth transmission path that his different from the third transmission path on the basis of the path information.

19. A broadcast transmission device comprising:
a control unit collecting emergency alert information for notifying an emergency situation from alert authorities and encoding the collected emergency alert information in a format for transmission; and
a broadcast transmission unit transmitting the encoded emergency alert information through a transmission path included in a physical layer that is one of a plurality of layers for transmitting a broadcast signal and is for transmitting/receiving a broadcast signal through a physical medium.

20. An operating method of a broadcast transmission device, the method comprising:
collecting emergency alert information for notifying an emergency situation from alert authorities;
encoding the collected emergency alert information in a format for transmission; and
transmitting the encoded emergency alert information through a transmission path included in a physical layer that is one of a plurality of layers for transmitting a broadcast signal and is for transmitting/receiving a broadcast signal through a physical medium.
